(19) United States
(12) Patent Application Publication
(10) Pub. No.: US 2016/0367961 A1
(43) Pub. Date: Dec. 22, 2016

(54) METHOD AND COMPOSITION FOR PEPTIDE CYCLIZATION AND PROTEASE TREATMENT

(71) Applicant: Roche Sequencing Solutions, Inc., Pleasanton, CA (US)

(72) Inventors: Jigar Patel, Madison, WI (US); Lauren Goodrich, Madison, WI (US); Victor Lyamichev, Fitchburg, WI (US); Thomas Albert, Verona, WI (US)

(21) Appl. No.: 15/136,028

(22) Filed: Apr. 22, 2016

Related U.S. Application Data
(60) Provisional application No. 62/152,010, filed on Apr. 23, 2015.

(51) Int. Cl. B01J 19/00

(52) U.S. Cl. CPC B01J 19/0046; B01J 2219/00596; B01J 2219/00711; B01J 2219/00533; B01J 2219/00725

(57) ABSTRACT

This invention relates to peptide microarrays, methods of generating peptide microarrays, and methods of identifying peptide binders using microarrays. More specifically, this invention relates to peptide microarrays, methods of generating peptide microarrays, and methods of identifying peptide binders using microarrays wherein the microarrays comprise cyclic peptides. The invention also relates to methods of increasing the number of cyclized peptides on a microarray by treating the peptides on the microarray with a protease. Additionally, the invention relates to methods of generating linear and cyclic peptides subarrays on a microarray.

### CROSS REFERENCE TO RELATED APPLICATION

This application claims priority under 35 U.S.C. §119(e) to U.S. Provisional Application No. 62/152,010, filed Apr. 23, 2016, incorporated herein by reference in its entirety.

### SEQUENCE LISTING

The instant application contains a Sequence Listing which has been submitted electronically in ASCII format and is hereby incorporated by reference in its entirety. Said ASCII copy, created on Apr. 21, 2016, is named 5727-248051_SL.txt and is 70,660 bytes in size.

### TECHNICAL FIELD

This invention relates to peptide microarrays, methods of generating peptide microarrays, and methods of identifying peptide binders using microarrays. More specifically, this invention relates to peptide microarrays, methods of generating peptide microarrays, and methods of identifying peptide binders using microarrays wherein the microarrays comprise cyclic peptides. In some aspects, the invention relates to methods of increasing the proportion of cyclized peptides on a microarray relative to linear peptides by treating the peptides on the microarray with a protease. In additional aspects, the invention relates to methods of generating linear and cyclic peptides subarrays on a microarray.

### BACKGROUND

Understanding protein-protein interactions is important for basic research as well as various biomedical and other practical applications. Examples of this kind include binding between peptide fragments or epitopes and antibodies, the interaction between proteins and short fragments of other proteins, as well as binding between peptides referred to as aptamers to their target molecules. Development of simple and reliable methods for identifying peptide binders for proteins would help in understanding the mechanisms of protein-protein interaction and open new opportunities for drug discovery.

With the identification of cellular pathways and targets that play key roles in metabolism and disease progression, the understanding of disease states continues to expand exponentially. Although our understanding of diseases is advanced, our ability to treat them lags behind due to the limitations inherent in existing drug platforms. At present, the available drug platforms are based primarily on small molecules and therapeutic proteins, which address only about 10 to 20 percent of the identified therapeutic targets for treatment of diseases.

Peptides combine the high specificity of biological drugs with the bioavailability of small molecules, and, thus, offer exciting opportunities to address difficult targets for disease treatment. In fact, peptides have proven to be effective when used to target extracellular receptors, but limitations include the inherent instability of peptides within the body and rapid breakdown by circulating proteases. The concept of using peptides to modulate intracellular processes has been investigated for decades, yet these strategies have largely failed because peptides lack the ability to enter cells.

Cyclic peptides, with their conformational rigidity, exhibit superior properties relative to their linear peptide counterparts, such as improved target affinity and specificity. Their higher target specificity and affinity as well as resistance to proteolysis have made them attractive candidates for drug discovery. Cyclic peptides have been isolated from large combinatorial libraries using library screening tools, such as phage display and mRNA display, but improved methods are needed to screen large numbers of cyclic peptides, to mature cyclic peptides in situ, and to identify cyclic peptides of interest. Currently, there is no systematic approach to identifying and maturing cyclic peptides to obtain optimized cyclic peptide binders.

Another powerful method to study peptide-protein interactions is the use of peptide microarrays. Peptide microarrays can be made with peptides synthesized using solid phase peptide synthesis and then immobilized on a solid support or can be directly prepared by in situ synthesis methods. Although peptide microarrays are commercially available, their application is limited by a relatively low density of peptides and high cost of manufacturing. Both of these issues can be addressed by use of maskless light-directed technology, see (Pellois, Zhou et al. (2002) Individually addressable parallel peptide synthesis on microchips.) and U.S. Pat. No. 6,375,903.

Using an instrument for maskless light-directed microarray synthesis, the selection of peptide sequences to be constructed on the peptide microarray is under software control such that it is now possible to create individually-customized arrays based on the particular needs of an investigator. In general, maskless light-directed microarray synthesis technology allows for the parallel synthesis of millions of unique peptide features in a very small area of a standard microscope slide. The peptide microarrays are generally synthesized by using light to direct which peptides are synthesized at specific locations on the microarray.

There exists an unmet need for a more efficient and successful method of identifying therapeutic cyclic peptide candidates for existing and potential new drug targets, in part, because many targets and diseases are presently “undruggable” using existing therapeutic modalities.

### SUMMARY

Applicants disclose herein novel peptide microarrays, methods of generating peptide microarrays, and methods of identifying peptide binders using the microarrays described herein, wherein the microarrays comprise cyclic peptides. In one embodiment described herein, the cyclic peptides can be used as therapeutic peptides. Also disclosed herein are methods of increasing the proportion of cyclized peptides on a microarray relative to linear peptides by treating the peptides on the microarray with a protease. Further disclosed herein are methods of generating linear and cyclic peptides subarrays on the same microarray.

Several embodiments of the invention are described by the following enumerated clauses:

1. A peptide microarray comprising at least one cyclic peptide of formula I

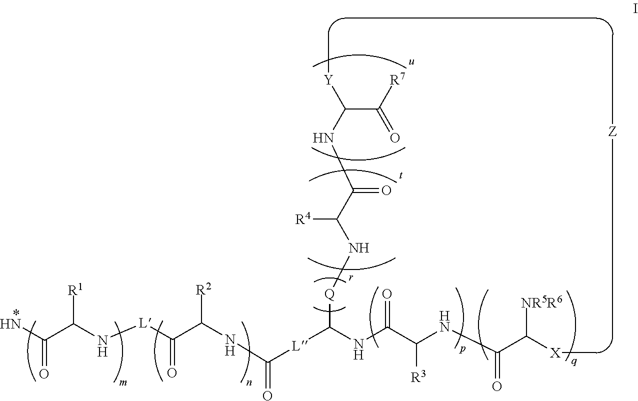

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6; p is an integer from 0 to 100;

q is 0 or 1;

r is 0 or 1;

t is an integer from 0 to 100;

u is 0 or 1;

and * is a point of connection connecting the at least one cyclic peptide to a solid support having a reactive surface,

wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

2. The peptide microarray of clause 1, wherein Z comprises a moiety selected from the group consisting of an amide bond,

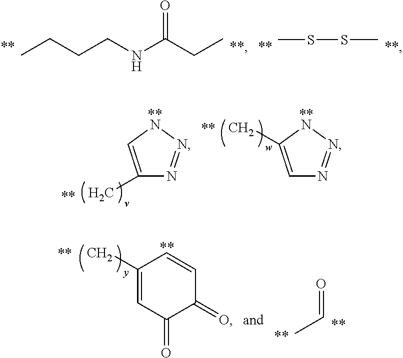

wherein v is an integer from 0 to 6, w is an integer from 0 to 6, and y is an integer from 0 to 6, and ** is a point of connection to the rest of the cyclic peptide.

3. The peptide microarray of clause 1 or 2, wherein Z comprises a peptide bond, Q is a carbonyl, q is 0, r is 1, and u is 0.

4. The peptide microarray of clause 1 or 2, wherein each Q and X is a cysteine side chain, Z is a disulfide bond, q is 1, r is 1, t is 0, and u is 0.

5. The peptide microarray of clause 1 or 2, wherein X and Y are bonds to Z, Z comprises **—S—S—**, q is 1, and u is 1.

6. The peptide microarray of clause 1 or 2, wherein Z comprises

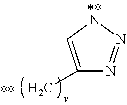

and v is 1.

7. The peptide microarray of clause 1 or 2, wherein Z comprises

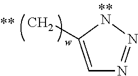

and w is 1.

8. The peptide microarray of clause 1 or 2, wherein Z comprises

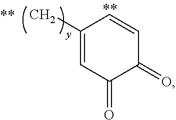

r is 0, t is 0, u is 0, and y is 1.

9. The peptide microarray of clause 1 or 2, wherein Y is a bond to Z, Z comprises

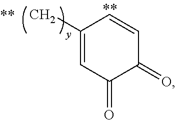

u is 1, and y is 1.

10. The peptide microarray of clause 1 or 2, wherein Y is a bond to Z, Z comprises

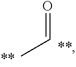

q is 0, and u is 1.

11. The peptide microarray of clause 1 or 2, wherein X is a bond to Z, Z comprises

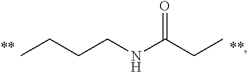

### q is 1, r is 0, t is 0, and u is O.

12. The peptide microarray of clause 1 or 2, wherein X and Y are bonds to Z, Z comprises

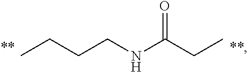

q is 1, and u is 1.

13. The peptide microarray of any one of clauses 1 to 12, wherein each L′ and L″ is independently of the formula II

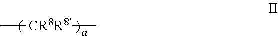

wherein each R⁸ and R^{8′} is independently selected from the group consisting of H, D, halogen, C₁-C₆ alkyl, C₂-C₆ alkenyl, C₂₋C₆ alkynyl, C₃₋C₆ cycloalkyl, 3- to 7-membered heterocycloalkyl, C₆-C₁₀ aryl, 5- to 7-membered heteroaryl, —OR⁹, —OC(O)R⁹, —NR⁹R^{9′}, —NR⁹C(O)R¹⁰, —C(O)R⁹, —C(O)OR⁹, and —C(O)NR⁹R^{9′}, wherein each hydrogen atom in C₁-C₆ alkyl, C₂-C₆ alkenyl, C₂₋C₆ alkynyl, C₃₋C₆ cycloalkyl, 3- to 7-membered heterocycloalkyl, C₆-C₁₀ aryl and 5- to 7-membered heteroaryl is independently optionally substituted by halogen, C₁-C₆ alkyl, C₂-C₆ alkenyl, C₂₋C₆ alkynyl, —OR¹¹; each R⁹, R^{9′}, R¹⁰, and R¹¹ is independently selected from the group consisting of H, D, hydroxyl, C₁-C₇ alkyl, C₂-C₇ alkenyl, C₂₋C₇alkynyl, C_{3—}C₆ cycloalkyl, 3- to 7-membered heterocycloalkyl, C₆-C₁₀ aryl and 5- to 7-membered heteroaryl; and a is an integer from 1 to 10; or the formula III or IV

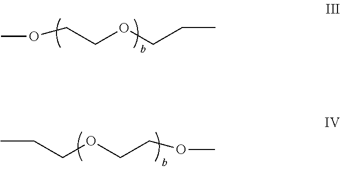

wherein b is an integer from 0 to 30.

14. The peptide microarray of clause 13, wherein each R⁸ and R^{8′} is hydrogen.

15. The peptide microarray of clause 13 or 14, wherein each L′ and L″ is independently

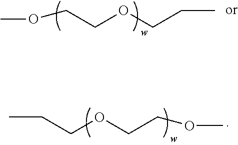

16. The peptide microarray of any one of clauses 1 to 15, wherein m is 0.

17. The peptide microarray of any one of clauses 1 to 16, wherein n is 0.

18. The peptide microarray of any one of clauses 1 to 12 or 16 to 17, wherein each R⁸ and R^{8′} is hydrogen, m is 0, n is 0, a is 5, L′ is present, and L″ is absent.

19. The peptide microarray of any one of clauses 1 to 13 or 16 to 18, wherein L′ is 6-aminohexanoic acid.

20. The peptide microarray of any one of clauses 1 to 14, 16 to 17, or 19, wherein L″ is CH₂CH₂.

21. The peptide microarray of any one of clauses 1 to 20, wherein t is 0, and p is an integer 1 to 100.

22. The peptide microarray of any one of clauses 1 to 21, wherein p is an integer 1 to 20.

23. The peptide microarray of any one of clauses 1 to 22, wherein the solid support is selected from a group of materials consisting of plastic, glass, and carbon composite.

24. The peptide microarray of any one of clauses 1 to 23, wherein the reactive surface comprises an activated amine.

25. The peptide microarray of any one of clauses 1 to 24, wherein the amino acid sequences of interest of the population of peptides comprise the same number of amino acids.

26. The peptide microarray of any one of clauses 1 to 25, wherein the amino acid sequences of interest of the population of peptides comprise five amino acids.

27. The peptide microarray of any one of clauses 1 to 26, wherein the amino acid sequences of interest of the population of peptides do not contain any of a methionine amino acid, a cysteine amino acid, an amino acid repeat of the same amino acid, or an amino acid motif consisting of a histidine (H)- proline (P)- glutamine (Q) sequence.

28. The peptide microarray of any one of clauses 1 to 27, wherein each cyclic peptide of the population of peptides further comprises at least one of an N-terminal wobble synthesis oligopeptide or a C-terminal wobble synthesis oligopeptide.

29. The peptide microarray of clause 28, wherein the wobble synthesis oligopeptide of each cyclic peptide of the population of peptides comprises an amino acid sequence having the same number of amino acids.

30. The peptide microarray of clause 28 or 29, wherein the wobble synthesis oligopeptide of each cyclic peptide of the population of peptides is derived randomly from an amino acid mixture having each of the twenty amino acids or a subset of the twenty amino acids in approximately equal concentrations.

31. The peptide microarray of clause 28 or 29, wherein the wobble synthesis oligopeptide of each cyclic peptide of the population of peptides is derived randomly from an amino acid mixture having amino acids glycine (G) and serine (S) in approximately a 3 (G) to 1 (S) concentration.

32. The peptide microarray of any one of clauses 28 to 31, wherein there is a C-terminal and an N-terminal wobble synthesis oligopeptide and both the C-terminal and N-terminal wobble synthesis oligopeptides comprise the same number of five or more amino acids.

33. A method of generating a peptide microarray comprising at least one cyclic peptide of formula I

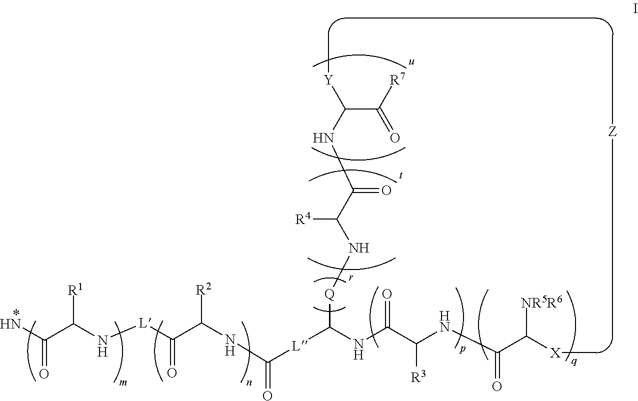

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and * is a point of connection connecting the at least one cyclic peptide to a solid support having a reactive surface;

the method comprising the step of reacting a functionalized peptide of formula II under conditions that cause Z to form

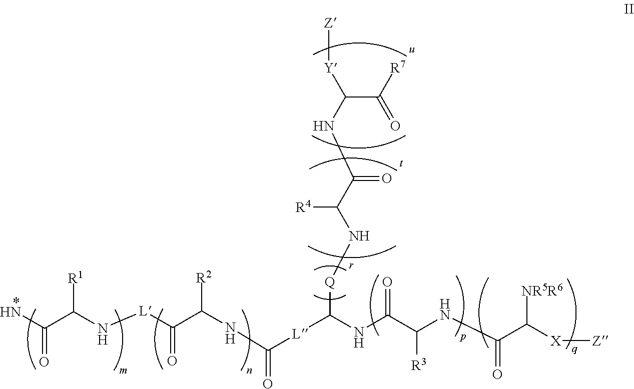

wherein R¹, R² R³, R⁴, R⁵, R⁶, Q, L′, L″, m, n, p, q, r, t, u, and * are as defined for formula I;

each R⁷ is independently selected from the group consisting of —OH, a C-terminal capping group, and

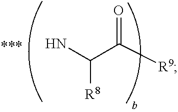

each R⁸ is independently a natural amino acid side chain or a non-natural amino acid side chain;

each R⁹ is independently —OH or a C-terminal capping group;

each X′ is independently selected from the group consisting of a bond, a natural amino acid side chain covalently attached to Z″, and a non-natural amino acid side chain covalently attached to Z″;

each Y′ is independently selected from the group consisting of a bond, a natural amino acid side chain covalently attached to Z′, and a non-natural amino acid side chain covalently attached to Z′;

Z′ and Z″ are each independently selected from the group consisting of a bond, —OH, hydrogen, a thiol, an amine, a carboxylic acid, an amide, an alkyne, an azide, an optionally substituted aminophenol, a natural amino acid side chain, a non-natural amino acid side chain, an N-terminal protecting group, and a C-terminal protecting group, provided that Z′ and Z″ are complementary groups that combine to form Z;

b is an integer from 0 to 50;

and *** is a point of connection to the rest of the functionalized peptide;

wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

34. The method of clause 33, wherein Z comprises a moiety selected from the group consisting of an amide bond,

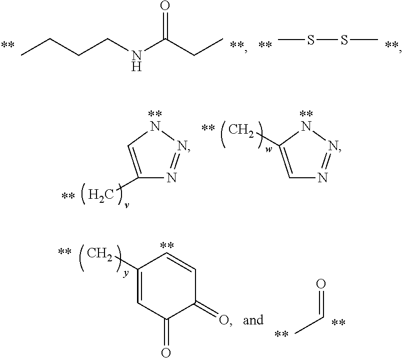

wherein v is an integer from 0 to 6, w is an integer from 0 to 6, and y is an integer from 0 to 6, and ** is a point of connection to the rest of the cyclic peptide.

35. The method of clause 33 or 34, wherein Z comprises a peptide bond, Z′ comprises a C-terminal protecting group or Z″ comprises an N-terminal protecting group, Q is a carbonyl, q is 0, r is 1 and u is 0.

36. The method of clause 35, further comprising removing Z′ or Z″ from the rest of the functionalized peptide to cause the peptide bond to form.

37. The method of clause 33 or 34, wherein X and Y are bonds to Z, Z comprises **—S—S—**, X′ is a bond to Z″, Y′ is a bond to Z′, Z′ and Z″ comprise cysteine side chains, q is 1, and u is 1.

38. The method of clause 37, further comprising subjecting the functionalized peptide to oxidative conditions to cause **—S—S—** to form.

39. The method of clause 33 or 34, wherein Y is a bond to Z, Z comprises

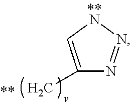

Y′ is a bond to Z′, Z′ comprises

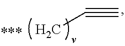

Z″ comprises an azide, u is 1, and v is 1.

40. The method of clause 39, further comprising contacting the functionalized peptide with a copper catalyst to cause

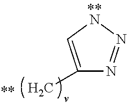

to form.

41. The method of clause 33 or 34, wherein Y is a bond to Z, Z comprises

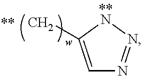

Y′ is a bond to Z′, Z′ comprises

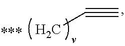

Z″ comprises an azide, u is 1, and v is 1.

42. The method of clause 41, further comprising contacting the functionalized peptide with a copper catalyst to cause

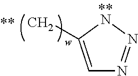

to form.

43. The method of clause 33 or 34, wherein Z comprises

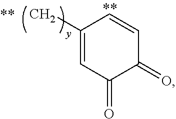

Y′ is a bond to Z′, Z′ comprises

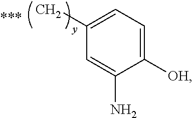

r is 0, u is 1, and y is 1.

44. The method of clause 43, further comprising contacting the functionalized peptide with a potassium ferricyanide to cause

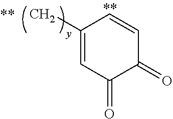

to form.

45. The method of clause 33 or 34, wherein R³ and R⁸ are defined such that the functionalized peptide comprises a butelase 1 recognition sequence, Y is a bond to Z, Z comprises

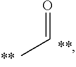

Y′ is a bond to Z′, Z′ is an asparagine or aspartic acid side chain, q is 0, and u is 1.

46. The method of clause 45, further comprising contacting the functionalized peptide with butelase 1 to cause

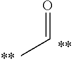

to form.

47. The method of clause 33 or 34, wherein X and Y are bonds to Z, Z comprises

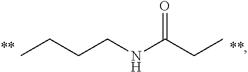

X′ is a bond to Z″, Y′ is a bond to Z′, Z′ is a glutamine side chain and Z″ is a lysine side chain or Z′ is a lysine side chain and Z″ is a glutamine side chain, q is 1, and u is 1.

48. The method of clause 47, further comprising contacting the functionalized peptide with a microbial transglutaminase to cause

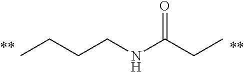

to form.

49. The method of any one of clauses 33 to 48, wherein L′ is 6-aminohexanoic acid.

50. The method of any one of clauses 33 to 49, wherein L″ is CH₂CH₂.

51. The method of any one of clauses 33 to 50, wherein m is 0.

52. The method of any one of clauses 33 to 51, wherein n is 0.

53. The method of any one of clauses 33 to 52, wherein t is 0, and p is an integer 1 to 100.

54. The method of any one of clauses 33 to 53, wherein p is an integer 1 to 20.

55. The method of clause 33 or 34, wherein Q is a carbonyl, Z is an amide bond, r is 1, u is 0, and q is 0.

56. The method of any one of clauses 33 to 55, wherein the solid support is selected from a group of materials consisting of plastic, glass and carbon composite.

57. The method of any one of clauses 33 to 56, wherein the reactive surface comprises an activated amine.

58. The method of any one of clauses 33 to 57, wherein the amino acid sequences of interest of the population of peptides comprise the same number of amino acids.

59. The method of any one of clauses 33 to 58, wherein the amino acid sequences of interest of the population of peptides comprise five amino acids.

60. The method of any one of clauses 33 to 59, wherein the amino acid sequences of interest of the population of peptides do not contain any of a methionine amino acid, a cysteine amino acid, an amino acid repeat of the same amino acid, or an amino acid motif consisting of a histidine (H)- proline (P)- glutamine (Q) sequence.

61. The method of any one of clauses 33 to 60, wherein each cyclic peptide of the population of peptides further comprises at least one of an N-terminal wobble synthesis oligopeptide or a C-terminal wobble synthesis oligopeptide.

62. The method of clause 61, wherein the wobble synthesis oligopeptide of each cyclic peptide of the population of peptides comprises an amino acid sequence having the same number of amino acids.

63. The method of clause 61 or 62, wherein the wobble synthesis oligopeptide of each cyclic peptide of the population of peptides is derived randomly from an amino acid mixture having each of the twenty amino acids or a subset of the twenty amino acids in approximately equal concentrations.

64. The method of clause 61 or 62, wherein the wobble synthesis oligopeptide of each cyclic peptide of the population of peptides is derived randomly from an amino acid mixture having amino acids glycine (G) and serine (S) in approximately a 3 (G) to 1 (S) concentration.

65. The method of any one of clauses 61 to 64, wherein there is a C-terminal and an N-terminal wobble synthesis oligopeptide and both the C-terminal and N-terminal wobble synthesis oligopeptides comprise the same number of five or more amino acids.

66. A method of preparing a peptide microarray comprising:

generating at least one first linear peptide subarray comprising a first plurality of linear peptides covalently attached to a microarray surface;

generating at least one second linear peptide subarray comprising a second plurality of linear peptides covalently attached to the microarray surface, wherein the second plurality of linear peptides has an amino acid sequence that is identical to the first plurality of linear peptides; and

treating the peptide microarray under conditions to cyclize the first plurality of linear peptides to provide at least one cyclized peptide subarray comprising a plurality of cyclized peptides, wherein the second plurality of linear peptides substantially does not cyclize.

67. The method of clause 66, wherein the first plurality of linear peptides is a first plurality of protected linear peptides, wherein the C-terminus of the first plurality of protected linear peptides is protected by a first protecting group; and

the second plurality of linear peptides is a second plurality of protected linear peptides, wherein the second plurality of protected linear peptides has an amino acid sequence that is identical to the first plurality of protected linear peptides, and wherein the C-terminus of the second plurality of protected linear peptides is protected by a second protecting group that is different from the first protecting group.

68. The method of clause 67, further comprising contacting the peptide microarray with a first deprotection reagent to selectively remove the first protecting group to provide at least one first deprotected linear peptide subarray comprising a first plurality of deprotected linear peptides; and

contacting the peptide microarray with a second deprotection reagent to remove the second protecting group to provide at least one second deprotected linear peptide subarray comprising a second plurality of deprotected linear peptides.

69. The method of any one of clauses 66-68, wherein the first plurality of linear peptides and the second plurality of linear peptides are each covalently attached to the microarray surface through an amino acid side chain.

70. The method of clause 69, wherein the amino acid side chain is a carboxylic acid side chain.

71. The method of clause 70, wherein the carboxylic acid side chain is a glutamate or aspartate side chain.

72. The method of any one of clauses 69 to 71, wherein the amino acid side chain is part of the C-terminal amino acid.

73. The method of any one of clauses 66 to 72, wherein at least one molecule of the first plurality of linear peptides fails to cyclize.

74. The method of clause 73, wherein the at least one of the first plurality of linear peptides that fails to cyclize is not removed from the first deprotected linear peptide subarray.

75. The method of any one of clauses 67 to 74, wherein the first protecting group is OAll.

76. The method of any one of clauses 67 to 75, wherein the first deprotection reagent is a palladium catalyst.

77. The method of clause 76, wherein the palladium catalyst is tetrakis(triphenylphosphine)palladium(O).

78. The method of any one of clauses 67 to 77, wherein the second protecting group is OtBu.

79. The method of any one of clauses 67 to 78, wherein the second deprotection reagent is an acid.

80. The method of clause 79, wherein the acid is trifluoroacetic acid. 81. The method of any one of clauses 66 to 80, wherein treating the peptide microarray under conditions to cyclize the first plurality of linear peptides comprises activating the carboxyl group of the C-terminus of the first plurality of linear peptides to react with the amino group of the N-terminus of the first plurality of linear peptides to form an amide bond.

82. The method of any one of clauses 66 to 81, wherein treating the peptide microarray under conditions to cyclize the first plurality of linear peptides comprises contacting the first plurality of linear peptides with HOBt and HBTU.

83. A method of identifying an active cyclic peptide comprising generating a peptide microarray according to the method of any one of clauses 66 to 82, contacting the peptide microarray with a potential binding group, and measuring the presence of the potential binding group on the peptide microarray after the contacting step.

84. The method of clause 83, wherein the measuring step comprises measuring fluorescent activity.

85. A method of generating a peptide microarray comprising at least one cyclic peptide of formula III

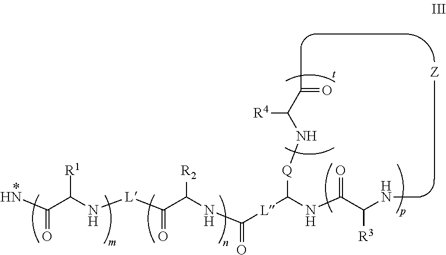

wherein each R¹, R², R³ and R⁴ is independently a natural amino acid side chain or a non-natural amino acid side chain;

Q is a carbonyl;

L′ and L″ are each independently an optional bivalent linking group or a bond;

m is an integer from 0 to 6;

n is an integer from 0 to 6;

p is an integer from 0 to 100;

t is an integer from 0 to 100; and

* is a point of connection connecting the at least one cyclic peptide to a solid support having a reactive surface;

the method comprising generating a plurality of first peptides on a cyclic peptide subarray, wherein the first peptide is of formula IV

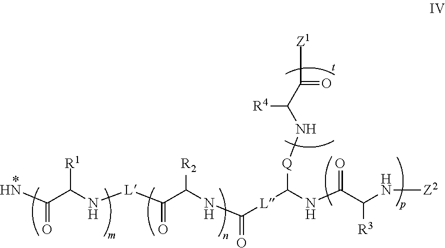

wherein R¹, R², R³, R⁴, Q, L′, L″, m, n, p, t, and * are as defined for formula III;

Z¹ is a first carboxyl protecting group; and

Z² is hydrogen;

generating a plurality of second peptides on a linear peptide subarray, wherein the second peptide is of formula V

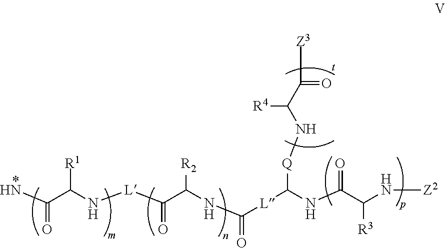

wherein R¹, R², R³, R⁴, Q, L′, L″, Z², m, n, p, t, and * are as defined for formula IV; and

Z³ is a second carboxyl protecting group different from the first carboxyl protecting group; and

is hydrogen; and

treating the first peptides to form a first plurality of linear deprotected peptides, wherein the linear deprotected peptide is of formula VI

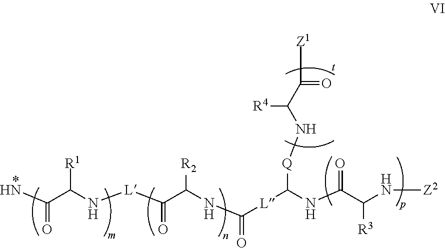

wherein R¹, R², R³, R⁴, Q, L′, L″, Z², m, n, p, t, and * are as defined for formula IV; and

Z¹ is —OH; followed by

treating the linear deprotected peptides to form the cyclic peptide; followed by

treating the second peptides to form a second plurality of linear deprotected peptides of formula VI;

wherein the first peptides and the second peptides are immobilized to the reactive surface, and wherein the at least one cyclic peptide is part of a population of peptides immobilized to the reactive surface wherein the population of peptides comprises independently selected amino acid sequences of interest.

86. The method of clause 85, wherein L′ is 6-aminohexanoic acid.

87. The method of clause 85 or 86, wherein L″ is CH₂CH₂.

88. The method of any one of clauses 85 to 87, wherein m is 0.

89. The method of any one of clauses 85 to 88, wherein n is 0.

90. The method of any one of clauses 85 to 89, wherein t is 0, and p is an integer 1 to 100.

91. The method of any one of clauses 85 to 90, wherein p is an integer 1 to 20.

92. The method of any one of clauses 85 to 91, wherein at least one molecule of the linear deprotected peptides on the cyclic peptide subarray fails to cyclize.

93. The method of any one of clauses 85 to 92, wherein the linear deprotected peptides on the cyclic peptide subarray are not removed from the cyclic peptide subarray.

94. The method of any one of clauses 85 to 93, wherein the first carboxyl protecting group is OAll.

95. The method of any one of clauses 85 to 94, wherein treating the first peptides to form the first plurality of linear deprotected peptides comprises contacting the first peptides with palladium.

96. The method of any one of clauses 85 to 95, wherein the second carboxyl protecting group is OtBu.

97. The method of any one of clauses 85 to 96, wherein treating the second peptides to form the second plurality of linear deprotected peptides comprises contacting the second peptides with an acid.

98. The method of clause 97, wherein the acid is trifluoroacetic acid.

99. The method of any one of clauses 85 to 98, wherein treating the first peptides to form the cyclic peptide comprises activating a carboxyl group of the first peptide to react with a free amino group of the first peptide to form Z.

100. The method of any one of clauses 85 to 99, wherein treating the first peptides to form the cyclic peptide comprises contacting the first peptides with HOBt and HBTU.

101. A method of identifying an active cyclic peptide comprising generating a peptide microarray according to the method of any one of clauses 85 to 100, contacting the peptide microarray with a potential binding group, and measuring the presence of the potential binding group on the peptide microarray after the contacting step.

102. The method of clause 101, wherein the measuring step comprises measuring fluorescent activity.

103. A method of identifying a peptide binder comprising the steps of:

a. exposing a target of interest to a peptide microarray comprising a first population of peptide binders comprising a cyclic peptide of formula I

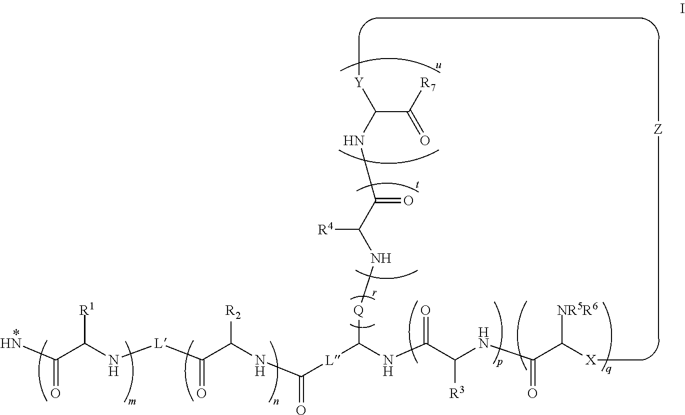

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a first solid support having a first reactive surface, whereby the target of interest binds to the cyclic peptide;

b. identifying overlap in peptide binder sequences of the first population of peptide binders which bind the target of interest, whereby a core binder sequence is determined;

c. performing at least one alteration selected from a single amino acid substitution, a double amino acid substitution, an amino acid deletion, and an amino acid insertion of amino acids to the core binder sequence, whereby a second population of core binder sequences is generated;

d. exposing the second population of core binder sequences to the target of interest, whereby the target of interest binds to at least one peptide sequence of the second population of core binder sequences and wherein the second population of core binder sequences comprises the cyclic peptide of formula I

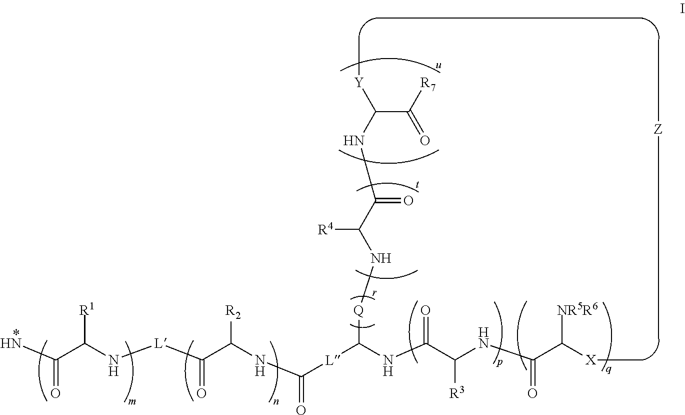

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a second solid support having a second reactive surface;

e. identifying one or more sequences of the second population of core binder sequences demonstrating strong binding properties to the target of interest, whereby a matured core binder sequence is determined;

f. performing at least one of N-terminal and C-terminal extension of the matured core peptide binder sequence determined in step e, whereby a population of matured, extended peptide binders is generated;

g. exposing the target of interest to a peptide microarray comprising the population of matured, extended peptide binders generated in step f wherein the population of mature, extended peptide binders comprises the cyclic peptide of formula I

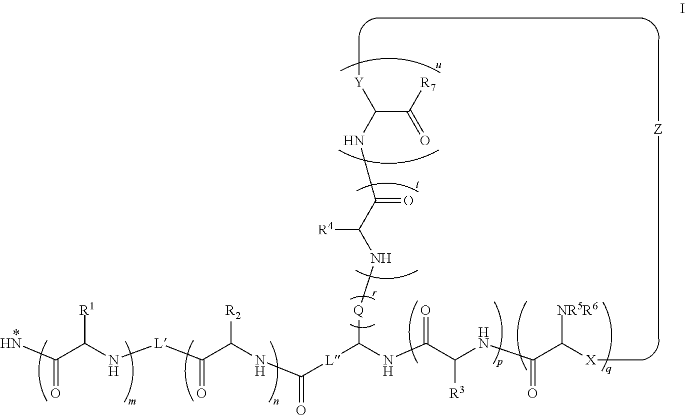

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a third solid support having a third reactive surface; and

h. identifying overlap in the N-terminal or C-terminal peptide binder sequences of the peptides comprising the population of mature, extended peptide binders, whereby a mature, extended core peptide binder sequence is determined.

104. The method of clause 103, wherein Z comprises a moiety selected from the group consisting of an amide bond,

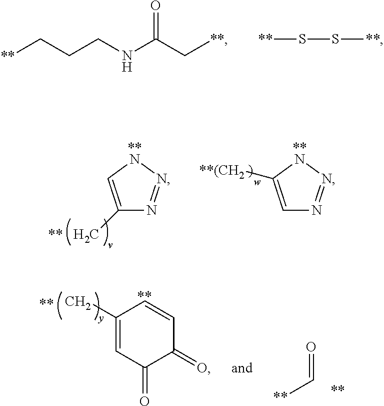

wherein v is an integer from 0 to 6, w is an integer from 0 to 6, and y is an integer from 0 to 6, and ** is a point of connection to the rest of the cyclic peptide.

105. The method of clause 103 or 104, wherein Z comprises a peptide bond, Q is a carbonyl, q is 0, r is 1 and u is 0.

106. The method of clause 103 or 104, wherein X and Y are bonds to Z, Z comprises **—S—S—**, q is 1, and u is 1.

107. The method of clause 103 or 104, wherein Z comprises

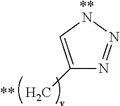

and v is 1.

108. The method of clause 103 or 104, wherein Z comprises

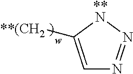

and w is 1.

109. The method of clause 103 or 104, wherein Y is a bond to Z, Z comprises

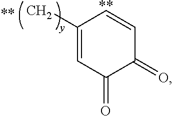

u is 1, and y is 1.

110. The method of clause 103 or 104, wherein Y is a bond to Z, Z comprises

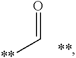

q is 0, and u is 1.

111. The method of clause 103 or 104, wherein X and Y are bonds to Z, Z comprises

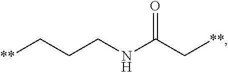

q is 1, and u is 1.

112. The method of any one of clauses 103 to 111, wherein L′ is 6-aminohexanoic acid.

113. The method of any one of clauses 103 to 112, wherein L″ is CH₂CH₂.

114. The method of any one of clauses 103 to 113, wherein m is 0.

115. The method of any one of clauses 103 to 114, wherein n is 0.

116. The method of any one of clauses 103 to 115, wherein t is 0, and p is an integer 1 to 100.

117. The method of any one of clauses 103 to 116, wherein p is an integer 1 to 20.

118. The method of any one of clauses 103 to 117, wherein at least one of a label-free and affinity analysis of the mature, extended core peptide binder sequence is performed.

119. The method of any one of clauses 103 to 118, wherein the first, second, and/or third solid support comprises at least one of glass, plastic, and carbon composite.

120. The method any one of clauses 103 to 119, wherein the peptide binders of the first population comprise the same number of amino acids.

121. The method of any one of clauses 103 to 120, wherein the peptide binders of the first population do not include the amino acid cysteine or methionine, or histidine-proline-glutamine motifs, or amino acid repeats of 2 or more amino acids.

122. The method of any one of clauses 103 to 121, wherein the cyclic peptide binders of the population of mature, extended peptide binders include at least one of an N-terminal wobble synthesis oligopeptide and a C-terminal wobble synthesis oligopeptide.

123. The method of any one of clauses 103 to 122, wherein the core binder sequence comprises a greater number of amino acids than the number of amino acids for each of the peptides comprising the first population of peptide binders.

124. The method of any one of clauses 103 to 123, wherein steps e. and h. comprise principled clustering analysis.

125. The method of any one of clauses 103 to 124, wherein steps c. to h. are repeated for the mature, extended core peptide binder sequence.

126. The method of any one of clauses 103 to 125 wherein the peptide microarray comprises one or more linear peptides and wherein the method further comprises the step of contacting the one or more linear peptides on the peptide microarray with a protease capable of digesting the one or more linear peptides.

127. The method of clause 126 wherein the protease is an amino protease or a mixture of amino proteases.

128. The method of clause 127 wherein the protease is dipeptidyl peptidase IV, aminopeptidase m, or a combination thereof.

129. The method of clause 45 or 46 wherein the butelase 1 recognition sequence is NHV.

130. The method of clause 47 or 48 wherein the glutamine side chain is part of the sequence [WY][DE][DE][YW]ALQ[GST]YD (SEQ ID NO: 194) and the lysine side chain is part of the sequence RSKLG (SEQ ID NO: 195).

### BRIEF DESCRIPTION OF THE DRAWINGS

FIG. 1 is a schematic view of a microarray system for array synthesis by way of a photolithographic technique utilizing photolithographic mask (Prior art).

FIG. 2 is a schematic view of a microarray system for array synthesis by way of a photolithographic technique utilizing maskless photolithography (Prior art).

FIG. 3 is a schematic view illustrating arrays comprising peptide probes thereon in accordance with the present disclosure.

FIG. 4 is a schematic illustration of an embodiment of a process of the present disclosure.

FIG. 5 is a schematic view illustrating another embodiment of an array comprising peptide probes thereon in accordance with the present disclosure.

FIG. 6 is a schematic view depicting an embodiment of the process of FIG. 4.

FIG. 7 is a schematic view depicting a reaction scheme for head-to-tail (amide bond formation) cyclization of peptide libraries on a surface.

FIG. 8A is a slide image of subarrays of peptides each having a glutamate linker amino acid where (bottom) a linear library of peptides is formed from OtBu-protected variants of the glutamate linker amino acid after deprotection and biotin labelling, and (top) a cyclic library of peptides is formed from OAll-protected variants of the glutamate linker amino acid after deprotection and biotin labelling.

FIG. 8B is a schematic view depicting (bottom) deprotection of OtBu-protected variants of glutamate, followed by biotin labelling and (top) deprotection of OAll-protected variants of glutamate, followed by biotin labelling.

FIG. 9A and 9B are schematic views depicting a process for forming subarrays of linear and cyclic peptide libraries where the peptides of the cyclic library that fail to cyclize are the same as those of the linear library.

FIG. 10 is a chart showing cyclic versus linear fluorescent intensity for a peptide library of the format XXXXU bound to streptavidin-Cy5.

FIG. 11 is a chart showing surface plasmon resonance (SPR) binding curves of a head-to-tail cylic NQpWQ (SEQ ID NO: 84) peptide to a streptavidin coated CM5 BIAcore chip.

FIG. 12 is a chart showing surface plasmon resonance (SPR) binding of a head-to-tail cylic NQpWQ (SEQ ID NO: 84) peptide to a streptavidin coated CM5 BIAcore chip versus peptide concentration. The dashed line indicates the binding constant.

FIG. 13 is a chart showing cyclic versus linear fluorescent intensity for a peptide library of the format JXXHPQXXJU (SEQ ID NO: 86) bound to streptavidin-Cy5.

FIG. 14 is a chart showing cyclic fluorescent intensity versus log fold change (logFC) between cyclic and linear fluorescent intensity for a peptide library of the format JXXHPQXXJU (SEQ ID NO: 86) bound to streptavidin-Cy5. The darker points indicate the top 100 JXXHPQXXJU (SEQ ID NO: 86) cyclic peptides.

FIG. 15 is a chart showing cyclic fluorescent intensity versus log fold change (logFC) between cyclic and linear fluorescent intensity for a peptide library of the format JXXHPQXXJU (SEQ ID NO: 86) bound to streptavidin-Cy5, where each XXHPQXX (SEQ ID NO: 187) corresponds to one of the top 100 cyclic peptides of the chart shown in FIG. 14, and J is random. FIG. 15 discloses SEQ ID NOS 230-231, respectively, in order of appearance.

FIG. 16 is a chart showing surface plasmon resonance (SPR) binding curves of a head-to-tail cylic LYDHPQNGGQ (SEQ ID NO: 190) peptide to a streptavidin coated CM5 BIAcore chip at various peptide concentrations.

FIG. 17 is a chart showing surface plasmon resonance (SPR) binding of a head-to-tail cylic LYDHPQNGGQ (SEQ ID NO: 190) peptide to a streptavidin coated CM5 BIAcore chip versus peptide concentration. The dashed line indicates the binding constant.

FIG. 18 is a chart showing surface plasmon resonance (SPR) binding curves of a linear NH₂-LYDHPQNGGQ-COOH (SEQ ID NO: 191) peptide to a streptavidin coated CM5 BIAcore chip at various peptide concentrations.

FIG. 19 is a chart showing surface plasmon resonance (SPR) binding of a linear NH₂-LYDHPQNGGQ-COOH (SEQ ID NO: 191) peptide to a streptavidin coated CM5 BIAcore chip versus peptide concentration. The dashed line indicates the binding constant.

FIG. 20 is a chart showing surface plasmon resonance (SPR) binding curves of a head-to-tail cylic QNDHPQNGGQ (SEQ ID NO: 192) peptide to a streptavidin coated CM5 BIAcore chip at various peptide concentrations.

FIG. 21 is a chart showing surface plasmon resonance (SPR) binding of a head-to-tail cylic QNDHPQNGGQ (SEQ ID NO: 192) peptide to a streptavidin coated CM5 BIAcore chip versus peptide concentration. The dashed line indicates the binding constant.

FIG. 22 is a chart showing surface plasmon resonance (SPR) binding curves of a linear NH₂-QNDHPQNGGQ-COOH (SEQ ID NO: 193) peptide to a streptavidin coated CM5 BIAcore chip at various peptide concentrations.

FIG. 23 is a chart showing surface plasmon resonance (SPR) binding of a linear NH₂-QNDHPQNGGQ-COOH (SEQ ID NO: 193) peptide to a streptavidin coated CM5 BIAcore chip versus peptide concentration. The dashed line indicates the binding constant.

### DETAILED DESCRIPTION OF ILLUSTRATIVE EMBODIMENTS

The instant disclosure provides peptide microarrays, methods of generating peptide microarrays, and methods of identifying peptide binders (e.g., cyclic peptides) using microarrays by which novel peptide binders (e.g., cyclic peptides) can be synthesized, optimized and identified. In some embodiments, the final optimization step is cyclization according to the methods described herein after the peptide binders are matured and extended on the peptide microarray.

According to some embodiments, the peptide microarrays disclosed herein identify peptide binders (e.g., cyclic peptides) through identification of overlapping binding of the target of interest to small peptides comprising a comprehensive population of peptides immobilized on a peptide microarray, then performing an exhaustive peptide maturation of the isolated core binder sequence, followed by N-terminal and C-terminal extension procedures and, in one embodiment, followed by cyclization. In some embodiments, the mature, extended core peptide binder sequence may be subjected to further maturation processes and a new series of N-terminal and C-terminal extension processes, and, for example, followed by cyclization.

Several embodiments of the invention are described in the Summary section of this patent application and each of the embodiments described in this Detailed Description section of the application applies to the embodiments described in the Summary, including the embodiments described by the enumerated clauses below.

1. A peptide microarray comprising at least one cyclic peptide of formula I

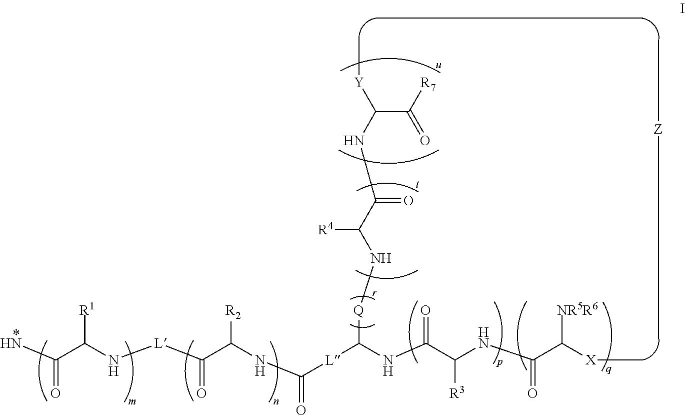

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1;

and * is a point of connection connecting the at least one cyclic peptide to a solid support having a reactive surface,

wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

2. The peptide microarray of clause 1, wherein Z comprises a moiety selected from the group consisting of an amide bond,

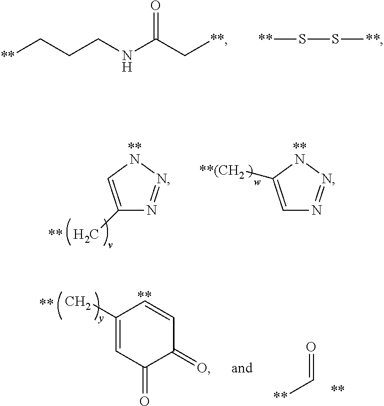

wherein v is an integer from 0 to 6, w is an integer from 0 to 6, and y is an integer from 0 to 6, and ** is a point of connection to the rest of the cyclic peptide.

3. The peptide microarray of clause 1 or 2, wherein Z comprises a peptide bond, Q is a carbonyl, q is 0, r is 1, and u is 0.

4. The peptide microarray of clause 1 or 2, wherein each Q and X is a cysteine side chain, Z is a disulfide bond, q is 1, r is 1, t is 0, and u is 0.

5. The peptide microarray of clause 1 or 2, wherein X and Y are bonds to Z, Z comprises **—S—S—**, q is 1, and u is 1.

6. The peptide microarray of clause 1 or 2, wherein Z comprises

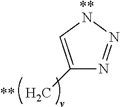

and v is 1.

7. The peptide microarray of clause 1 or 2, wherein Z comprises

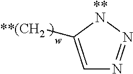

and w is 1.

8. The peptide microarray of clause 1 or 2, wherein Z comprises

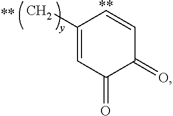

r is 0, t is 0, u is 0, and y is 1.

9. The peptide microarray of clause 1 or 2, wherein Y is a bond to Z, Z comprises

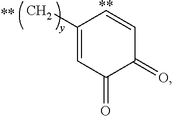

u is 1, and y is 1.

10. The peptide microarray of clause 1 or 2, wherein Y is a bond to Z, Z comprises

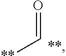

q is 0, and u is 1.

11. The peptide microarray of clause 1 or 2, wherein X is a bond to Z, Z comprises

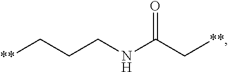

q is 1, r is 0, t is 0, and u is 0.

12. The peptide microarray of clause 1 or 2, wherein X and Y are bonds to Z, Z comprises

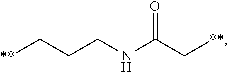

q is 1, and u is 1.

13. The peptide microarray of any one of clauses 1 to 12, wherein each L′ and

L″ is independently of the formula II

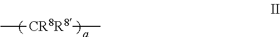

wherein each R⁸ and R⁸′ is independently selected from the group consisting of H, D, halogen, C₁-C₆ alkyl, C₂-C₆ alkenyl, C₂₋C₆ alkynyl, C₃₋C₆ cycloalkyl, 3- to 7-membered heterocycloalkyl, C₆-C₁₀ aryl, 5- to 7-membered heteroaryl, —OR⁹, —OC(O)R⁹, —NR⁹R⁹′, —NR⁹C(O)R¹⁰ —C(O)R⁹, —C(O)OR⁹, and —C(O)NR⁹R⁹′, wherein each hydrogen atom in C₁-C₆ alkyl, C₂-C₆ alkenyl, C₂₋C₆ alkynyl, C₃₋C₆ cycloalkyl, 3- to 7-membered heterocycloalkyl, C₆-C₁₀ aryl and 5- to 7-membered heteroaryl is independently optionally substituted by halogen, C₁-C₆ alkyl, C₂-C₆ alkenyl, C₂₋C₆ alkynyl, —OR¹¹; each R⁹, R⁹′, R¹⁰, and R¹¹ is independently selected from the group consisting of H, D, hydroxyl, C₁-C₇ alkyl, C₂-C₇ alkenyl, C₂₋C₇alkynyl, C₃₋C₆ cycloalkyl, 3- to 7-membered heterocycloalkyl, C₆-C₁₀ aryl and 5- to 7-membered heteroaryl; and a is an integer from 1 to 10; or the formula III or IV

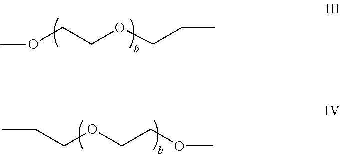

wherein b is an integer from 0 to 30.

14. The peptide microarray of clause 13, wherein each R⁸ and R^{8′} is hydrogen.

15. The peptide microarray of clause 13 or 14, wherein each L′ and L″ is independently

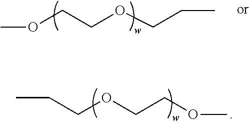

16. The peptide microarray of any one of clauses 1 to 15, wherein m is 0.

17. The peptide microarray of any one of clauses 1 to 16, wherein n is 0.

18. The peptide microarray of any one of clauses 1 to 12 or 16 to 17, wherein each R⁸ and R^{8′} is hydrogen, m is 0, n is 0, a is 5, L′ is present, and L″ is absent.

19. The peptide microarray of any one of clauses 1 to 13 or 16 to 18, wherein L′ is 6-aminohexanoic acid.

20. The peptide microarray of any one of clauses 1 to 14, 16 to 17, or 19, wherein L″ is CH₂CH₂.

21. The peptide microarray of any one of clauses 1 to 20, wherein t is 0, and p is an integer 1 to 100.

22. The peptide microarray of any one of clauses 1 to 21, wherein p is an integer 1 to 20.

23. The peptide microarray of any one of clauses 1 to 22, wherein the solid support is selected from a group of materials consisting of plastic, glass, and carbon composite.

24. The peptide microarray of any one of clauses 1 to 23, wherein the reactive surface comprises an activated amine. 25. The peptide microarray of any one of clauses 1 to 24, wherein the amino acid sequences of interest of the population of peptides comprise the same number of amino acids.

26. The peptide microarray of any one of clauses 1 to 25, wherein the amino acid sequences of interest of the population of peptides comprise five amino acids.

27. The peptide microarray of any one of clauses 1 to 26, wherein the amino acid sequences of interest of the population of peptides do not contain any of a methionine amino acid, a cysteine amino acid, an amino acid repeat of the same amino acid, or an amino acid motif consisting of a histidine (H)— proline (P)— glutamine (Q) sequence.

28. The peptide microarray of any one of clauses 1 to 27, wherein each cyclic peptide of the population of peptides further comprises at least one of an N-terminal wobble synthesis oligopeptide or a C-terminal wobble synthesis oligopeptide.

29. The peptide microarray of clause 28, wherein the wobble synthesis oligopeptide of each cyclic peptide of the population of peptides comprises an amino acid sequence having the same number of amino acids.

30. The peptide microarray of clause 28 or 29, wherein the wobble synthesis oligopeptide of each cyclic peptide of the population of peptides is derived randomly from an amino acid mixture having each of the twenty amino acids or a subset of the twenty amino acids in approximately equal concentrations.

31. The peptide microarray of clause 28 or 29, wherein the wobble synthesis oligopeptide of each cyclic peptide of the population of peptides is derived randomly from an amino acid mixture having amino acids glycine (G) and serine (S) in approximately a 3 (G) to 1 (S) concentration.

32. The peptide microarray of any one of clauses 28 to 31, wherein there is a C-terminal and an N-terminal wobble synthesis oligopeptide and both the C-terminal and N-terminal wobble synthesis oligopeptides comprise the same number of five or more amino acids.

33. A method of generating a peptide microarray comprising at least one cyclic peptide of formula I

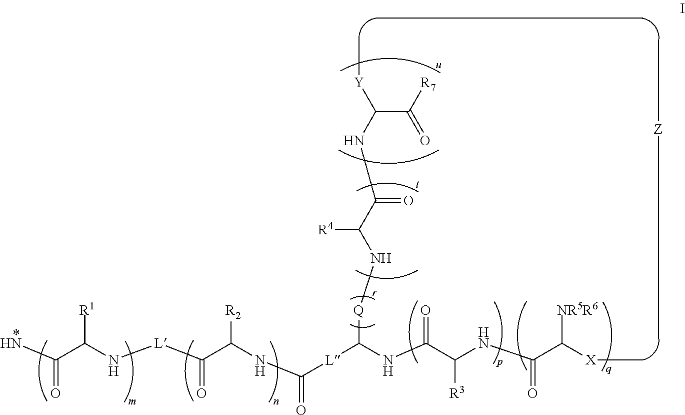

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and * is a point of connection connecting the at least one cyclic peptide to a solid support having a reactive surface;

the method comprising the step of reacting a functionalized peptide of formula II under conditions that cause Z to form

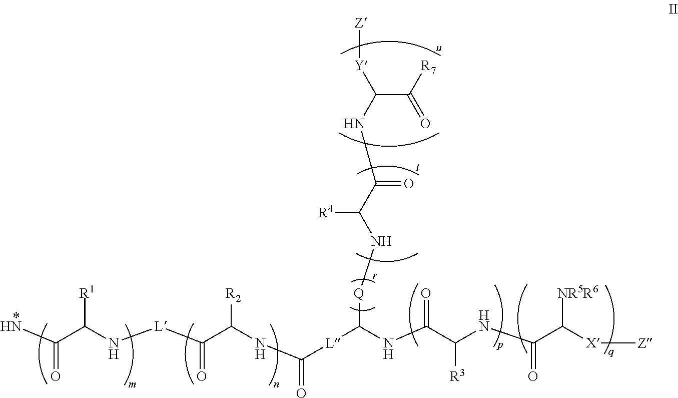

wherein R¹, R² R³, R⁴, R⁵, R⁶, Q, L′, L″, m, n, p, q, r, t, u, and * are as defined for formula I;

each R⁷ is independently selected from the group consisting of —OH, a C-terminal capping group, and

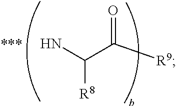

each R⁸ is independently a natural amino acid side chain or a non-natural amino acid side chain;

each R⁹ is independently —OH or a C-terminal capping group;

each X′ is independently selected from the group consisting of a bond, a natural amino acid side chain covalently attached to Z″, and a non-natural amino acid side chain covalently attached to Z″;

each Y′ is independently selected from the group consisting of a bond, a natural amino acid side chain covalently attached to Z′, and a non-natural amino acid side chain covalently attached to Z′;

Z′ and Z″ are each independently selected from the group consisting of a bond, —OH, hydrogen, a thiol, an amine, a carboxylic acid, an amide, an alkyne, an azide, an optionally substituted aminophenol, a natural amino acid side chain, a non-natural amino acid side chain, an N-terminal protecting group, and a C-terminal protecting group, provided that Z′ and Z″ are complementary groups that combine to form Z;

b is an integer from 0 to 50;

and *** is a point of connection to the rest of the functionalized peptide;

wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

34. The method of clause 33, wherein Z comprises a moiety selected from the group consisting of an amide bond,

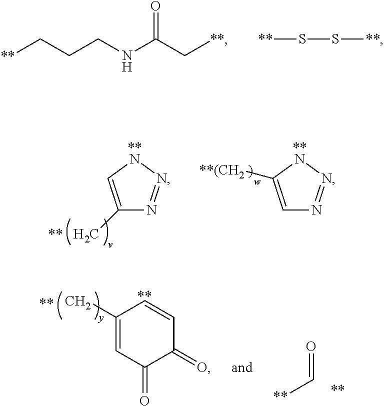

wherein v is an integer from 0 to 6, w is an integer from 0 to 6, and y is an integer from 0 to 6, and ** is a point of connection to the rest of the cyclic peptide.

35. The method of clause 33 or 34, wherein Z comprises a peptide bond, Z′ comprises a C-terminal protecting group or Z″ comprises an N-terminal protecting group, Q is a carbonyl, q is 0, r is 1 and u is 0.

36. The method of clause 35, further comprising removing Z′ or Z″ from the rest of the functionalized peptide to cause the peptide bond to form.

37. The method of clause 33 or 34, wherein X and Y are bonds to Z, Z comprises **—S—S—**, X′ is a bond to Z″, Y′ is a bond to Z′, Z′ and Z″ comprise cysteine side chains, q is 1, and u is 1.

38. The method of clause 37, further comprising subjecting the functionalized peptide to oxidative conditions to cause **—S—S—** to form.

39. The method of clause 33 or 34, wherein Y is a bond to Z, Z comprises

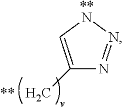

Y′ is a bond to Z′, Z′ comprises

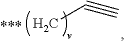

Z″ comprises an azide, u is 1, and v is 1.

40. The method of clause 39, further comprising contacting the functionalized peptide with a copper catalyst to cause

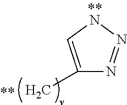

to form.

41. The method of clause 33 or 34, wherein Y is a bond to Z, Z comprises

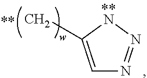

Y′ is a bond to Z′, Z′ comprise

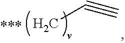

Z″ comprises an azide, u is 1, and v is 1.

42. The method of clause 41, further comprising contacting the functionalized peptide with a copper catalyst to cause

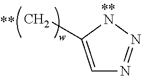

to form.

43. The method of clause 33 or 34, wherein Z comprises

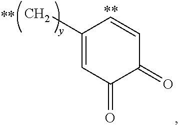

Y′ is a bond to Z′, Z′ comprises

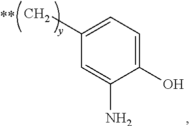

r is 0, u is 1, and y is 1.

44. The method of clause 43, further comprising contacting the functionalized peptide with a potassium ferricyanide to cause

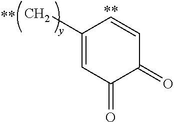

to form.

45. The method of clause 33 or 34, wherein R³ and R⁸ are defined such that the functionalized peptide comprises a butelase 1 recognition sequence, Y is a bond to Z, Z comprises

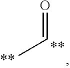

Y′ is a bond to Z′, Z′ is an asparagine or aspartic acid side chain, q is 0, and u is 1.

46. The method of clause 45, further comprising contacting the functionalized peptide with butelase 1 to cause

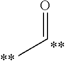

to form.

47. The method of clause 33 or 34, wherein X and Y are bonds to Z, Z comprises

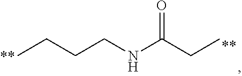

X′ is a bond to Z″, Y′ is a bond to Z′, Z′ is a glutamine side chain and Z″ is a lysine side chain or Z′ is a lysine side chain and Z″ is a glutamine side chain, q is 1, and u is 1.

48. The method of clause 47, further comprising contacting the functionalized peptide with a microbial transglutaminase to cause

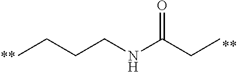

to form.

49. The method of any one of clauses 33 to 48, wherein L′ is 6-aminohexanoic acid.

50. The method of any one of clauses 33 to 49, wherein L″ is CH₂CH_{2.}

51. The method of any one of clauses 33 to 50, wherein m is 0.

52. The method of any one of clauses 33 to 51, wherein n is 0.

53. The method of any one of clauses 33 to 52, wherein t is 0, and p is an integer 1 to 100.

54. The method of any one of clauses 33 to 53, wherein p is an integer 1 to 20.

55. The method of clause 33 or 34, wherein Q is a carbonyl, Z is an amide bond, r is 1, u is 0, and q is O.

56. The method of any one of clauses 33 to 55, wherein the solid support is selected from a group of materials consisting of plastic, glass and carbon composite.

57. The method of any one of clauses 33 to 56, wherein the reactive surface comprises an activated amine.

58. The method of any one of clauses 33 to 57, wherein the amino acid sequences of interest of the population of peptides comprise the same number of amino acids.

59. The method of any one of clauses 33 to 58, wherein the amino acid sequences of interest of the population of peptides comprise five amino acids.

60. The method of any one of clauses 33 to 59, wherein the amino acid sequences of interest of the population of peptides do not contain any of a methionine amino acid, a cysteine amino acid, an amino acid repeat of the same amino acid, or an amino acid motif consisting of a histidine (H)— proline (P)— glutamine (Q) sequence.

61. The method of any one of clauses 33 to 60, wherein each cyclic peptide of the population of peptides further comprises at least one of an N-terminal wobble synthesis oligopeptide or a C-terminal wobble synthesis oligopeptide.

62. The method of clause 61, wherein the wobble synthesis oligopeptide of each cyclic peptide of the population of peptides comprises an amino acid sequence having the same number of amino acids.

63. The method of clause 61 or 62, wherein the wobble synthesis oligopeptide of each cyclic peptide of the population of peptides is derived randomly from an amino acid mixture having each of the twenty amino acids or a subset of the twenty amino acids in approximately equal concentrations.

64. The method of clause 61 or 62, wherein the wobble synthesis oligopeptide of each cyclic peptide of the population of peptides is derived randomly from an amino acid mixture having amino acids glycine (G) and serine (S) in approximately a 3 (G) to 1 (S) concentration.

65. The method of any one of clauses 61 to 64, wherein there is a C-terminal and an N-terminal wobble synthesis oligopeptide and both the C-terminal and N-terminal wobble synthesis oligopeptides comprise the same number of five or more amino acids.

66. A method of preparing a peptide microarray comprising: generating at least one first linear peptide subarray comprising a first plurality of linear peptides covalently attached to a microarray surface;

generating at least one second linear peptide subarray comprising a second plurality of linear peptides covalently attached to the microarray surface, wherein the second plurality of linear peptides has an amino acid sequence that is identical to the first plurality of linear peptides; and

treating the peptide microarray under conditions to cyclize the first plurality of linear peptides to provide at least one cyclized peptide subarray comprising a plurality of cyclized peptides, wherein the second plurality of linear peptides substantially does not cyclize.

67. The method of clause 66, wherein the first plurality of linear peptides is a first plurality of protected linear peptides, wherein the C-terminus of the first plurality of protected linear peptides is protected by a first protecting group; and

the second plurality of linear peptides is a second plurality of protected linear peptides, wherein the second plurality of protected linear peptides has an amino acid sequence that is identical to the first plurality of protected linear peptides, and wherein the C-terminus of the second plurality of protected linear peptides is protected by a second protecting group that is different from the first protecting group.

68. The method of clause 67, further comprising contacting the peptide microarray with a first deprotection reagent to selectively remove the first protecting group to provide at least one first deprotected linear peptide subarray comprising a first plurality of deprotected linear peptides; and

contacting the peptide microarray with a second deprotection reagent to remove the second protecting group to provide at least one second deprotected linear peptide subarray comprising a second plurality of deprotected linear peptides.

69. The method of any one of clauses 66-68, wherein the first plurality of linear peptides and the second plurality of linear peptides are each covalently attached to the microarray surface through an amino acid side chain.

70. The method of clause 69, wherein the amino acid side chain is a carboxylic acid side chain.

71. The method of clause 70, wherein the carboxylic acid side chain is a glutamate or aspartate side chain.

72. The method of any one of clauses 69 to 71, wherein the amino acid side chain is part of the C-terminal amino acid.

73. The method of any one of clauses 66 to 72, wherein at least one molecule of the first plurality of linear peptides fails to cyclize.

74. The method of clause 73, wherein the at least one of the first plurality of linear peptides that fails to cyclize is not removed from the first deprotected linear peptide subarray.

75. The method of any one of clauses 67 to 74, wherein the first protecting group is OAll.

76. The method of any one of clauses 67 to 75, wherein the first deprotection reagent is a palladium catalyst.

77. The method of clause 76, wherein the palladium catalyst is tetrakis(triphenylphosphine)palladium(0).

78. The method of any one of clauses 67 to 77, wherein the second protecting group is OtBu.

79. The method of any one of clauses 67 to 78, wherein the second deprotection reagent is an acid.

80. The method of clause 79, wherein the acid is trifluoroacetic acid.

81. The method of any one of clauses 66 to 80, wherein treating the peptide microarray under conditions to cyclize the first plurality of linear peptides comprises activating the carboxyl group of the C-terminus of the first plurality of linear peptides to react with the amino group of the N-terminus of the first plurality of linear peptides to form an amide bond.

82. The method of any one of clauses 66 to 81, wherein treating the peptide microarray under conditions to cyclize the first plurality of linear peptides comprises contacting the first plurality of linear peptides with HOBt and HBTU.

83. A method of identifying an active cyclic peptide comprising generating a peptide microarray according to the method of any one of clauses 66 to 82, contacting the peptide microarray with a potential binding group, and measuring the presence of the potential binding group on the peptide microarray after the contacting step.

84. The method of clause 83, wherein the measuring step comprises measuring fluorescent activity.

85. A method of generating a peptide microarray comprising at least one cyclic peptide of formula III

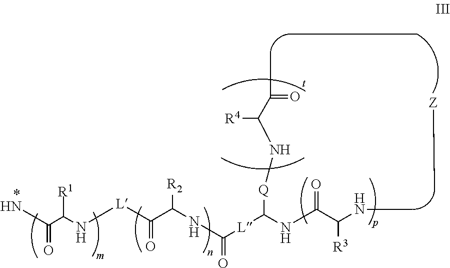

wherein each R¹, R², R³ and R⁴ is independently a natural amino acid side chain or a non-natural amino acid side chain;

Q is a carbonyl;

L′ and L″ are each independently an optional bivalent linking group or a bond;

m is an integer from 0 to 6;

n is an integer from 0 to 6;

p is an integer from 0 to 100;

t is an integer from 0 to 100; and

* is a point of connection connecting the at least one cyclic peptide to a solid support having a reactive surface;

the method comprising generating a plurality of first peptides on a cyclic peptide subarray, wherein the first peptide is of formula IV

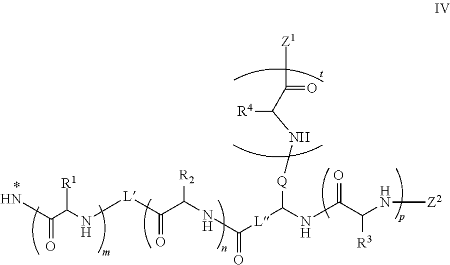

wherein R¹, R², R³, R⁴, Q, L′, L″, m, n, p, t, and * are as defined for formula III;

Z¹ is a first carboxyl protecting group; and

Z² is hydrogen;

generating a plurality of second peptides on a linear peptide subarray, wherein the second peptide is of formula V

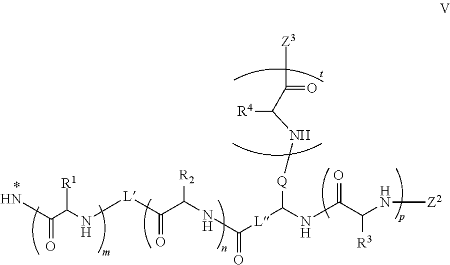

wherein R¹, R², R³, R⁴, Q, L′, L″, Z², m, n, p, t, and * are as defined for formula IV; and

Z³ is a second carboxyl protecting group different from the first carboxyl protecting group; and

is hydrogen; and

treating the first peptides to form a first plurality of linear deprotected peptides, wherein the linear deprotected peptide is of formula VI

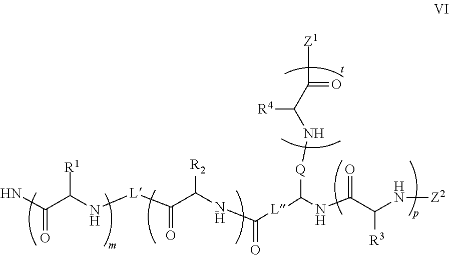

wherein R¹, R², R³, R⁴, Q, L′, L″, Z², m, n, p, t, and * are as defined for formula IV; and

Z¹ is —OH; followed by

treating the linear deprotected peptides to form the cyclic peptide; followed by

treating the second peptides to form a second plurality of linear deprotected peptides of formula VI;

wherein the first peptides and the second peptides are immobilized to the reactive surface, and wherein the at least one cyclic peptide is part of a population of peptides immobilized to the reactive surface wherein the population of peptides comprises independently selected amino acid sequences of interest.

86. The method of clause 85, wherein L′ is 6-aminohexanoic acid.

87. The method of clause 85 or 86, wherein L″ is CH₂CH₂.

88. The method of any one of clauses 85 to 87, wherein m is 0.

89. The method of any one of clauses 85 to 88, wherein n is 0.

90. The method of any one of clauses 85 to 89, wherein t is 0, and p is an integer 1 to 100.

91. The method of any one of clauses 85 to 90, wherein p is an integer 1 to 20.

92. The method of any one of clauses 85 to 91, wherein at least one molecule of the linear deprotected peptides on the cyclic peptide subarray fails to cyclize.

93. The method of any one of clauses 85 to 92, wherein the linear deprotected peptides on the cyclic peptide subarray are not removed from the cyclic peptide subarray.

94. The method of any one of clauses 85 to 93, wherein the first carboxyl protecting group is OAll.

95. The method of any one of clauses 85 to 94, wherein treating the first peptides to form the first plurality of linear deprotected peptides comprises contacting the first peptides with palladium.

96. The method of any one of clauses 85 to 95, wherein the second carboxyl protecting group is OtBu.

97. The method of any one of clauses 85 to 96, wherein treating the second peptides to form the second plurality of linear deprotected peptides comprises contacting the second peptides with an acid.

98. The method of clause 97, wherein the acid is trifluoroacetic acid.

99. The method of any one of clauses 85 to 98, wherein treating the first peptides to form the cyclic peptide comprises activating a carboxyl group of the first peptide to react with a free amino group of the first peptide to form Z.

100. The method of any one of clauses 85 to 99, wherein treating the first peptides to form the cyclic peptide comprises contacting the first peptides with HOBt and HBTU.

101. A method of identifying an active cyclic peptide comprising generating a peptide microarray according to the method of any one of clauses 85 to 100, contacting the peptide microarray with a potential binding group, and measuring the presence of the potential binding group on the peptide microarray after the contacting step.

102. The method of clause 101, wherein the measuring step comprises measuring fluorescent activity.

103. A method of identifying a peptide binder comprising the steps of: a. exposing a target of interest to a peptide microarray comprising a first population of peptide binders comprising a cyclic peptide of formula I

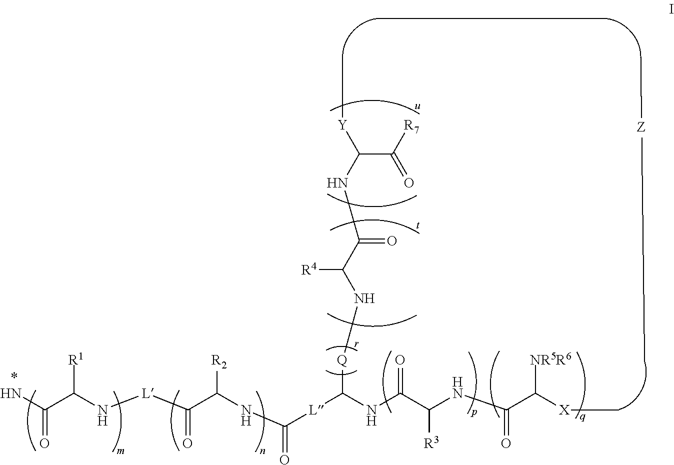

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a first solid support having a first reactive surface, whereby the target of interest binds to the cyclic peptide;

b. identifying overlap in peptide binder sequences of the first population of peptide binders which bind the target of interest, whereby a core binder sequence is determined;

c. performing at least one alteration selected from a single amino acid substitution, a double amino acid substitution, an amino acid deletion, and an amino acid insertion of amino acids to the core binder sequence, whereby a second population of core binder sequences is generated;

d. exposing the second population of core binder sequences to the target of interest, whereby the target of interest binds to at least one peptide sequence of the second population of core binder sequences and wherein the second population of core binder sequences comprises the cyclic peptide of formula I

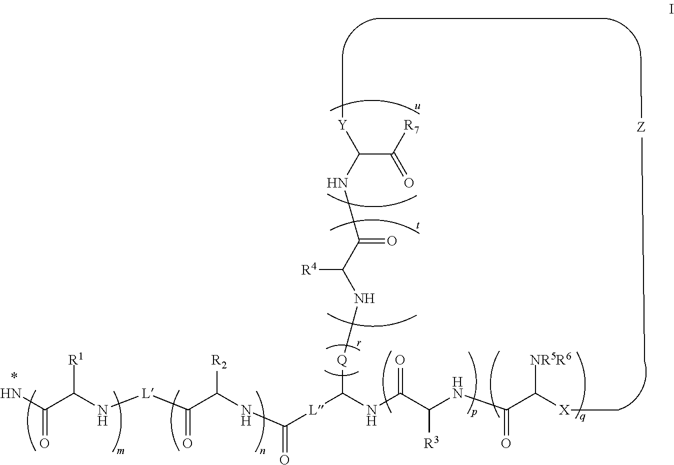

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a second solid support having a second reactive surface;

e. identifying one or more sequences of the second population of core binder sequences demonstrating strong binding properties to the target of interest, whereby a matured core binder sequence is determined;

f. performing at least one of N-terminal and C-terminal extension of the matured core peptide binder sequence determined in step e, whereby a population of matured, extended peptide binders is generated;

g. exposing the target of interest to a peptide microarray comprising the population of matured, extended peptide binders generated in step f wherein the population of mature, extended peptide binders comprises the cyclic peptide of formula I

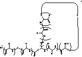

wherein each R¹, R², R³ and R⁴ is independently a natural amino acid side chain or a non-natural amino acid side chain;

each R⁵ and R⁶ is independently hydrogen or an N-terminal capping group;

each R⁷ is independently —OH or a C-terminal capping group;

Q is selected from the group consisting of a carbonyl, a natural amino acid side chain, and a non-natural amino acid side chain;

each X and Y is independently selected from the group consisting of a bond, a natural amino acid side chain covalently attached to Z, and a non-natural amino acid side chain covalently attached to Z;

Z is a group comprising a moiety selected from the group consisting of an amide bond, a disulfide bond, an isopeptide bond, a 1,2,3-triazole, and an optionally substituted 1,2-quinone;

L′ and L″ are each independently an optional bivalent linking group or a bond;

m is an integer from 0 to 6;

n is an integer from 0 to 6;

p is an integer from 0 to 100;

q is 0 or 1;

r is 0 or 1;

t is an integer from 0 to 100;

u is 0 or 1; and

* is a covalent bond immobilizing the cyclic peptide on a third solid support having a third reactive surface; and

h. identifying overlap in the N-terminal or C-terminal peptide binder sequences of the peptides comprising the population of mature, extended peptide binders, whereby a mature, extended core peptide binder sequence is determined.

104. The method of clause 103, wherein Z comprises a moiety selected from the group consisting of an amide bond,

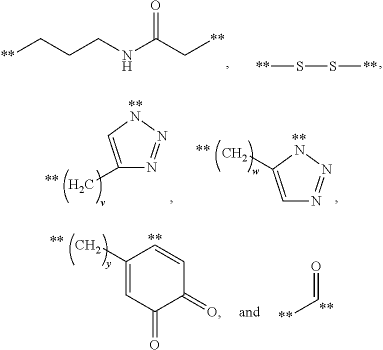

wherein v is an integer from 0 to 6, w is an integer from 0 to 6, and y is an integer from 0 to 6, and ** is a point of connection to the rest of the cyclic peptide.

105. The method of clause 103 or 104, wherein Z comprises a peptide bond, Q is a carbonyl, q is 0, r is 1 and u is 0.

106. The method of clause 103 or 104, wherein X and Y are bonds to Z, Z comprises **—S—S—**, q is 1, and u is 1.

107. The method of clause 103 or 104, wherein Z comprises

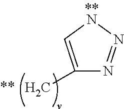

and v is 1.

108. The method of clause 103 or 104, wherein Z comprises

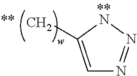

and w is 1.

109. The method of clause 103 or 104, wherein Y is a bond to Z, Z comprises

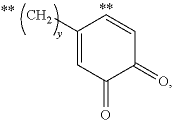

u is 1, and y is 1.

110. The method of clause 103 or 104, wherein Y is a bond to Z, Z comprises

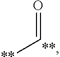

q is 0, and u is 1.

111. The method of clause 103 or 104, wherein X and Y are bonds to Z, Z comprises

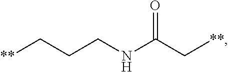

q is 1, and u is 1.

112. The method of any one of clauses 103 to 111, wherein L′ is 6-aminohexanoic acid.

113. The method of any one of clauses 103 to 112, wherein L″ is CH₂CH₂.

114. The method of any one of clauses 103 to 113, wherein m is 0.

115. The method of any one of clauses 103 to 114, wherein n is 0.

116. The method of any one of clauses 103 to 115, wherein t is 0, and p is an integer 1 to 100.

117. The method of any one of clauses 103 to 116, wherein p is an integer 1 to 20.

118. The method of any one of clauses 103 to 117, wherein at least one of a label-free and affinity analysis of the mature, extended core peptide binder sequence is performed.

119. The method of any one of clauses 103 to 118, wherein the first, second, and/or third solid support comprises at least one of glass, plastic, and carbon composite.

120. The method any one of clauses 103 to 119, wherein the peptide binders of the first population comprise the same number of amino acids.

121. The method of any one of clauses 103 to 120, wherein the peptide binders of the first population do not include the amino acid cysteine or methionine, or histidine-proline-glutamine motifs, or amino acid repeats of 2 or more amino acids.

122. The method of any one of clauses 103 to 121, wherein the cyclic peptide binders of the population of mature, extended peptide binders include at least one of an N-terminal wobble synthesis oligopeptide and a C-terminal wobble synthesis oligopeptide.

123. The method of any one of clauses 103 to 122, wherein the core binder sequence comprises a greater number of amino acids than the number of amino acids for each of the peptides comprising the first population of peptide binders.

124. The method of any one of clauses 103 to 123, wherein steps e. and h. comprise principled clustering analysis.

125. The method of any one of clauses 103 to 124, wherein steps c. to h. are repeated for the mature, extended core peptide binder sequence.

126. The method of any one of clauses 103 to 125 wherein the peptide microarray comprises one or more linear peptides and wherein the method further comprises the step of contacting the one or more linear peptides on the peptide microarray with a protease capable of digesting the one or more linear peptides.

127. The method of clause 126 wherein the protease is an amino protease or a mixture of amino proteases.

128. The method of clause 127 wherein the protease is dipeptidyl peptidase IV, aminopeptidase m, or a combination thereof.

129. The method of clause 45 or 46 wherein the butelase 1 recognition sequence is NHV.

130. The method of clause 47 or 48 wherein the glutamine side chain is part of the sequence [WY][DE][DE][YW]ALQ[GST]YD (SEQ ID NO: 194) and the lysine side chain is part of the sequence RSKLG (SEQ ID NO: 195).

In the various embodiments described herein, the target of interest may be any molecule, including, but not limited to, a biomacromolecule such as a protein, a peptide, a nucleic acid (e.g., DNA or RNA), a polycarbohydrate, or a small molecule such as an organic compound or an organometallic complex, or any other molecule that contributes to a disease, such as the diseases listed below (e.g., a receptor for a therapeutic peptide, an enzyme inhibited or activated by a therapeutic peptide, or any other molecule wherein the activity of the molecule is altered by a therapeutic peptide). In one embodiment, the target of interest can be a molecule involved in a disease state and the cyclic peptide can be a therapeutic peptide.

In the embodiment where the cyclic peptide is a therapeutic peptide, the disease that is treated can be selected from the group consisting of cancer, an infectious disease, heart disease (e.g., atherosclerosis) and other cholesterol-related diseases, stroke, wounds, pain, an inflammatory disease, such as arthritis (e.g., rheumatoid arthritis), inflammatory bowel disease, psoriasis, diabetes mellitis, or an autoimmune disease, a respiratory disease, such as asthma or chronic obstructive pulmonary disease, diarrheal diseases, a genetic disease, a neurological disorder, such as Alzheimer's disease, muscular dystrophy, or Parkinson's disease, a mental disorder, or any other type of disease capable of being treated with a therapeutic peptide (e.g., a cyclic peptide).

In other embodiments, the disease can be a cancer selected from the group consisting of a carcinoma, a sarcoma, a lymphoma, a melanoma, a mesothelioma, a nasopharyngeal carcinoma, a leukemia, an adenocarcinoma, and a myeloma. In yet other embodiments, the disease can be a cancer selected from the group consisting of lung cancer, bone cancer, pancreatic cancer, skin cancer, cancer of the head or neck, melanoma, uterine cancer, ovarian cancer, endometrial cancer, rectal cancer, stomach cancer, colon cancer, breast cancer, cancer of the cervix, Hodgkin's Disease, cancer of the esophagus, non-small cell lung cancer, prostate cancer, leukemia, lymphoma, mesothelioma, cancer of the bladder, Burkitt's lymphoma, kidney cancer, and brain cancer, or any other type of cancer that can be treated with a therapeutic peptide (e.g., a cyclic peptide).

In some instances, generating cyclic peptide libraries on a microarray can be challenging when the precursor linear peptides have inefficient cyclization reactions that fail to go to completion, leading to mixtures of linear and cyclic peptides. Inefficient cyclization may be difficult to account for because the cyclization reaction can be sequence specific. In situations where cyclization does not complete, the resulting mixture comprises linear and cyclic peptides, where the ratio of cyclic to linear peptides is not constant or simple to predict based on methods known in the art. Addressing these challenges by purification of the cyclic peptides away from their linear counterparts is very difficult.

In one embodiment, a step can be performed to increase the proportion of cyclized peptides on a microarray relative to linear peptides on the peptide microarray. In this aspect, the peptide microarray comprises one or more linear peptides, along with cyclic peptides due to the inefficiency of cyclization. Thus, in this aspect, the cyclization method can further comprise the step of contacting the one or more linear peptides on the peptide microarray with a protease capable of digesting the one or more linear peptides. In this embodiment, the steps of the maturation/extension/cyclization method described herein can then be repeated to increase the yield of cyclic peptides on the peptide microarray.

In some embodiments, instead of increasing the yield of cyclization or purifying cyclic peptides from their linear precursors, the cyclic peptides are formed alongside a linear standard. As described in greater detail below, by generating linear peptides identical to the peptides that fail to cyclize, interactions of the linear peptides with a target protein are possible to measure. Therefore, differences between linear and cyclic peptides of the same sequence can be measured to identify peptides with high cyclic activity.

In one illustrative embodiment, the protease can be an aminoprotease, such as aminopeptidase m, cystinyl aminopeptidase, glutamyl aminopeptidase, leucyl aminopeptidase, or pyroglutamyl peptidase, or a mixture of aminoproteases. In another illustrative aspect, the protease can be a dipeptidase, such as dipeptidyl peptidase IV, a carboxypeptidase, a tripeptidylpeptidase, a metalloexopeptidase, or a combination thereof.

In one embodiment of the maturation/extension/cyclization method described herein, an isopeptide bond can be formed to cyclize peptides on the peptide microarray. In one aspect, the amino acids that can be linked can be a glutamine residue and a lysine residue in the same peptide, and the linkage can be formed using a transglutaminase.

In this embodiment, the glutamine-containing portion of the peptide can comprise a sequence motif of GDYALQGPG (SEQ ID NO: 1). In the embodiment where the sequence motif is GDYALQGPG (SEQ ID NO: 1), the glutamine-containing portion of the peptide can comprise a sequence selected from the group consisting of CGGDYALQGPG (SEQ ID NO:2), WGGDYALQGPG (SEQ ID NO:3), YGGDYALQGPG (SEQ ID NO:4), DGGDYALQGPG (SEQ ID NO:5), GDGDYALQGPG (SEQ ID NO:6), NGGDYALQGPG (SEQ ID NO:7), GCGDYALQGPG (SEQ ID NO:8), EGGDYALQGPG (SEQ ID NO:9), PGGDYALQGPG (SEQ ID NO:10), TGGDYALQGPG (SEQ ID NO:11), QGGDYALQGPG (SEQ ID NO:12), IGGDYALQGPG (SEQ ID NO:13), FGGDYALQGPG (SEQ ID NO:14), HGGDYALQGPG (SEQ ID NO:15), LGGDYALQGPG (SEQ ID NO:16), VGGDYALQGPG (SEQ ID NO:17), RGGDYALQGPG (SEQ ID NO:18), GWGDYALQGPG (SEQ ID NO:19), MGGDYALQGPG (SEQ ID NO:20), SGGDYALQGPG (SEQ ID NO:21), AGGDYALQGPG (SEQ ID NO:22), GYGDYALQGPG (SEQ ID NO:23), GEGDYALQGPG (SEQ ID NO:24), GPGDYALQGPG (SEQ ID NO:25), GHGDYALQGPG (SEQ ID NO:26), and GNGDYALQGPG (SEQ ID NO: 27), or a combination thereof. In another embodiment, the glutamine-containing portion of the peptide can comprise the sequence DYALQ (SEQ ID NO: 28).

In another embodiment, the glutamine-containing portion of the peptide can comprise a sequence selected from the group consisting of GGGDYALQGGG (SEQ ID NO:29), WDGDYALQGGG (SEQ ID NO:30), GGGGDYALQGGGG (SEQ ID NO: 31), and GGGDYALQGGGG (SEQ ID NO: 32), or a combination thereof. In another embodiment, the glutamine-containing portion of the peptide can comprise the sequence GGGDYALQGGG (SEQ ID NO: 29).

In yet another embodiment, the glutamine-containing portion of the peptide can comprise a sequence motif of [YF][VA]LQG (SEQ ID NO: 33). In this embodiment, the glutamine-containing portion of the peptide can comprise a sequence selected from the group consisting of DYALQ (SEQ ID NO:34), DYVLQ (SEQ ID NO:35), NYALQ (SEQ ID NO:36), EYALQ (SEQ ID NO:37), PYALQ (SEQ ID NO:38), EYVLQ (SEQ ID NO:39), DFALQ (SEQ ID NO:40), FYALQ (SEQ ID NO:41), NYVLQ (SEQ ID NO:42), RYALQ (SEQ ID NO:43), YFALQ (SEQ ID NO:44), PYVLQ (SEQ ID NO:45), WYALQ (SEQ ID NO:46), SYALQ (SEQ ID NO:47), HYALQ (SEQ ID NO:48), EFALQ (SEQ ID NO:49), and NFVLQ (SEQ ID NO:50), or a combination thereof.

In still another illustrative aspect, the glutamine-containing portion of the peptide can comprise a sequence selected from the group consisting of DYFLQ (SEQ ID NO:51), EYVAQ (SEQ ID NO:52), DYVAQ (SEQ ID NO:53), DFYLQ (SEQ ID NO:54), EYFLQ (SEQ ID NO:55), or a combination thereof.

In yet another embodiment, the peptide can contain a lysine and the lysine-containing portion of the peptide can comprise a sequence motif of SK[LS]K (SEQ ID NO: 56) or [KR][ST]KL (SEQ ID NO: 57). In this embodiment, the lysine-containing portion of the peptide can comprise a sequence selected from the group consisting of ARSKL (SEQ ID NO:58), KSKLA (SEQ ID NO:59), TKSKL (SEQ ID NO:60), KLSKL (SEQ ID NO:61), RSKLG (SEQ ID NO:62), RGSKL (SEQ ID NO:63), RSKSK (SEQ ID NO:64), SKSKL (SEQ ID NO:65), PKTKL (SEQ ID NO:66), RSKLA (SEQ ID NO:67), GRSKL (SEQ ID NO:68), SKLSK (SEQ ID NO:69), FTKSK (SEQ ID NO:70), RLKSK (SEQ ID NO:71), KLGAK (SEQ ID NO:72), QRSKL (SEQ ID NO:73), LSKLK (SEQ ID NO:74), NRTKL (SEQ ID NO:75), QRTKL (SEQ ID NO:76), GGGRSKLAGGG (SEQ ID NO: 77), and GGGARSKLGGGG (SEQ ID NO: 78), or a combination thereof.

In another illustrative embodiment, the peptide can contain a lysine and the lysine-containing portion of the peptide can comprise a sequence selected from the group consisting of RGTKL (SEQ ID NO:196), FPKLK (SEQ ID NO:197), KLKYK (SEQ ID NO:198), RAKYK (SEQ ID NO:199), KTKYK (SEQ ID NO:200), and GYKLK (SEQ ID NO:201), or a combination thereof.

In still another embodiment, the peptide can comprise a transglutaminase glutamine substrate peptide and a transglutaminase lysine substrate peptide. In yet another embodiment, the transglutaminase glutamine and/or lysine substrate peptide can comprise a sequence of DYALQ (SEQ ID NO: 34) or can have a sequence motif comprising [FY][FYT]LQ (SEQ ID NO: 79), [YF]VAQ (SEQ ID NO: 80), K[YLS]K (SEQ ID NO: 81), or TKL (SEQ ID NO: 82).

In another embodiment, transglutaminase substrate peptides are contemplated having about 60%, about 70%, about 75%, about 80%, about 85%, about 90%, about 95%, about 96%, about 97%, about 98%, or about 99% homology with any of SEQ ID NOS: 4 to 82. Determination of percent identity or similarity between sequences can be done, for example, by using the GAP program (Genetics Computer Group, software; available via Accelrys on http://www.accelrys.com), and alignments can be done using, for example, the ClustalW algorithm (VNTI software, InforMax Inc.). A sequence database can be searched using the peptide sequence to be compared. Algorithms for database searching are typically based on the BLAST software (Altschul et al., 1990).

In one illustrative embodiment, linking a transglutaminase glutamine substrate peptide and a transglutaminase lysine substrate peptide to form an isopeptide bond that results in cyclization of the peptide can be performed using a transglutaminase. In another embodiment, a microbial transglutaminase (e.g., a Streptoverticillium sp. transglutaminase) or a mammalian transglutaminase can be used. In the embodiment where the enzyme is a mammalian transglutaminase, the mammalian transglutaminase can be, for example, selected from the group consisting of Human Factor XIII A transglutaminase, Human Factor XIII B transglutaminase, a Factor XIII transglutaminase, a keratinocyte transglutaminase, a tissue-type transglutaminase, an epidermal transglutaminase, a prostate transglutaminase, a neuronal transglutaminase, a human transglutaminase 5, and a human transglutaminase 7.

### I. Peptides:

The peptides disclosed and described herein make up a class of molecules having a vast number of applications in the life science and healthcare fields. As disclosed and described herein, the peptides (or “peptide binders” (e.g., cyclic peptides)) described herein may be in a cyclic or constrained (macrocycle) form, or in linear form prior to cyclization.

As used herein, the terms “peptide,” “oligopeptide” or “peptide binder” refer to organic compounds composed of amino acids, which may be arranged in either a linear chain (joined together by peptide bonds between the carboxyl and amino groups of adjacent amino acid residues) prior to cyclization, or in a cyclic form or in a constrained (e.g., “macrocycle” form). A macrocycle (or constrained peptide), as used herein, is used in its customary meaning for describing a cyclic small molecule such as a peptide of about 500 Daltons to about 2,000 Daltons.

The term “natural amino acid” refers to one of the 20 amino acids typically found in proteins and used for protein biosynthesis as well as other amino acids which can be incorporated into proteins during translation (including pyrrolysine and selenocysteine). The 20 natural amino acids include histidine, alanine, valine, glycine, leucine, isoleucine, aspartic acid, glutamic acid, serine, glutamine, asparagine, threonine, arginine, proline, phenylalanine, tyrosine, tryptophan, cysteine, methionine and lysine.

The term “non-natural amino acid” refers to an organic compound that is not among those encoded by the standard genetic code, or incorporated into proteins during translation. Therefore, non-natural amino acids include amino acids or analogs of amino acids, but are not limited to, the D-isostereomers of amino acids, the beta-amino-analogs of amino acids, citrulline, homocitrulline, homoarginine, hydroxyproline, homoproline, ornithine, 4-amino-phenylalanine, cyclohexylalanine, a-aminoisobutyric acid, N-methyl-alanine, N-methyl-glycine, norleucine, N-methyl-glutamic acid, tert-butylglycine, a-aminobutyric acid, tert-butylalanine, 2-aminoisobutyric acid, a-aminoisobutyric acid, 2-aminoindane-2-carboxylic acid, selenomethionine, dehydroalanine, lanthionine, y-amino butyric acid, and derivatives thereof wherein the amine nitrogen has been mono- or di-alkylated.

According to embodiments of the instant disclosure, novel cyclic peptides are described which are immobilized on a solid support (e.g., a microarray). As described in greater detail below, the peptide binders (e.g., cyclic peptides) may enable discovery techniques such as profiling of antibodies, epitope identification, sample profiling, antibody isolation, protein identification as well as diagnostic and therapeutic applications. In some embodiments, the peptide binders can be extended and matured (for example, with natural or non-natural amino acids) prior to cyclization for preparing a potential drug candidate.

In one aspect of the present disclosure, linear and cyclic peptides in adjacent features on the same array are generated without requiring purification. First, peptides are generated on a subarray for forming cyclic peptides. As used herein, the term “subarray” refers to a part or section of a microarray. A microarray may have one or more subarrays. In some embodiments, different molecules on the microarray may be located at different subarrays to facilitate comparison of the molecules. Each of the peptides has a free amino group and a protected carboxyl group. As used herein, a “carboxyl group” may be protonated (a carboxylic acid) or deprotonated (a carboxylate). Identical peptides are also generated on a subarray for forming linear peptides, except the carboxyl groups of the peptides on the subarray for forming linear peptides have different protecting groups than the carboxyl groups of the peptides on the cyclic peptide subarray. In some embodiments, the carboxyl group is the C-terminus carboxyl group of the subject peptide, and the amino group is the N-terminus amino group of the subject peptide. During synthesis, the C-terminus and amino acid side chains may be protected.

As used herein, the term “protecting group” refers to any group, commonly known in the art, that alters the reactivity of a functional group, typically to ameliorate or mask the reactivity of the functional group. Protecting groups useful in connection with the present disclosure include, but are not limited to, carboxyl protecting groups, such as those described in Greene's Protective Groups in Organic Synthesis, Fourth Edition, Copyright © 2007 John Wiley & Sons, Inc., incorporated by reference herein. Exemplary carboxyl protecting groups useful in connection with the present disclosure include, but are not limited to, esters, such as alkyl, allyl, benzyl, phenyl, aryl, and silyl esters; oxazoles; ortho esters; and organometallic complexes, such as cobalt and tin complexes. A non-limiting list of carboxyl protecting groups includes heptyl, 2-N-(morpholino)ethyl, choline, (methoxyethoxy)ethyl, methoxyethyl, methyl, 9-fluorenylmethyl, methoxymethyl, methoxyethoxymethyl, methylthiomethyl, tetrahydropyranyl, tetrahydrofuranyl, 2-(trimethylsilyl)ethoxymethyl, benzyloxymethyl, triisopropylsiloxymethyl, pivaloyloxymethyl, phenylacetoxymethyl, triisopropylsilylmethyl, cyanomethyl, acetol, phenacyl, desyl, carboxamidomethyl, p-azobenzenecarboxamidomethyl, 6-bromo-7-hydroxycoumarin-4-ylmethyl, N-phthalimidomethyl, 2,2,2-trichloroethyl, 2-haloethyl, w-chloroalkyl, 2-(trimethylsilyl) ethyl, (2-methyl-2-trimethylsilyl)ethyl, (2-phenyl-2-trimethylsilyl)ethyl, 2-methylthioethyl, 1,3-dithianyl-2-methyl, 2-(p-nitrophenylsulfenyl)ethyl, 2-(p-toluenesulfonyl)ethyl, 2-(2′-pyridyl)ethyl, 2-(diphenylphosphino)ethyl, (p-methoxyphenyl)ethyl, 1-methyl-1-phenylethyl, 2-(4-acetyl-2-nitrophenyl)ethyl, 1-[2-(2-hydroxyalkyl)phenyl] ethanone, 2-cyanoethyl, t-butyl, 3-methyl-3-pentyl, dicyclopropylmethyl, 2,4-dimethyl-3-pentyl, cyclopentyl, cyclohexyl, allyl, methallyl, 2-methylbut-3-en-2-yl, 3-methylbut-2-enyl, 3-buten-1-yl, 4-(trimethylsilyl)-2-buten-1-yl, cinnamyl, α-methylcinnamyl, prop-2-ynyl (propargyl), phenyl, 2,6-dimethylphenyl, 2,6-diisopropylphenyl, 2,6-di-t-butyl-4-methylphenyl, 2,6-di-t-butyl-4-methoxyphenyl, p-(methylthio)phenyl, pentafluorophenyl, 2-(dimethylamino)-5-nitrophenyl, benzyl, triphenylmethyl, 2-chlorophenyldiphenylmethyl, 2,3,4,4′,4″,5,6-heptafluorotriphenylmethyl, diphenylmethyl, bis(o-nitrophenyl) methyl, 9-anthrylmethyl, 2-(9,10-dioxo) anthrylmethyl, 5-dibenzosuberyl, 1-pyrenylmethyl, 2-(trifluoromethyl)-6-chromonylmethyl, 2,4,6-trimethylbenzyl, p-bromobenzyl, o-nitrobenzyl, p-nitrobenzyl, p-Methoxybenzyl, 2,6-dimethoxybenzyl, 4-(methylsulfinyl) benzyl, 4-sulfobenzyl, 4-azidomethoxybenzyl, 4-{N-[1-(4,4-dimethyl-2,6-dioxocyclohexylidene)-3-methylbutyl] amino} benzyl, piperonyl, 4-picolyl, p-polymer-benzyl, 2-naphthylmethyl, 3-nitro-2-naphthylmethyl, 4-quinolylmethyl, 8-bromo-7-hydroxyquinoline-2-ylmethyl, 2-nitro-4,5-dimethoxybenzyl, 1,2,3,4-tetrahydro-1-naphthyl, trimethylsilyl, triethylsilyl, t-butyldimethylsilyl, t-butyldiphenylsilyl, t-propyldimethyl silyl, phenyldimethylsilyl, di-t-butylmethylsilyl, triisopropylsilyl, and tris(2,6-diphenylbenzyl)silyl.

Exemplary amino protecting groups include those described in Greene's Protective Groups in Organic Synthesis, Fourth Edition, Copyright © 2007 John Wiley & Sons, Inc., incorporated by reference herein. Exemplary amino protecting groups useful in connection with the present disclosure include, but are not limited to, carbamates, urea-type derivatives, amides, N-sulfenyl derivatives, and N-sulfonyl derivatives. A non-limiting list of amino protecting groups includes 9-fluorenylmethyl, 2,6-di-t-butyl-9-fluorenylmethyl, 2,7-bis (trimethylsilyl)fluorenylmethyl, 9-(2-sulfo)fluorenylmethyl, 9-(2,7-dibromo)fluorenylmethyl, 17-tetrabenzo[a,c,g,i]fluorenylmethyl, 2-chloro-3-indenylmethyl, benz[f]inden-3-ylmethyl, 1,1-dioxobenzo[b]thiophene-2-ylmethyl, 2-methylsulfonyl-3-phenyl-1-prop-2-enyloxy, 2,7-di-t-butyl-[9-(10,10-dioxo-10,10,10,10-tetrahydrothioxanthyl)] methyl, 2,2,2-trichloroethyl, 2-trimethylsilylethyl, (2-phenyl-2-trimethylsilyl)ethyl, 2-phenylethyl, 2-chloroethyl, 1,1-dimethyl-2-haloethyl, 1,1-dimethyl-2,2-dibromoethyl, 1,1-dimethyl-2,2,2-trichloroethyl, 2-(2′- and 4′-pyridyl)ethyl, 2,2-bis(4′-nitrophenyl)ethyl, 2-[(2-nitrophenyl)dithio]-1-phenylethyl, 2-(N,N-dicyclohexylcarboxamido) ethyl, t-butyl, 1-adamantyl, 2-adamantyl, 1-(1-adamantyl)-1-methylethyl, 1-methyl-1-(4-biphenylyl)ethyl, 1-(3,5-di-t-butylphenyl)-1-methylethyl, triisopropylsiloxyl, vinyl, allyl, prenyl, 1-isopropylallyl, cinnamyl, 4-nitrocinnamyl, 3-(3′-pyridyl)prop-2-enyl, hexadienyloxy, propargyloxy, but-2-ynylbisoxy, 8-quinolyl, N-hydroxypiperidinyl, alkyldithio, benzyl, 3,5-di-t-butylbenzyl, p-methoxybenzyl, p-methoxybenzyl, p-methoxybenzyl, p-chlorobenzyl, 2,4-dichlorobenzyl, 4-methylsulfinylbenzyl, 4-trifluoromethylbenzyl, fluorous benzyl, 2-naphthylmethyl, 9-anthrylmethyl, diphenylmethyl, 4-phenylacetoxybenzyl, 4-azidobenzyl, 4-azidomethoxybenzyl, m-chloro-p-acyloxybenzyl, p-(dihydroxyboryl) benzyl, 5-benzisoxazolylmethyl, 2-(trifluoromethyl)-6-chromonylmethyl, 2-methylthioethyl, 2-methylsulfonylethyl, 2-(p-toluenesulfonyl) ethyl, 2-(4-nitrophenylsulfonyl) ethyl, 2-(2,4-dinitrophenylsulfonyl)ethoxy, 2-(4-trifluoromethylphenyl sulfonyl) ethyl, [2-(1,3-dithianyl)]methyl, 2-phosphonioethyl, 2-[phenyl(methyl)sulfonio]ethyl, 1-methyl-1-(triphenylphosphonio) ethyl, 1,1-dimethyl-2-cyanoethyl, 2-dansylethyl, 2-(4-nitrophenyl)ethyl, 4-methylthiophenyl, 2,4-dimethylthiophenyl, m-nitrophenyl, 3,5-dimethoxybenzyl, 1-methyl-1-(3,5-dimethoxyphenyl)ethyl, α-methylnitropiperonyl, o-nitrobenzyl, 3,4-dimethoxy-6-nitrobenzyl, 3,4-disubstituted-6-nitrobenzyl, phenyl(o-nitrophenyl)methyl, 2-nitrophenylethyl, 6-nitroveratryl, 4-methoxyphenacyl, 3′,5′-dimethoxybenzoin, 9-xanthenylmethyl, N-methyl-N-(o-nitrophenyl), N-(2-acetoxyethyl) amine, t-amyl, 1-methylcyclobutyl, 1-methylcyclohexyl, 1-methyl- 1-cyclopropylmethyl, cyclobutyl, cyclopentyl, cyclohexyl, isobutyl, isobornyl, cyclopropylmethyl, p-decyloxybenzyl, diisopropylmethyl, 2,2-dimethoxycarbonylvinyl, o-(N,N-dimethylcarboxamido)benzyl, 1,1-dimethyl-3-(N,N-dimethylcarboxamido)propyl, butynyl, 1,1-dimethylpropynyl, 2-iodoethyl, 1-methyl-1-(4′-pyridyl)ethyl, 1-methyl-1-(p-phenylazophenyl)ethyl, p-(p′-methoxyphenylazo) benzyl, p-(phenylazo) benzyl, 2,4,6-trimethylbenzyl, isonicotinyl, 4-(trimethylammonium)benzyl, p-cyanobenzyl, di(2-pyridyl)methyl, 2-furanylmethyl, phenyl, 2,4,6-tri-t-butylphenyl, 1-methyl-1-phenylethyl, S-benzyl thiocarbamate, urea, phenothiazinyl-(10)-carbonyl derivative, N′-p-toluenesulfonylaminocarbonyl, N′-phenylaminothiocarbonyl, 4-hydroxyphenylaminocarbonyl, 3-hydroxytryptaminocarbonyl, N′-phenylaminothiocarbonyl, formamide, acetamide, chloroacetamide, trichloroacetamide, triftuoroacetamide, phenylacetamide, 3-phenylpropanamide, pent-4-enamide, picolinamide, 3-pyridylcarboxamide, N-benzoylphenylalanyl derivative, benzamide, p-phenylbenzamide, o-nitrophenylacetamide, 2,2-dimethyl-2-(o-nitrophenyl)acetamide, o-nitrophenoxyacetamide, 3-(o-nitrophenyl)propanamide, 2-methyl-2-(o-nitrophenoxy)propanamide, 3-methyl-3-nitrobutanamide, o-nitrocinnamide, o-nitrobenzamide, 3-(4-t-butyl-2,6-dinitrophenyl)-2,2-dimethylpropanamide, o-(benzoyloxymethyl) benzamide, 2-(acetoxymethyl) benzamide, 2-[(t-butyldiphenylsiloxy)methyl]benzoyl, 3-(3′,6′-dioxo-2′,4′,5-trimethylcyclohexa-1′,4′-diene)-3,3-dimethylpropionamide, o-hydroxy-trans-cinnamide, 2-methyl-2-(o-phenylazophenoxy)propanamide, 4-chlorobutanamide, acetoacetamide, 3-(p-hydroxyphenyl)propanamide, (N′-dithiobenzyloxycarbonylamino) acetamide, N-acetylmethionine derivative, 4,5-diphenyl-3-oxazolin-2-one, N-phthalimide, N-dichlorophthalimide, N-tetrachlorophthalimide, N-4-nitrophthalimide, N-thiodiglycoloyl, N-dithiasuccinimide, N-2,3-diphenylmaleimide, N-2,3-dimethylmaleimide, N-2,5-dimethylpyrrole, N-2,5-bis(triisopropylsiloxy)pyrrole, N-1,1,4,4-tetramethyldisilylazacyclopentane adduct, N-1,1,3,3-tetramethyl-1,3-disilaisoindoline, N-diphenylsilyldiethylene group, N-5-substituted 1,3-dimethyl-1,3,5-triazacyclohexan-2-one, N-5-substituted 1,3-dibenzyl-1,3,5-triazacyclohexan-2-one, 1-substituted 3,5-dinitro-4-pyridone, 1,3,5-dioxazine, benzenesulfenamide, 2-nitrobenzenesulfenamide, 2,4-dinitrobenzenesulfenamide, pentachlorobenzenesulfenamide, 2-nitro-4-methoxybenzenesulfenamide, triphenylmethylsulfenamide, 1-(2,2,2-trifluoro-1,1-diphenyl)ethylsulfenamide, N-3-nitro-2-pyridinesulfenamide, methanesulfonamide, trifluoromethanesulfonamide, t-butylsulfonamide, benzylsulfonamide, 2-(trimethylsilyl) ethanesulfonamide, p-toluenesulfonamide, benzenesulfonamide, anisylsulfonamide, 2- or 4-nitrobenzenesulfonamide, 2,4-dinitrobenzenesulfonamide, 2-naphthlenesulfonamide, 4-(4′,8′-dimethoxynaphthylmethyl) benzenesulfonamide, 2-(4-methylphenyl)-6-methoxy-4-methylsulfonamide, 9-anthracenesulfonamide, pyridine-2-sulfonamide, benzothiazole-2-sulfonamide, phenacylsulfonamide, 2,3,6-trimethyl-4-methoxybenzenesulfonamide, 2,4,6-trimethoxybenzenesulfonamide, 2,6-dimethyl-4-methoxybenzenesulfonamide, pentamethylbenzenesulfonamide, 2,3,5,6-tetramethyl-4-methoxybenzenesulfonamide, 4-methoxybenzenesulfonamide, 2,4,6-trimethylbenzenesulfonamide, 2,6-dimethoxy-4-methylbenzenesulfonamide, 3-methoxy-4-t-butylbenzenesulfonamide, 2,2,5,7,8-pentamethylchroman-6-sulfonamide.

After generating the microarray, the protected carboxyl groups of the peptides on the subarray for forming cyclic peptides are deprotected. As a result of deprotection, each of peptides on the subarray for forming cyclic peptides now has a free carboxyl group. Although the peptides on the subarray for forming cyclic peptides are deprotected in this step, the carboxyl groups of the peptides on the subarray for forming linear peptides are not removed. As such, peptides on the linear peptide subarray remain protected during this step.

Protecting groups can be removed according to a variety of methods known in the art (a.k.a deprotection). Exemplary methods for deprotection of (or removal of) carboxyl protecting groups include, but are not limited to, those methods described in Greene's Protective Groups in Organic Synthesis, Fourth Edition, Copyright © 2007 John Wiley & Sons, Inc., incorporated by reference herein. Exemplary methods for the deprotection of carboxyl protecting groups useful in connection with the present disclosure include, but are not limited to hydrolysis, such as hydrolysis of a carboxylic ester by contacting a with a hydroxide base, such as NaOH, KOH, LiOH, CsOH, Ca(OH)₂, Ba(OH)₂, and the like, nucleophilic displacement of a carboxyl protecting group, such as by contacting with LiS-n-Pr, NaSePh, LiCl KO-t-Bu, NaCN, NaTeH, KO₂, LiI, and PhSH. In some embodiments, and particularly in the case of allyl protecting groups, removing the protecting group may comprising adding a palladium source, such as Pd/C, Pd(0), Pd(II), and the like. One example of Pd(0) is Pd(PPh₃)₄. Examples of Pd(II) include PdCl₂ and Pd(OAc)₂. It is further contemplated that carboxyl protecting groups may be removed by adding an acid, such as trifluoroacetic acid (TFA), hydrochloric acid, p-toluenesulfonic acid, and the like.

Next, peptides on the subarray for forming cyclic peptides are exposed to conditions to promote the formation of amide bonds between their free amino and carboxyl groups. Due to this amide bond formation, the peptides on the subarray for forming cyclic peptides are cyclized to form cyclic peptides. During the cyclization step, some inefficiency is to be expected, and not all of the peptides cyclize. Peptides that do not cyclize remain in a deprotected linear form. Because the peptides on the subarray for forming linear peptides have protected carboxyl groups, amide bond formation does not occur during this step for these peptides, which remain in a protected linear form.

In some embodiments, linear peptides described herein are cyclized to form cyclic peptides by forming an amide bond between the C-terminus carboxyl group and the N-terminus amino group of linear peptides. Such reactions can be promoted by amide bond forming conditions commonly known in the art, including, but not limited to, conditions for activation of the C-terminus carboxyl group. Exemplary amide bond forming conditions useful in connection with the present disclosure include, but are not limited to, carbodiimides, such as dicyclohexylcarbodiimide, diisopropylcarbodiimide, and (N-(3-dimethylaminopropyl)-N′-ethylcarbodiimide.HCl; additives, such as 1-hydroxybenzotriazole, hydroxy-3,4-dihydro-4-oxo-1,2,3-benzotriazine, 2-(1H-benzotriazol-1-yl)-1,1,3,3-tetramethyluronium hexafluorophosphate, N-hydroxysuccinimide, 1-hydroxy-7-aza-1H-benzotriazole, ethyl 2-cyano-2-(hydroximino)acetate, and 4-(N,N-dimethylamino)pyridine; phosphonium reagents, such as benzotriazol-1-yloxy-tris(dimethylamino)-phosphonium hexafluorophosphate, benzotriazol-1-yloxy-tripyrrolidino-phosphonium hexafluorophosphate, bromo-tripyrrolidino-phosphonium hexafluorophosphate, 7-aza-benzotriazol-1-yloxy-tripyrrolidinophosphonium hexafluorophosphate, ethyl cyano(hydroxyimino)acetato-O₂)-tri-(1-pyrrolidinyl)-phosphonium hexafluorophosphate, and 3-(diethoxy-phosphoryloxy)-1,2,3-benzo[d]triazin-4(3H)-one; aminium/uronium-imonium reagents, such as 2-(1H-benzotriazol-1-yl)-N,N,N′ ,N′-tetramethylaminium tetrafluoroborate/hexafluorophosphate, 2-(6-chloro-1H-benzotriazol-1-yl)-N,N,N′,N′-tetramethylaminium hexafluorophosphate, (N-[(5-chloro-1H-benzotriazol-1-yl)-dimethylamino-morpholino]-uronium hexafluorophosphate N-oxide, 2-(7-aza-1H-benzotriazol-1-yl)-N,N,N′,N′-tetramethylaminium hexafluorophosphate, (1-[1-(cyano-2-ethoxy-2-oxoethylideneaminooxy)-dimethylamino-morpholino]-uronium hexafluorophosphate, (2-(1-oxy-pyridin-2-yl)-1,1,3,3-tetramethylisothiouronium tetrafluoroborate, and tetramethylfluoroformamidinium hexafluorophosphate; and other coupling reagents, such as N-ethoxycarbonyl-2-ethoxy-1,2-dihy droquinoline, 2-Propanephosphonic acid anhydride, 4-(4,6-dimethoxy-1,3,5-triazin-2-yl)- 4-methylmorpholinium salts, triphosgene, and 1,1′-carbonyldiimidazole.

After the cyclization step, the peptides on the subarray for forming linear peptides are deprotected. As a result of this deprotection step, peptides on the subarray for forming linear peptides are structurally identical to peptides on the subarray for forming cyclic peptides that fail to cyclize during the cyclization step. The binding properties of peptides on the linear peptide subarray and peptides on the cyclic peptide subarray can be compared to determine cyclic versus linear binding preferences against a given target. In doing so, it is possible to determine whether the linear sequence is contributing to binding in the cyclic feature. Several pairs of linear and cyclic peptide subarrays can be formed on a microarray to identify peptide sequences of interest.

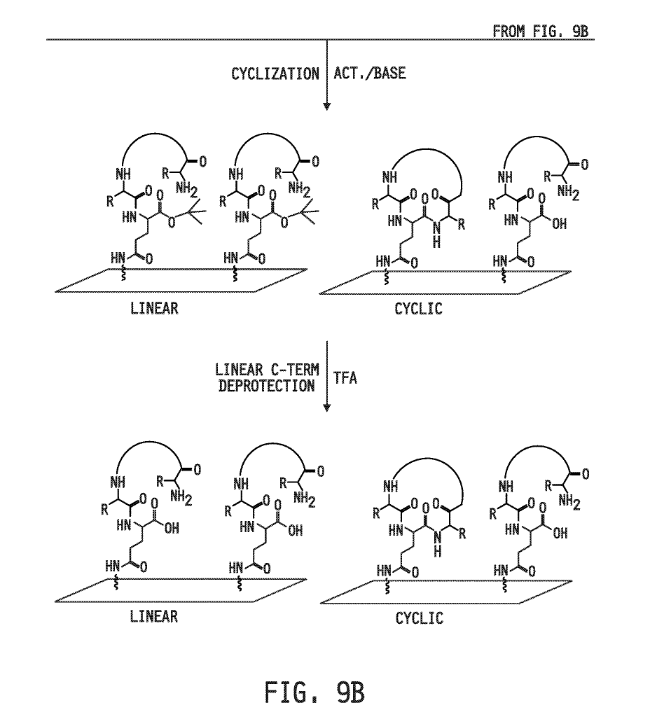

Referring to FIG. 9, in some embodiments, a linear peptide library is synthesized on the microarray by attaching the subject peptides to the microarray through the side chain of a linker amino acid. Although glutamate is shown in FIG. 9, other amino acid side chains, such as an aspartate side chain, may couple to the microarray surface active group to attach the subject peptides. Other amino acid side chains, natural or unnatural, such as alcohol, amine, thiol, acyl, phosphonyl, sulfonyl, and other functional groups that can form a covalent bond with the active group on the microarray surface are contemplated herein. It is further contemplated that the C-terminus carboxyl group of the linker amino acid may be coupled to the reactive surface, and the side chain of the linker amino may be a carboxyl side chain groups capable of forming an amide bond an amino group. The carboxyl protecting groups can be any two different carboxyl protecting groups that allow for selective deprotection and cyclization of one set of peptides without allowing the second set of peptides to cyclize.

### II. Microarrays:

In one embodiment, peptide microarrays are described which may be used in research and healthcare. For example, the peptide microarrays described herein may be utilized in the identification of biologically active motifs (e.g., the peptides on the microarrays (e.g., cyclic peptides) may imitate potential active motifs of ligands for screening the binding to corresponding receptors). In one aspect, the peptide microarrays disclosed herein may reflect specific sequences of disease-associated antigens (and thus be utilized for diagnostic or monitoring purposes, e.g., to detect antibodies from patient samples suggesting the presence of certain diseases). Another application of the peptide microarrays is the discovery of biochemical interactions, including the binding of proteins or DNA to peptides (e.g., cyclic peptides) immobilized on the peptide microarray, or for profiling cellular activity, enzymatic activity, cell adhesion, and the like.

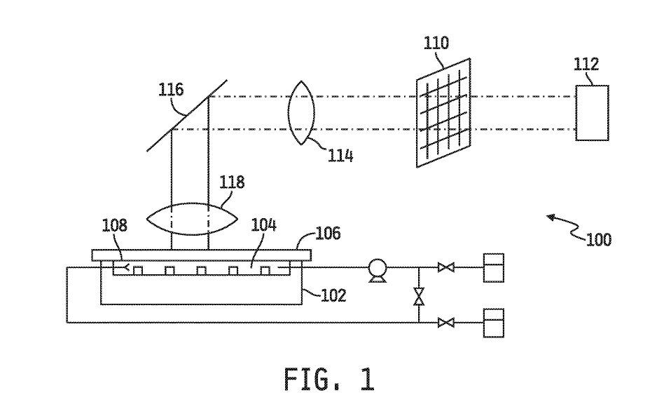

Various methods for the production of peptide microarrays are known in the art. For example, spotting prefabricated peptides or in-situ synthesis by spotting reagents, e.g., on membranes, exemplify known methods. Other known methods used for generating peptide microarrays of higher density are the so-called photolithographic techniques, where the synthetic design of the desired biopolymers is controlled by suitable photolabile protecting groups (PLPG) releasing the linkage site for the respective next component (amino acid) upon exposure to electromagnetic radiation, such as light (Fodor et al., (1993) Nature 364:555-556; Fodor et al., (1991) Science 251:767-773). Two different photolithographic techniques are known in the state of the art. The first is a photolithographic mask, used to direct light to specific areas of the synthesis surface effecting localized deprotection of the PLPG (see, for example, FIG. 1). “Masked” methods include the synthesis of polymers utilizing a mount (e.g., a “mask”) which engages a substrate and provides a reactor space between the substrate and the mount. Exemplary embodiments of such “masked” array synthesis are described in, for example, U.S. Pat. Nos. 5,143,854 ad 5,445,934, the disclosures of which are hereby incorporated by reference. Potential drawbacks of this technique, however, include the need for a large number of masking steps resulting in a relatively low overall yield and high costs, e.g., the synthesis of a peptide of only six amino acids in length could require over 100 masks.

The second photolithographic technique is the so-called maskless photolithography, where light is directed to specific areas of the synthesis surface effecting localized deprotection of the PLPG by digital projection technologies, such as micromirror devices (Singh-Gasson et al., Nature Biotechn. 17 (1999) 974-978). Such “maskless” microarray synthesis thus eliminates the need for time-consuming and expensive production of exposure masks. It should be understood that the embodiments of the peptide microarrays, methods of generating peptide microarrays, and methods of identifying peptide binders (e.g., cyclic peptides) using microarrays disclosed herein may utilize any of the various peptide microarray synthesis techniques described above.

The use of PLPG (photolabile protecting groups), providing the basis for the photolithography based synthesis of peptide microarrays, is well known in the art. Commonly used PLPG for photolithography based biopolymer synthesis are for example α-methyl-6-nitropiperonyl-oxycarbonyl (MeNPOC) (Pease et al., Proc. Natl. Acad. Sci. USA (1994) 91:5022-5026), 2-(2-nitrophenyl)-propoxycarbonyl (NPPOC) (Hasan et al. (1997) Tetrahedron 53: 4247-4264), nitroveratryloxycarbonyl (NVOC) (Fodor et al. (1991) Science 251:767-773) and 2-nitrobenzyloxycarbonyl (NBOC) (Patchornik et al. (1970) 21:6333-6335).

Amino acids have been introduced in photolithographic solid-phase peptide synthesis of peptide microarrays, which were protected with NPPOC as a photolabile amino protecting group, wherein glass slides were used as a solid support (U.S. App. Pub. No. 2005/0101763 A1). The method using NPPOC protected amino acids has the disadvantage that the half-life upon irradiation with light of all (except one) protected amino acids is within the range of approximately 2 to 3 minutes under certain conditions. In contrast, under the same conditions, NPPOC-protected tyrosine exhibits a half-life of almost 10 minutes. As the velocity of the whole synthesis process depends on the slowest sub-process, this phenomenon increases the time of the synthesis process by a factor of 3 to 4. Concomitantly, the degree of damage by photogenerated radical ions to the growing peptides increases with increasing and excessive light dose requirement.

As used herein, the term “peptide microarray” refers to a two dimensional arrangement of features on the surface of a solid support. A single peptide microarray or, in some cases, multiple peptide microarrays (e.g., 3, 4, 5, or more peptide microarrays) can be located on one solid support. The size of the peptide microarrays depends on the number of peptide microarrays on one solid support. The higher the number of peptide microarrays per solid support, the smaller the peptide microarrays have to be to fit on the solid support. The arrays can be designed in any shape, but preferably they are designed as squares or rectangle. The ready to use product is the peptide microarray on the solid support (e.g., peptide microarray slide).

The term “peptide microarray” (or peptide chip or peptide epitope microarray) includes a population or collection of peptides displayed on a solid support, for example a glass, carbon composite or plastic array, slide or chip. Exemplary uses of peptide microarrays include the fields of biology, medicine and pharmacology, including the study of binding properties, functionality and kinetics of protein-protein interactions. Basic research use may include profiling of enzymes (e.g., kinase, phosphatase, protease, acetyltransferase, histone deacetylase) and mapping an antibody epitope to find key residues for protein binding. Other applications include seromarker discovery, profiling of changing humoral immune responses of individual patients during disease progression, monitoring of therapeutic interventions, patient stratification and development of diagnostic and therapeutic tools and vaccines.

The term “feature” refers to a defined area on the surface of a peptide microarray. The feature comprises biomolecules, such as peptides. One feature can contain biomolecules with different properties, such as different sequences or orientations, as compared to other features. The size of a feature is determined by two factors: i) the number of features on a peptide microarray, the higher the number of features on a peptide microarray, the smaller is each single feature, and ii) the number of individually addressable aluminum minor elements which are used for the irradiation of one feature. The higher the number of mirror elements used for the irradiation of one feature, the bigger is each single feature. The number of features on a peptide microarray may be limited by the number of minor elements (pixels) present in the micro minor device. For example, the state of the art micro minor device from Texas Instruments, Inc. currently contains 4.2 million minor elements (pixels), thus the number of features within such exemplary peptide microarray is therefore limited by this number. However, it should be understood that the micro minor device from Texas Instruments, Inc. is provided only for exemplary purposes and higher density peptide microarrays are possible.

The term “solid support” refers to any solid material, having a surface area to which organic molecules can be attached through bond formation or absorbed through electronic or static interactions such as covalent bond or complex formation through a specific functional group. The solid support can be a combination of materials such as plastic on glass, carbon on glass, and the like. The functional surface can be simple organic molecules but can also comprise co-polymers, dendrimers, molecular brushes and the like.

The term “plastic” refers to synthetic materials, such as homo- or hetero-co-polymers of organic building blocks (monomer) with a functionalized surface such that organic molecules can be attached through covalent bond formation or absorbed through electronic or static interactions such as through bond formation through a functional group. Preferably the term “plastic” refers to polyolefin, which is a polymer derived by polymerization of an olefin (e.g., ethylene propylene diene monomer polymer, polyisobutylene). Most preferably, the plastic is a polyolefin with defined optical properties, like TOPAS® or ZEONOR/EX®.

The term “functional group” refers to any of numerous combinations of atoms that form parts of chemical molecules, that undergo characteristic reactions themselves, and that influence the reactivity of the remainder of the molecule. Typical functional groups include, but are not limited to, hydroxyl, carboxyl, aldehyde, carbonyl, amino, azide, alkynyl, thiol and nitril. Potentially reactive functional groups include, for example, amines, carboxylic acids, alcohols, double bonds, and the like. Preferred functional groups are potentially reactive functional groups of amino acids such as amino groups or carboxyl groups. Functionalized peptides contain reactive functional groups.

As used herein, “substantially does not cyclize” means that less than 5% cyclize.

As understood by one of skill in the art, peptide microarrays comprise an assay principle whereby thousands (or in the case of the instant disclosure, millions) of peptides (in some embodiments presented in multiple copies) are linked or immobilized to the surface of a solid support (which in some embodiments comprises a glass, carbon composite or plastic chip or slide). According to embodiments of the instant disclosure, peptide microarrays may be incubated with a variety of different targets of interest including purified enzymes or antibodies, patient or animal sera, cell lysates, ligands for receptors, receptors, substrates for enzymes, and the like.

In some embodiments, the peptide microarray, after incubation with a target of interest, undergoes one or more washing steps, and then is exposed to a secondary antibody having a desired specificity (e.g. anti IgG human/mouse or anti phosphotyrosine or anti myc). Usually, the secondary antibody is tagged by a fluorescent label that can be detected by a fluorescence scanner Other detection methods are chemiluminescence, colorimetry or autoradiography.

In some embodiments, after scanning the peptide microarray slides, the scanner records a 20-bit, 16-bit or 8-bit numeric image in tagged image file format (*.tif). The .tif-image enables interpretation and quantification of each fluorescent spot on the scanned peptide microarray slide. This quantitative data is the basis for performing statistical analysis on measured binding events or peptide modifications on the peptide microarray slide. For evaluation and interpretation of detected signals an allocation of the peptide spot (visible in the image) and the corresponding peptide sequence has to be performed.

In one embodiment, a peptide microarray can be a slide with peptides spotted onto it or assembled directly on the surface by in-situ synthesis. Peptides are ideally covalently linked through a chemoselective bond leading to peptides with the same orientation for interaction profiling. Alternative procedures include unspecific covalent binding and adhesive immobilization.

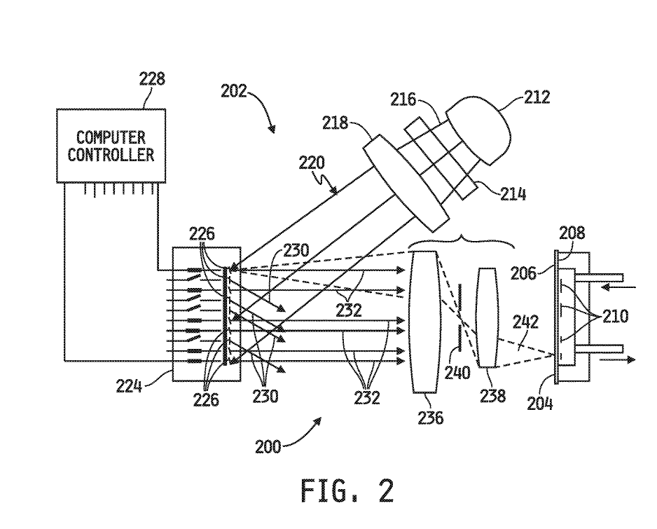

With reference to FIGS. 1 and 2, embodiments of various peptide microarray synthesizers (utilized in both masked and maskless photolithographic techniques, respectively) are presented. Specifically referring now to FIG. 1, an exemplary system 100 for performing masked photolithographic techniques (such as taught in U.S. Pat. No. 5,445,934) is shown, illustrating a system body 102 with a cavity 104 defined at a surface thereof. A substrate (solid support) 106, having a photoremovable protective group (for example, such as NVOC with or without an intervening linker molecule) along its bottom surface 108 is mounted above the cavity 104. The substrate (solid support) 106, for example, may be transparent to a wide spectrum of light, or in some embodiments is transparent only at a wavelength at which the protective group may be removed (such as UV in the case of NVOC). The substrate (solid support) 106 and the body 102 seal the cavity 104 (except for inlet and outlet ports) and may be mated, for example, by way of gasket(s) or a vacuum.

Lens 118, and in some embodiments, reflective mirror 116 are provided for focusing and directing light from light source 112 (such as a Xe(Hg) light source) onto substrate (solid support) 106. In the illustrated embodiment of FIG. 1 a second lens 114 is shown (and in some embodiments may be provided) for projecting a mask image onto the substrate (solid support) in combination with lens 118 (a.k.a., “projection printing”). Light (from light source 112), prior to contacting substrate (solid support) 106 contacts mask 110, whereby such light is permitted to reach only selected locations on substrate (solid support) 106. Mask 110 may be, for example, a glass slide having etched chrome thereon. In some embodiments, mask 110 may be provided with a grid of transparent locations and opaque locations, for example. As is understood by a person of skill in the art, with masked array synthesis, light passes freely through “transparent” regions of mask 110, but is reflected from, or absorbed by, other (e.g., “non-transparent”) regions of mask 110. Thus, only selected regions of substrate (solid support) 106 are exposed to light.

Also, light valves (LCD's) may be used as an alternative to conventional masks (to selectively expose regions of the substrate); fiberoptic faceplates may be used (for contrast enhancement of the mask or as the sole means of restricting the region to which light is applied); and fly's-eye lenses, tapered fiberoptic faceplates, or the like, may also be used for contrast enhancement. Also, it should be understood that illumination of regions smaller than a wavelength of light may be accomplished with more elaborate techniques as known in the art (e.g., directing light at the substrate by way of molecular microcrystals on the tip of, for example, micropipettes). Exemplary devices are disclosed in Lieberman et al., “A Light Source Smaller than the Optical Wavelength,” Science (1990) 247:59-61.

Now, specifically referring to FIG. 2, an exemplary “maskless” peptide microarray system (as described, for example, in U.S. Pat. No. 6,375,903) that may be utilized in accordance with the instant disclosure is provided for illustrating “maskless” peptide microarray synthesis. The illustrative system, shown generally as 200, is depicted including a two-dimensional array image former 202 and a substrate (solid support) 204 onto which the array image is projected. In the illustrative embodiment presented at FIG. 2, the substrate (solid support) has an exposed entrance surface 206 and an opposite active surface 208 on which a two-dimensional array of peptides 210 is to be fabricated. However, in some embodiments the substrate (solid support) 204 may have active surface 208 facing the image former 202 and enclosed within a reaction chamber flow cell having a transparent window (allowing light to be projected onto the active surface 208). (solid support) Embodiments may include opaque or porous substrates (solid support) 204 as well.

In some embodiments of maskless peptide microarrays according to this instant disclosure, an image former 202 may include a light source 212 (e.g., an ultraviolet or near ultraviolet source such as a mercury arc lamp), an optional filter 214 (to receive output beam 216 from source 212 and selectively pass only the desired wavelengths, e.g., 365 nm Hg line), and a condenser lens 218 (for forming a collimated beam 220). Other devices for filtering or monochromating the source light, e.g., diffraction gratings, dichroic minors, and prisms, may also be used rather than a transmission filter, and are generically referred to as “filters” herein.

As shown, beam 220 is projected a two-dimensional micromirror array device 224 having a two-dimensional array of individual micromirrors 226 which are each responsive to control signals (provided by computer controller 228) supplied to the array device 224 to tilt in one of at least two directions. In some embodiments, the micromirrors 226 are constructed so that: A.) in a first position beam 220 that strikes an individual micromirror 226 may be deflected in a direction oblique to beam 220 (as indicated by the arrows 230); and B.) in a second position, beam 220 striking such minors is reflected back parallel to beam 220, as indicated by the arrows 232. As should be understood, the light reflected from each of the minors 226 constitutes an individual beam 232. The beams 232 are incident upon projection optics 234 (comprising, for example, lenses 236, 238 and an adjustable iris 240). The projection optics 234 serve to form an image of the pattern of the micromirror array 224, as represented by the individual beams 232 (and the dark areas between these beams), on the active surface 208 of the substrate 204. As described above and throughout this disclosure, the substrate support 204 may be transparent, and may be, for example, formed of fused silica or soda lime glass or quartz, so that the light projected thereon (illustrated by the lines 242), passes through substrate 204 without substantial attenuation or diffusion.

An exemplary micromirror array 224 in accordance with the instant disclosure includes the Digital Micromirror Device (DMD) (available commercially from Texas Instruments, Inc.) which is capable of forming patterned beams of light by electronically addressing the micromirrors in the arrays. Such arrays are discussed, for example, in: Larry J. Hornbeck, “Digital Light Processing and MEMs: Reflecting the Digital Display Needs of the Networked Society,” SPIE/EOS European Symposium on Lasers, Optics, and Vision for Productivity and Manufacturing I, Besancon, France, Jun. 10-14, 1996; and U.S. Pat. Nos. 5,096,279, 5,535,047, 5,583,688, 5,600,383 and 6.375,903. The micromirrors 226 of such devices are capable of reflecting the light of normal usable wavelengths, including ultraviolet and near ultraviolet light, in an efficient manner without damage to the minors themselves.

In some peptide microarray embodiments, the projection optics 234 may be of standard design. Lenses 236, 238 focus the light in beam 232 (passed through adjustable iris 240) onto the active surface 208 of substrate 204. The iris 240 aides in controlling the effective numerical aperture and in ensuring that unwanted light (particularly the off-axis beams 230) is not transmitted to substrate (solid support) 204. Resolutions of dimensions as small as a fraction of a micron are obtainable with such optics systems. Various alternate configurations (e.g., for example as preferred in manufacturing applications), as known in the art may also be utilized in accordance with the instant application.

It should be understood that although exemplary embodiments are provided herein, various approaches may be utilized in the fabrication of the peptides 210 on the substrate (solid support) 204, and include adaptations of microlithographic techniques. For example, in a “direct photofabrication approach,” the substrate (solid support) 204 may be coated with a layer of a chemical capable of binding amino acids (e.g., an amine) which, for example, may be protected with a chemical group that is able to react with and be removed by light. Light therefore may be applied by the projection system 202, deprotecting the amine groups on the substrate 204 and making them available for binding the amino acids (which are flowed onto the active surface 208 of the substrate (solid support) 204 for binding to the selected sites using normal chemistry). This process is repeated multiple times, thereby binding another amino acid to a different set of locations. The process is simple, and if a combinatorial approach is used the number of permutations increases exponentially.

According to some embodiments of the instant disclosure, maskless array synthesis is utilized in the fabrication of the peptides 210 on substrate (solid support) 204. According to such embodiments, the maskless array synthesis employed allows ultra-high density peptide synthesis with synthesis up to 2.9M unique peptides. Each of 2.9M synthesis features/regions have up to 10⁷ reactive sites that could yield a full length peptide. Smaller peptide microarrays can also be designed. For example, a peptide microarray representing a comprehensive list of all possible 5-mer peptides using all natural amino acids excluding cysteine will have 2,476,099 peptides. A peptide microarray of 5-mer peptides by using all combinations of 18 natural amino acids excluding cysteine and methionine may also be used. Additionally, a peptide microarray can exclude other amino acids or aminoacid dimers. For example, the 18-mer an⁻ay exemplified above may be designed to exclude any dimer or a longer repeat of the same amino acid, as well as any peptide containing HR, RH, HK, KH, RK, KR, HP, and PQ sequences to create a library of 1,360,732 unique peptides. Smaller peptide microarrays may have replicates of each peptide on the same peptide microarray to increase the confidence of the conclusions drawn from peptide microarray data.

In various embodiments, the peptide microarrays described herein can have at least 1.6×10⁵ peptides, at least 2.0×10⁵ peptides, at least 3.0×10⁵ peptides, at least 4.0×10⁵ peptides, at least 5.0×10⁵ peptides, at least 6.0×10⁵ peptides, at least 7.0×10⁵ peptides, at least 8.0×10⁵ peptides, at least 9.0×10⁵ peptides, at least 1.0×10⁶ peptides, at least 1.2×10⁶ peptides, at least 1.4×10⁶ peptides, at least 1.6×10⁶ peptides, at least 1.8×10⁶ peptides, at least 1.0×10⁷ peptides, or at least 1.0×10⁸ peptides attached to the solid support of the peptide microarray. In other embodiments, the peptide microarrays described herein can have about 1.6×10⁵ peptides, about 2.0×10⁵ peptides, about 3.0×10⁵ peptides, about 4.0×10⁵ peptides, about 5.0×10⁵ peptides, about 6.0×10⁵ peptides, about 7.0×10⁵ peptides, about 8.0×10⁵ peptides, about 9.0×10⁵ peptides, about 1.0×10⁶ peptides, about 1.2×10⁶ peptides, about 1.4×10⁶ peptides, about 1.6×10⁶ peptides, about 1.8×10⁶ peptides, about 1.0×10⁷ peptides, or about 1.0×10⁸ peptides attached to the solid support of the peptide microarray. As described herein, a peptide microarray comprising a particular number of peptides can mean a single peptide microarray on a single solid support, or the peptides can be divided and attached to more than one solid support to obtain the number of peptides described herein.

Peptide microarrays synthesized in accordance with such embodiments can be designed for peptide binder discovery in the cyclic form (as noted herein) and with and without modification such as N-methyl or other PTMs. Peptide microarrays cam also be designed for further extension of potential binders using a block-approach by performing iterative screens on the N-terminus and C-terminus of a potential hit (as is further described in detail herein). Once a hit of an ideal affinity has been discovered it can be further matured using a combination of maturation arrays (described further herein), that allow a combinatorial insertion, deletion and replacement analysis of various amino acids, both natural and non-natural. In one embodiment, the maturation and/or extension process can be followed by cyclization.

The peptide microarrays of the instant disclosure can be used in monoclonal antibody cross reactivity profiling, polyclonal sera profiling, epitope identification (for an antibody of interest), lupus immune reactivity profiling, gut profiling; cancer biomarker profiling, pseudo-monoclonal antibody isolation (from isolates of a polyclonal antibody), peptide to protein interaction characterization, affinity purification, and specific and sensitive binding analysis for diagnostic or therapeutic applications. In one embodiment, peptide binders identified and disclosed herein can be matured and/or extended (including with non-natural amino acids) and a cyclic peptide formed making such binder a potential drug candidate.

### III. Peptide Binder Discovery:

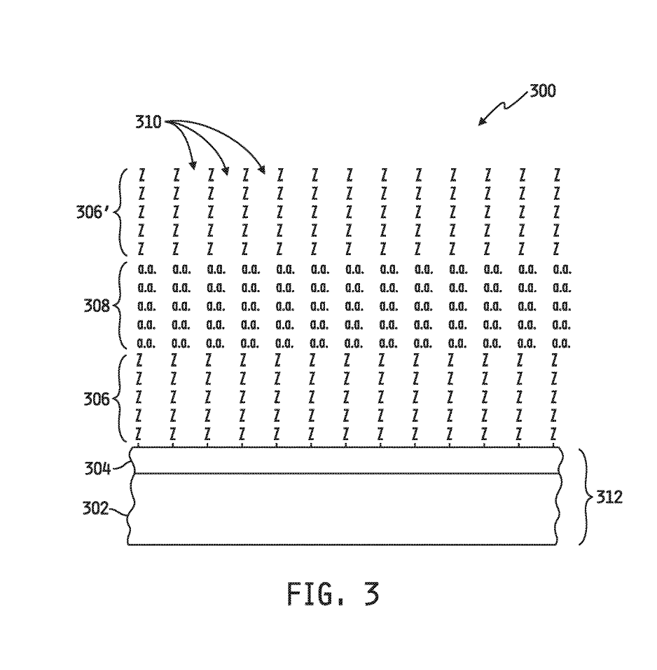

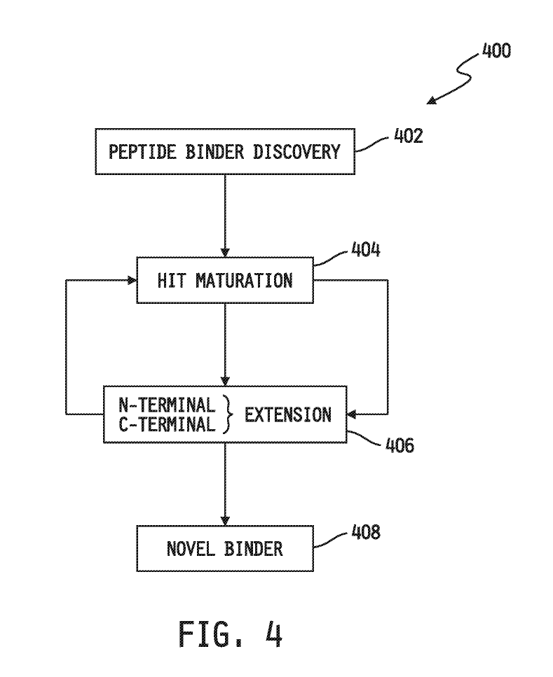

Discovery of novel peptide binders (e.g., cyclic peptides; see, for example, FIG. 4, the method generally represented as 400) may be accomplished, according to the instant disclosure. As explained herein, such novel peptide binders can be utilized in numerous applications, including but not limited to therapeutics, diagnostic applications and general laboratory applications. According to some specific embodiments of the instant disclosure, a peptide microarray may be designed comprising a population of hundreds, thousands, tens of thousands, hundreds of thousands and even millions of peptides. With reference to FIG. 3, in some embodiments, the population of peptides 310 can be configured such that the peptides represent an entire protein, gene, chromosome, molecule or even and entire organism (e.g., a human) of interest. In some embodiments, the peptides can be configured according to specific criteria, whereby specific amino acids or motifs are excluded. In other embodiments, the peptides can be configured such that each peptide comprises an identical length. For example, in some embodiments the population of peptides 310 immobilized on the peptide microarray 312 may all comprise 3-, 4-, 5-, 6-, 7-, 8-, 9-, 10-, 11-, 12-, 13-, 14-, 15-, 16-, 17-, 18-, 19-, or 20-mers 308, or more. In some embodiments, the peptides may also each comprise an N-terminal or a C-terminal sequence (for example, 306 and 306′) where each peptide comprises both an N and a C terminal peptide sequence of a specific and identical length (e.g., 3-, 4-, 5-, 6-, 7- or even 8- or more peptides). In some embodiments, the N-terminal or C-terminal sequence (306, 306′) is not present, and the peptides 310 immobilized on the peptide microarray 312 only comprise the 3-, 4-, 5-, 6-, 7-, 8-, 9-, 10-, 11-, 12-, 13-, 14-, 15-, 16-, 17-, 18-, 19-, or 20- mers 308. In some embodiments, the peptides 310 immobilized on the peptide microarray 312 comprise cyclic peptides that have been cyclized according to the methods described herein.

According to some embodiments, a peptide microarray 300 is designed including a population of up to 2.9 million peptides 310, configured such that the 2.9 million peptides represents a comprehensive list of all possible 5-mer peptides 308 of a genome, immobilized on a peptide microarray 312. In some such embodiments, the 5-mer peptides 308 (comprising the 2.9 million peptides of the peptide microarray) may exclude the amino acid cysteine (C) (in order to aide in controlling unusual folding of the peptide); or the amino acid methionine (M) (because M is considered a rare amino acid within the proteome); and/or all amino acid repeats of 2 or more of the same amino acid (in order to aide in controlling non-specific interactions such as charge and hydrophobic interactions); or amino acid motifs consisting of histidine (H)— proline (P)— glutamine (Q) sequence. In some illustrative embodiments, such as provided at FIG. 3, the 5-mer peptides 308 may exclude one, or more than one of the exclusions listed above. One embodiment of the invention includes a peptide microarray comprising a population of up to 2.9 million 5-mer peptides 310, representing the entire human genome, wherein the 5-mer peptides 308 do not include any of the amino acids C and M, do not include amino acid repeats of 2 or more amino acids and do not include the amino acid motif HPQ. Another embodiment of the invention includes a peptide microarray comprising up to 2.9 million 5-mer peptides, representing the protein content encoded by the entire human genome, wherein the 5-mer peptides do not include any of the amino acids C and M, do not include amino acid repeats of 2 or more amino acids. It should be understood, that the sequences of the peptides at specific locations on the peptide microarray is known. As referred to in this paragraph and in this disclosure, peptides on a peptide microarray can be cyclic peptides.

According to further embodiments, each 5-mer peptide 308 comprising the population of up to 2.9 million peptides 310 of the peptide microarray 300 may be synthesized with 5 cycles of wobble synthesis in each of the N-terminus and of the C-terminus (see, for example, 306 and 306′ FIG. 3). As used herein “wobble synthesis” refers to synthesis (through any of the means disclosed herein) of a sequence of peptides (either constant or random; e.g., cyclic peptides) which are positioned at the N-terminus or C-terminus of the 5-mer peptide 308 of interest. As illustrated in FIG. 3, the specific amino acids comprising the wobble synthesis at either the N- or C-terminus are represented by a “Z.” According to various embodiments, wobble synthesis may include any number of peptides at the N-terminus or C-terminus, for example 1, 2, 3, 4, 5, 6, 7, 8, 9, 10 or more, even for example 15 or 20 peptides (e.g., cyclic peptides). Furthermore, wobble synthesis may comprise an N-terminus and C-terminus having the same or differing number of wobble synthesized peptides (e.g., cyclic peptides).

According to various embodiments, the wobble peptide compositions 306, 306′ are flexible in terms of amino acid composition and in term of amino acid ratios/concentrations. For example, the wobble peptide compositions may comprise a mixture of 2 or more amino-acids. An illustrative embodiment of such flexible wobble mix includes a wobble peptide composition 306, 306′ of glycine (G) and serine (S) at a ratio of 3:1. Other examples of a flexible wobble mixture include equal concentrations (e.g., equal ratios) of amino acids G, S, adenine (A), valine (V), aspartic acid (D), proline (P), glutamic acid (E), leucine (L), threonine (T) and/or equal concentrations (e.g., equal ratios) of amino acids L, A, D, lysine (K), T, glutamine (Q), P, F, V, tyrosine (Y). Other examples include the wobble peptide compositions 306, 306′comprising any of the 20 known amino acids, in equal concentrations.

As disclosed herein, the wobble peptide synthesis of the various embodiments allow for generating a peptide on a peptide microarray having a combination of random and directed synthesis amino acids. For example, a peptide on a peptide microarray may comprise a combined 15-mer peptide having a peptide sequence in the following format: ZZZZZ-5-mer-ZZZZZ, where Z is an amino-acid from a particular wobble oligopeptide mixture.

In some embodiments, a feature may contain 10⁷ peptides. In some such embodiments, the population complexity for each feature may vary depending on the complexity of the wobble mixture. As disclosed herein, creating such complexity using wobble synthesis in a semi-directed synthesis enables the screening of peptide binders on the array, using peptides with diversity up to 10¹² per array.

In one embodiment, with reference to FIG. 3, a peptide microarray 300 comprising a solid support 302 having a reactive surface 304 (e.g., a reactive amine layer for example) with a population of peptides 310 (such as a population of 5-mers representing the entire human proteome) immobilized thereto is provided. The exemplary 5-mer peptides comprising the population of peptides 310, according to such embodiment, does not include any of the amino acids C and M, does not include amino acid repeats of 2 or more amino acids and does not include the amino acid motif HPQ. According to such illustrative embodiment, such population of peptides 310 representing the entire human proteome would comprise 1,360,732 individual peptides comprising the population 310. In some embodiments, duplicates or repeats may be placed on the same peptide microarray. For example, a population 310 comprising a single duplicate would comprise 2,721,464 individual peptides. Additionally, the population of peptides 310 each comprise an N-terminal and C-terminal wobble synthesis oligopeptide 306, 306′, which for example consists of five amino acids each consisting of the amino acid glycine and serine in a 3:1 ratio, respectively. Such peptides can be cyclized as described herein.

Referring generally now to step 402 of process 400 of FIG. 4, in use an exemplary peptide microarray 300 (FIG. 3; such peptide microarray may comprise cyclic peptides as described herein) is exposed to a target of interest (as with standard peptide microarray practice), whereby the target of interest may bind at any of the population of peptides 310 (e.g., cyclic peptides), independent of the other peptides comprising the population 310. After exposure to the target of interest, binding of the target of interest to the peptide binders (e.g., cyclic peptides) is assayed, for example, by way of exposing the complex of the individual peptides (e.g., cyclic peptides) of the population 310 and target of interest to an antibody (specific for the target of interest) which has a reportable label (e.g., peroxidase) attached thereto. Because the peptide sequence of each 5-mer, at each location on the peptide microarray, is known, it is possible to chart/quantify/compare/contrast the sequences (and binding strengths) of the binding of the target of interest to specific 5-mer peptide sequences (e.g., cyclic peptides). One such method of comparing the protein binding to the peptides (e.g., cyclic peptides) comprising the population 310 is to review the binding in a principled analysis distribution-based clustering, such as described in, Standardizing and Simplifying Analysis of Peptide Library Data, Andrew D White et al, J Chem Inf Model, 2013, 53(2), pp 493-499, and illustrated herein. As is exemplified herein, the clustering of target of interest-5-mer binding (a.k.a., “hits”) (shown in a principled analysis distribution-based clustering) indicates 5-mers having overlapping peptide sequences. As demonstrated in greater detail below, from the overlapping peptide sequences (of each cluster), a “core hit” peptide sequence or core binder sequence (e.g., a peptide sequence shared by the prominent target of interest-peptide binding events of the peptide microarray) can be identified, or at least hypothesized and constructed for further evaluation. (Note, it should be understood that a peptide microarray, as exemplified herein, may identify more than one “core hit” peptide sequence (i.e., core binder sequence). It should further be understood that it is possible for the “core hit” peptide sequence to comprise more amino acids than, for the example, the 5-mer peptide binders comprising the population of peptides due to possible identification of overlapping and adjacent sequences during principled analysis distribution-based clustering).

### IV. Peptide Maturation:

Referring now to step 404 of process 400 graphically described in FIG. 4, upon identification of a core hit peptide sequence or core binder sequence (through the process of peptide binder discovery 402 disclosed, described and exemplified herein), a process of “peptide maturation” 404 whereby the core hit peptide sequence or core binder sequence is altered in various ways (through amino acid substitutions, deletions and insertions) at each position of the core hit peptide or core binder sequence in order to further optimize/verify the proper core hit sequence or core binder sequence. For example, according to some embodiments (for example, where the core hit peptide sequence (core binder sequence) comprises a given number of, such as 7, amino acids), a maturation array is produced. According to the instant disclosure, the maturation array may have, immobilized thereto, a population of core hit peptides (core binder sequence) whereby each amino acid in the core hit peptide (core binder sequence) has undergone an amino acid substitution at each position.

In order to further describe the process of hit maturation 404, an example/hypothetical core hit peptide or core binder sequence is described as consisting of a 5-mer peptide having the amino acid sequence -M₁M₂M₃M₄M₅- (SEQ ID NO: 202). According to the instant disclosure, hit maturation 404 may involve any of, or a combination of any or all of, amino acid substitutions, deletions and insertions at positions 1, 2, 3, 4 and 5. For example, in regard to the hypothetical core hit peptide or core binder sequence -M₁M₂M₃M₄M₅- (SEQ ID NO: 202), embodiments of the instant disclosure may include the amino acid M at position 1 being substituted with each of the other 19 amino acids (e.g., A₁M₂M₃M₄M₅- (SEQ ID NO: 203), P₁M₂M₃M₄M₅- (SEQ ID NO: 204), V₁M₂M₃M₄M₅- (SEQ ID NO: 205), Q₁M₂M₃M₄M₅- (SEQ ID NO: 206), etc.). Each position (2, 3,4 and 5) would also have the amino acid M substituted with each of the other 19 amino acids (for example, with position 2 the substitutions would resemble, M₁A₂M₃M₄M₅- (SEQ ID NO: 207), M₁Q2M3M4M5- (SEQ ID NO: 208), M₁P₂M₃M₄M₅- (SEQ ID NO: 209), M₁N₂M₃M₄M₅- (SEQ ID NO: 210), etc.). It should be understood that a peptide (immobilized on an array) is created comprising the substituted and/or deleted and/or inserted sequences of the core hit peptide or core binder sequence.

In some embodiments of hit maturation 404 according to the instant disclosure, a double amino acid substitution may be performed. A double amino acid substitution includes altering the amino acid at a given position (e.g., a M→P substitution, for example at position 1) and then substituting the amino acid at position 2 with each of the other 19 amino acids the amino acid at position 2. This process is repeated until all possible combinations of positions 1 and 2 are combined. By way of example, referring back to the hypothetical core hit peptide or core binder sequence having a 5-mer peptide with amino acid sequence -M₁M₂M₃M₄M₅- (SEQ ID NO: 202), a double amino acid substitution with regard to positions 1 and 2 may include, for example, a M→P substitution at position 1, and then a substitution of all 20 amino acids at position 2 (e.g., -P₁A₂M₃M₄M₅- (SEQ ID NO: 211), -P ₁F₂M₃M₄M₅- (SEQ ID NO: 212), -P₁V₂M₃M₄M₅- (SEQ ID NO: 213), -P₁E₂M₃M₄M₅- (SEQ ID NO: 214), etc.), a M→V substitution at position 1, and then a substitution of all 20 amino acids at position 2 (e.g., -V₁A₂M₃M₄M₅- (SEQ ID NO: 215), -V₁F₂M₃M₄M₅- (SEQ ID NO: 216), -P₁V₂M₃M₄M₅- (SEQ ID NO: 217), -V₁E₂M₃M₄M₅- (SEQ ID NO: 218), etc.), M→A substitution at position 1, and then a substation of all 20 amino acids at position 2 (e.g., -A₁A₂M₃M₄M₅- (SEQ ID NO: 219), -A₁F₂M₃M₄M₅- (SEQ ID NO: 220), -A₁V₂M₃M₄M₅- (SEQ ID NO: 221), -A₁E₂M₃M₄M₅-(SEQ ID NO: 222), etc.).

In some embodiments of hit maturation 404 according to the instant disclosure, an amino acid deletion for each amino acid position of the core hit peptide may be performed. An amino acid deletion includes preparing a peptide including the core hit peptide sequence or core binder sequence, but deleting a single amino acid from the core hit peptide sequence or core binder sequence (such that a peptide is created in which the amino acid at each peptide is deleted). By way of example, referring back to the hypothetical core hit peptide or core binder sequence having a 5-mer peptide with amino acid sequence -M₁M₂M₃M₄M₅- (SEQ ID NO: 202), an amino acid deletion would include preparing a series of peptides having the following sequences -M₂M₃M₄M₅- (SEQ ID NO: 223); -M₁M₃M₄M₅- (SEQ ID NO: 223); -M₁M₂M₄M₅-(SEQ ID NO: 223); -M₁M₂M₃M₅- (SEQ ID NO: 223); and -M₁M₂M₃M₄- (SEQ ID NO: 223). It should be noted that, following an amino acid deletion of the hypothetical 5-mer, 5 new 4-mers are created. According to some embodiments of the instant disclosure an amino acid substitution or a double amino acid substation scan can be performed for each new 4-mer generated.

Similar to the amino acid deletion scan discussed above, some embodiments of hit maturation 404 disclosed herein may include an amino acid insertion scan, whereby each of the 20 amino acids is inserted before and after every position of the core hit peptide or core binder sequence. By way of example, referring back to the hypothetical core hit peptide or core binder sequence having a 5-mer peptide with amino acid sequence -M₁M₂M₃M₄M₅- (SEQ ID NO: 202), an amino acid insertion scan would include the following sequences, -XM₁M₂M₃M₄M₅-(SEQ ID NO: 224); -M₁XM₂M₃M₄M₅- (SEQ ID NO: 225); -M₁M₂XM₃M₄M₅- (SEQ ID NO: 226); -M₁M₂M₃XM₄M₅- (SEQ ID NO: 227); -M₁M₂M₃M₄XM₅- (SEQ ID NO: 228); and -M₁M₂M₃M₄M₅X- (SEQ ID NO: 229) (where X represents an individual amino, selected from the 20 known amino acids or a specific, defined subset of amino acids, whereby a peptide replicate will be created for each of the 20 or defined subset of amino acids).

It should also be understood that the amino acid-substituted peptides, double amino acid- substituted peptides, amino acid deletion scan peptides and amino acid insertion scan peptides described above may also include one, or both of, a N-terminal and C-terminal wobble amino acid sequence (similar to as described at 306, 306′ of FIG. 3, for example). As with the N-terminal and C-terminal wobble amino acid sequences described in FIG. 3, the N-terminal and C-terminal wobble amino acid sequences may comprise as few as 1 amino acid or as many as 15 or 20 amino acids, and the N-terminal wobble amino acid sequence may be the same length as, longer than or shorter than the C-terminal wobble amino acid sequence. Further, the N-terminal and C-terminal wobble amino acid sequences may comprise any defined group of amino acids at any given ratios (for example, glycine and serine in a 3:1 ratio). In a specific exemplified embodiment of hit maturation 404 described below, a core hit peptide or core binder sequence of 7 amino acids (e.g., a 7-mer) undergoes exhaustive single and double amino acid screens, and includes both N-terminal and C-terminal wobble amino acid sequences which comprise three amino acids (all glycine).

Once the various substitution, deletion and insertion variations of the core hit peptide or core binder sequence are prepared (for example, in immobilized fashion on a solid support such as a peptide microarray), the strength of binding of the purified, concentrated target of interest is assayed.

### V. Peptide Extension (N-terminal and C-Terminal):

It is possible that motifs identified in 5-mer array experiments represent only short versions of optimal peptide binders. A strategy is described herein of identifying longer motifs by extending sequences selected from 5-mer arrays experiments by one or more amino acids from one or both N- and C-terminus. Starting from a selected peptide and adding one or more amino acids on each terminus, one can create an extension library for further selection. For example, starting from a single peptide and using all 20 natural amino acids, one can create an extension library of 160,000 unique peptides. In some embodiments, each of the extended peptides is synthesized in replicates.

Referring now to step 406 of process 400 graphically described in FIG. 4, upon maturation of the core hit peptide or core binder sequence (such that a more optimal amino acid sequence of the core hit peptide or core binder sequence is identified for binding the target of interest), the N-terminal and/or C-terminal positions undergo an extension step, whereby the length of the matured core hit peptide (also referred to as the mature core peptide binder sequence) 512 is further extended for increasing the specificity and affinity for the target of interest.

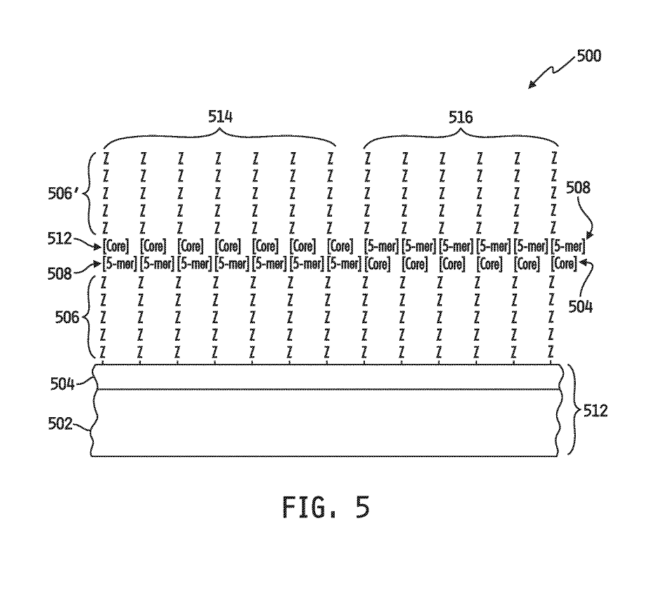

According to various embodiments of N-terminal extension of the instant disclosure, and with reference to FIG. 5, once the matured core hit peptide sequence (also referred to as the mature core peptide binder sequence) 512 is identified through the maturation process (404 of FIG. 4), each specific peptide (represented as a population of 5-mers, 308 of FIG. 3) from the peptide binder discovery step (302, FIG. 3), is added (or synthesized onto) the N-terminal end of a matured core hit peptide 512. In this manner, the most C-terminal amino acid of each peptide 308 (of the population), exemplified as a population of 5-mers in FIG. 3, is added (or synthesized) directly adjacent to the most N-terminal amino acid of the matured core hit peptide 512.

Likewise, according to various embodiments of C-terminal extension of the instant disclosure, and with reference to FIG. 5, once the matured core hit peptide 512 is identified through the maturation process (404 of FIG. 4), each specific peptide of the population (represented as a population of 5-mers, 308 of FIG. 3) from the peptide binder discovery step (302, FIG. 3), is added (or synthesized onto) the C-terminal end of a matured core hit peptide 512. In this manner, the most N-terminus amino acid of each peptide sequence 308, exemplified as a population of 5-mers in FIG. 3, is added (or synthesized) directly adjacent to the most C-terminal amino acid of the matured core hit peptide 512.

According to some embodiments of the instant disclosure (FIG. 5) one of, or both of, the matured core hit peptides used in C-terminal extension and N-terminal extension may also include one, or both of, a N-terminal and C-terminal wobble amino acid sequence (similar to as described at 306, 306′ of FIG. 3). As with the N-terminal and C-terminal wobble amino acid sequences described in FIG. 3, the N-terminal and C-terminal wobble amino acid sequences may comprise as few as 1 amino acid or as many as 15 or 20 amino acids (or more), and the N-terminal wobble amino acid sequence may be the same length as, longer than, or shorter than the C-terminal wobble amino acid sequence. Further, the N-terminal and C-terminal wobble amino acid sequences may comprise any defined group of amino acids at any given ratios (for example, glycine and serine in a 3:1 ratio).

By way of example, on FIG. 5, a peptide extension array 500 is shown, having a population of peptides for N-terminal extension 514 and a population of peptides for C-terminal extension 516. Each population of peptides 514, 516 may contain the full population of peptides 310 from peptide microarray 300 (used in the step of peptide binder discovery 404). As further illustrated, each peptide of both populations of peptides 514, 516 may contain the same matured core hit peptide 512, each with a different peptide 508 (of the population of peptides from the peptide binder discovery step 302, FIG. 3). Also shown in FIG. 5, each peptide of the populations 514, 516 includes N-terminal and C-terminal wobble amino acid sequences.

In one embodiment, an extension array 500 (including populations 514 and 516) is exposed to a concentrated, purified target of interest (as in peptide binder discovery, step 401 of process 400), whereby the target of interest may bind at any peptide (e.g., cyclic peptides) of either population 514, 516, independent of the other peptides comprising the populations 514, 516. After exposure to the target of interest, binding of the target of interest to the peptide of the populations (e.g., cyclic peptides) 514, 516 is assayed, for example, by way of exposing the complex of the individual peptides of the populations (e.g., cyclic peptides) 514, 516 and the target of interest to an antibody (specific for the target of interest) which has a reportable label (e.g., peroxidase) attached thereto (it should also be understood the target of interest may be directly labelled with a reporter molecule). Because the peptide 508 (of each 5-mer) for each location on the array, is known (e.g., a cyclic peptide), it is possible to chart/quantify/compare/contrast the sequences (and binding strengths) of the binding of the target of interest to the specific peptide (e.g., cyclic peptide) comprising the matured core hit peptide 512 with the respective peptide 508 (e.g., cyclic peptide). An exemplary method of comparing the target of interest binding to the matured core hit peptide 512-peptide 508 combination (comprising either population 514 or 516) is to review the binding strength in a principled analysis distribution-based clustering, such as described in, Standardizing and Simplifying Analysis of Peptide Library Data, Andrew D White et al, J Chem Inf Model, 2013, 53(2), pp 493-499, and illustrated herein (for example at Graphs 3 and 4). As is exemplified herein, clustering of protein binding to the respective peptides (e.g., cyclic peptides) (of populations 514, 516) shown in a principled analysis distribution-based clustering indicates peptide 5-mers 508 having overlapping peptide sequences. As demonstrated in greater detail below, from the overlapping peptide sequences (of each cluster), a mature, extended core peptide binder sequence can be identified, or at least hypothesized and constructed for further evaluation. In some embodiments of the instant application, a mature, extended core peptide binder sequence undergoes a maturation process (as described and exemplified herein and illustrated at step 404 of FIG. 4).

Additional rounds of optimization of extended peptide binders are also possible. For example, a third round of binder optimization may include extension of the sequences identified in the extension array experiments with glycine (G) amino acid. Other optimizations may include creating double substitution/deletion libraries that include all possible single and double substitution/deletion variants of the reference sequence, i.e., the peptide binder optimized and selected in any of the previous steps. In one embodiment, after or during any of the maturation and/or extension processes described herein the peptides can be cyclized.

### VI. Specificity Analysis of Mature, Extended Core Peptide Binder Sequence:

Following identification of a mature, extended core peptide binder sequence a specificity analysis may be performed by any method of measuring peptide affinity and specificity available in the art. One example of a specificity analysis includes a “Biacore™” system analysis which is used for characterizing molecules in terms of the molecule's interaction with a target of interest, the kinetic rates (of “on,” binding, and “off,” disassociation) and affinity (binding strength). Biacore™ is a trademark of General Electric Company and is available via the company website.

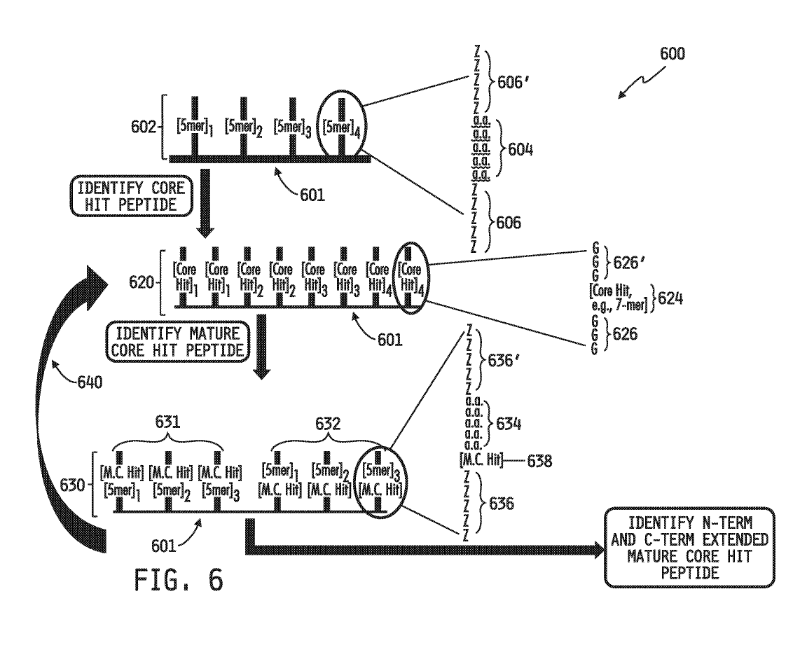

FIG. 6 is a brief schematic overview of the method of novel peptide binder identification (e.g., process 400 of FIG. 4). As shown, the peptide binder discovery 602 is performed by preparing (e.g., through maskless array synthesis) a population of peptides on a peptide microarray 601. As illustrated, each peptide includes 5 “cycles” of N-terminal wobble synthesis 606′ and C-terminal wobble synthesis 606 (e.g., both N- and C- terminal wobble synthesis comprises five amino acids). It should be understood that the wobble synthesis of the C- and N- terminal may comprise any composition as noted above (for example, only amino acids G and S, in a 3:1 [G:S] ratio). Each peptide is also shown as comprising a 5-mer peptide binder 604, which as noted above may comprise up to 2.9 million different peptide sequences such that an entire human proteome is represented. Further, it should be noted that the different peptide binders 604 may be synthesized according to specific “rules” (for example, no C or M amino acids, no repeats of the same amino acid in consecutive order, and no HPQ amino acid motifs). As described above, a target of interest (for example, in purified and concentrated form) is exposed to the peptide binders 604, and binding is scored (e.g., by way of a principled clustering analysis), whereby a “core hit peptide” sequence or core binder sequence is identified based on overlapping binding motifs.

Upon identification of a core hit peptide sequence or core binder sequence, an exhaustive maturation process 620 may be undertaken. In some embodiments, the core hit peptide or core binder sequence (exemplified as a 7-mer, 624) is synthesized on a peptide microarray 601 with both N- and C- terminal wobble (shown at step 620 as 3 cycles of N- and C-terminal wobble of only G amino acid, although the wobble amino acid may vary as noted above). In some embodiments of exhaustive maturation, a peptide is synthesized on the peptide microarray 601 wherein every amino acid position of the core hit peptide or core binder sequence 624 is substituted with each of the other 19 amino acids or a double amino acid substitution (as described above) is synthesized on the peptide microarray 601 or an amino acid deletion scan is synthesized on the peptide microarray 601, or an amino acid insertion scan is synthesized on the peptide microarray 601. In some cases, all of the above maturation processes are performed (and the repeated as described above for the new peptides generated as a result of the amino acid deletion and insertion scans). Upon synthesis of the maturation array 620 comprising the various peptides (inclusive of the substitutions, deletions and insertions described herein), the target of interest is exposed to the modified core hit peptides or core binder sequence 624 synthesized on the maturation array 620, and strength of binding is assayed, whereby a “matured core hit peptide” (mature core peptide binder sequence) is identified.

After identification of a “matured core hit peptide” sequence (mature core peptide binder sequence), one of, or both of N- and C- terminal extension may be performed (shown at 630 as including both N-terminal extension 632 and C-terminal extension 631). N-terminal and C-terminal extension involve the synthesis of matured core hit peptides (mature core peptide binder sequence) having the population of (e.g., 5-mer) peptide binders 604 synthesized at the N-terminal or C-terminal respectively. As shown at 631, C-terminal extension involves five rounds of wobble synthesis (as described above) 636 and the population of 5-mer peptide binders 634 being synthesized C-terminally of the matured core hit peptide 638, then another 5 cycles of wobble synthesis 636′ N-terminally. Similarly, as shown at 632, N-terminal extension involves five rounds of wobble synthesis (as described above) 636 being synthesized C-terminally of the matured core hit peptide (mature core peptide binder sequence) 638, then the population of 5-mer peptide binders 634 and another 5 cycles of wobble synthesis 636′ synthesized N-terminally (of the matured core hit peptide (mature core peptide binder sequence) 638). Upon synthesis of the extension array 630 comprising the various extension peptides (inclusive of C-terminal and N-terminal extension peptides), the target of interest is exposed to the C-terminal and N-terminal extension peptide populations 631, 632 synthesized on the extension array 630, and binding is scored (e.g., by way of a principled clustering analysis), whereby a C-terminally, N-terminally mature, extended core peptide binder sequence is identified. As represented by arrow 640, according to some embodiments, after the mature, extended core peptide binder sequence is identified, the maturation process 620 for the mature, extended core peptide binder sequence may be repeated (in any way as described above), and then the extension process repeated for any altered peptide resulting therefrom. In one embodiment, after or during any of the maturation and/or extension processes described herein the peptides can be cyclized as described herein.

### EXAMPLE 1

### Cyclization Between N- and C-terminus of Peptide Library

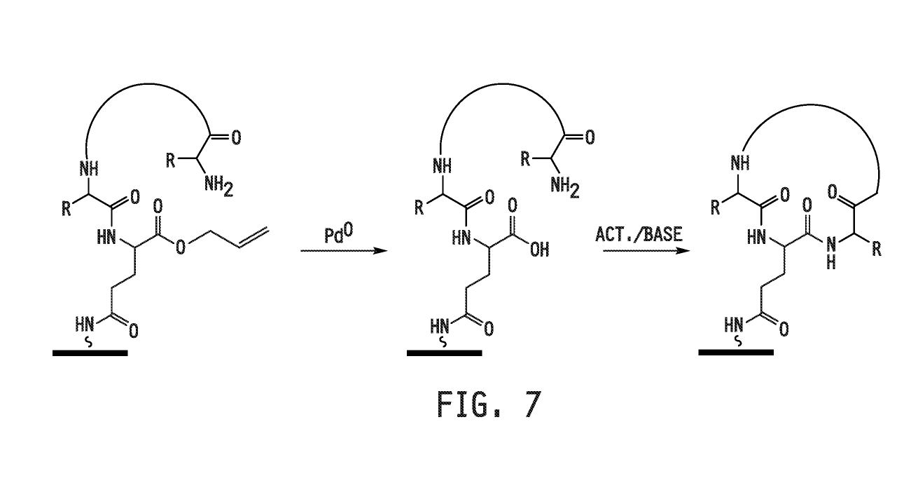

Peptide arrays were generated using maskless light-directed peptide array synthesis where all reactive amino acid side chains are protected with acid labile groups based on the methods of US 20120238477 A1, incorporated by reference herein. In this example, the microarray surface was comprised of a glass slide coated with a three-dimensional amine layer. The peptide library framework (C- to N-terminus) included a linker molecule (6-aminohexanoic acid, for example), Glu(OtBu) or Glu(OAll), and a variable peptide sequence described in the Library Design (below). Glu(OtBu) and Glu(OA11) were linked to the linker molecule through the gamma carboxylic acid of the side chain of glutamate where the C-terminus is protected with a t-Butyl ester or an allyl ester, respectively. Exemplary peptide library frameworks are shown in FIG. 7. In some embodiments, the variable peptide sequence consists of three to 15 amino acids. The N-terminus of the peptide library was a free amine. In order to cyclize the linear peptide library, the array was first treated with tetrakis(triphenylphosphine)palladium(O) (2 mM) in THF for 3 hours at room temperature to remove the OAll group from the C-terminus of the peptide library. To remove any residual palladium from the array, the slide was washed with 5% DIPEA and 5% sodium diethyldithiocarbamate in DMF for 5 minutes. The slide was washed with water for 1 minute and spun to dryness before cyclization. The array was then cyclized by coupling the N-to the C-terminus using a standard coupling procedure: slide was treated with activator (HOBt and HBTU, 20 mM each) and base (DIPEA, 2 M) for 3 hours at room temperature. The cyclized array was then side chain deprotected in trifluoroacetic acid (47.5 mL), triisopropylsilane (0.25 mL), and water (2.25 mL) for 30 min at room temperature. Following side chain deprotection, the slide was washed twice in methanol for 30 sec, four times in water for 10 seconds, 1×TBS with 0.05% tween-20 for 2 min, and then in 1×TBS for 1 minute. Finally, the slide was spun to dryness.

### EXAMPLE 2

### Cyclization of Peptide Library Using Two Cysteine Residues 5727-248051

Peptide arrays are generated using maskless light-directed peptide array synthesis where all reactive amino acid side chains are protected with acid labile groups. In this example, the microarray surface is comprised of a plastic slide coated with a three-dimensional amine layer. The peptide library framework (C- to N-terminus) consists of a linker molecule (6-aminohexanoic acid, for example), cysteine, variable peptide sequence, and cysteine. The variable peptide sequence consists of three to 15 amino acids. The N-terminus of the peptide library is a free amine. The microarray is side chain deprotected in trifluoroacetic acid (47.5 mL), triisopropylsilane (0.25), and water (2.25 mL) for 30 mM at room temperature. The slide is then washed twice in methanol for 30 sec, four times in water for 10 seconds, 1×TBS/0.05% tween 20 for 2 mM, and then in 1×TBS for 1 minute. The slide is then spun to dryness. Disulfide bridges between the two cysteines are formed under very mild conditions. The array is treated with 100 mM NH4Ac buffer (pH 8.0) containing 10% DMSO for 24 hours at room temperature. The slide is then washed with aqueous solutions and spun to dryness.

### EXAMPLE 3

### Glutamate Deprotection

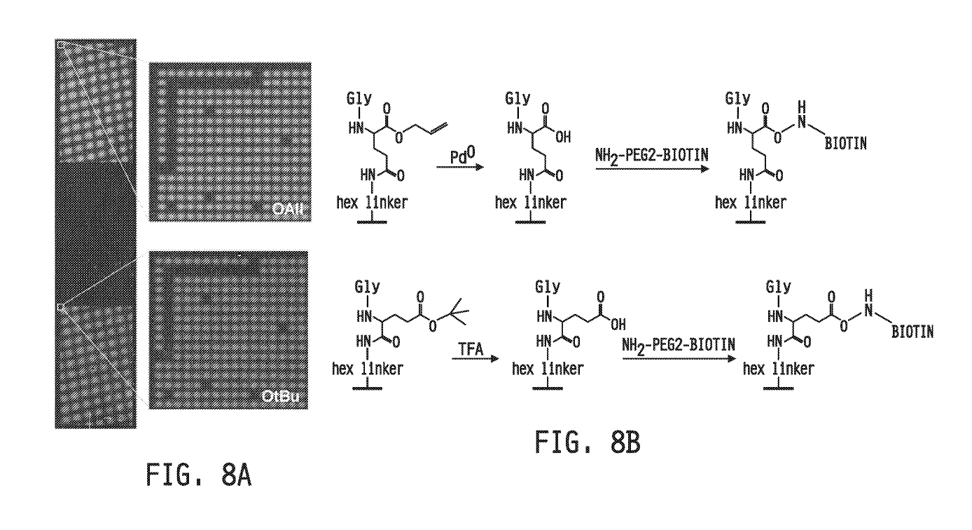

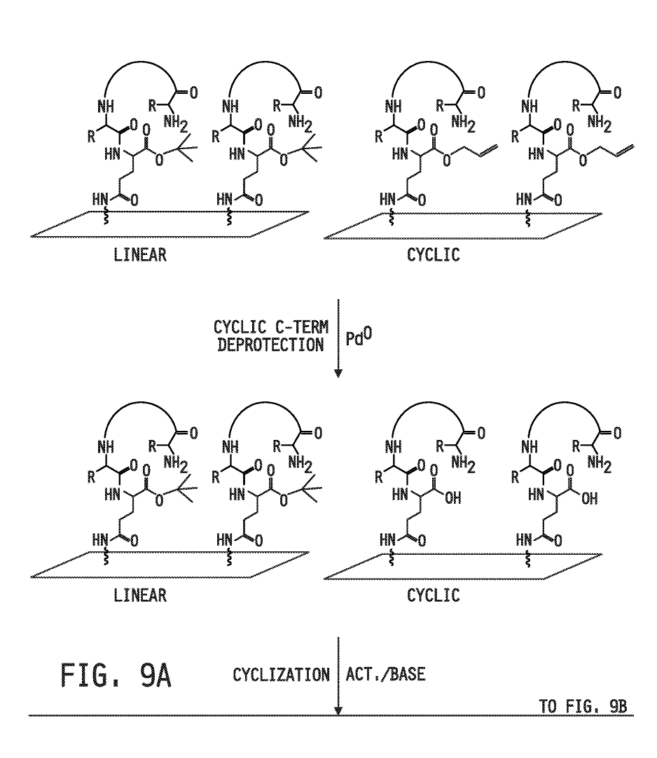

The microarray surface was comprised of a glass slide coated with a three-dimensional amine layer. Referring to FIG. 8B, to the amine substrate was coupled (C- to N-terminus) a 6-aminohexanoic acid linker molecule, a variable glutamate derivative, and glycine. The N-terminus of the peptide was free. The glutamate derivative included either a glutamate with OAll protection on the C-terminus (where the gamma carboxylic acid of the side chain is reacted to the linker, top subarray) or a glutamate with OtBu protection on the side chain carboxylic acid (the C-terminus is reacted with the linker, bottom subarray). The OtBu group was then removed by immersing the slide in a solution of trifluoroacetic acid (47.5 mL), triisopropylsilane (0.25 mL), and water (2.25 mL) for 30 min at room temperature. To remove all traces of TFA, the slide was washed twice in methanol for 30 sec, four times in water for 10 seconds, 1×TBS with 0.05% tween-20 for 2 min, and then 1×TBS for 1 minute. Finally, the slide was spun to dryness. Then, the slide was treated with tetrakis(triphenylphosphine)palladium(O) (2 mM) in THF for 3 hours at room temperature to remove the OAll groups. To remove any residual palladium from the array, the slide was washed with 5% DIPEA and 5% sodium diethyldithiocarbamate in DMF for 5 minutes. The slide was washed with water for 1 minute and spun to dryness. Following glutamate deprotection, the slide was reacted with 50 mM amine-PEG2-biotin activated with 100 mM EDC in 0.1 M MES buffer for 2 hours at room temperature. The slide was washed with wash 1 and water before being stained with streptavidin-Cy5, as detailed below.

As shown in FIG. 8A, the amine-PEG2-biotin labeled slide was the scanned for fluorescence. Both the top and bottom subarrays show consistent fluorescent intensity (2,500 and 2,000 fluorescent units for top and bottom subarrays, respectively), indicating successful removal of both the OtBu and OAll protecting groups.

### EXAMPLE 4

### Cyclic/Linear Peptide Library Synthesis

The peptide libraries described herein were generated according to the method described in FIG. 9. Peptide libraries were generated on the same microarray slide, which included a linear peptide subarray and a cyclic peptide subarray. Each of the peptides in both subarrays included a C-terminus glutamate and a free N-terminus amino group. Each glutamate side chain was attached to the array surface via a 6-aminohexanoic acid linker molecule, as described in Example 3. Each peptide the linear peptide subarray was protected at its C-terminus by an OtBu protecting group. Each peptide in the cyclic peptide subarray was protected at its C-terminus by an OAll protecting group. Otherwise, the peptides in each subarray were identical. All side chains were protected with acid labile groups based on a two stage deprotection of the C-terminus for all peptides.

Still referring to FIG. 9, first, a C-terminus deprotection step was performed to remove the OAll protecting groups from the peptides of the cyclic peptide subarray by treating the slide with palladium(O) according to the procedure described in Example 3. The resulting deprotected peptides had free C- terminus carboxyl groups. The deprotection selectively resulted in the removal of OAll protecting groups from the cyclic peptide subarray, and did not remove the OtBu protecting groups from the peptides in the linear peptide subarray or the side chain protecting groups.

Next, a cyclization step was performed to cyclize the deprotected peptides in the cyclic peptide subarray. To perform the cyclization step, the side was treated according to the conditions described in Example 1, leading to head-to-tail cyclization via amide bond formation.

After the cyclization step, a C-terminus deprotection step was performed to remove the OtBu protecting groups from the peptides of the cyclic peptide subarray by treating the slide with TFA according to the procedure described in Example 3. The resulting deprotected peptides had free C-terminus carboxyl groups.

The resulting slide included a linear peptide subarray of linear peptides and a cyclic peptide subarray of cyclized peptides and some linear peptides. Based on this method, the linear peptides in the two subarrays were structurally identical. By generating a linear peptide subarray having linear peptides identical to the peptides that failed to cyclize on the cyclic peptide subarray, the interaction of the linear peptides with the target protein was possible to detect.

### EXAMPLE 5

### Peptide Synthesis

Cyclic and linear peptides were supplied by GenScript (Piscataway, N.J.) at >95% purity. To best replicate the linkage between U and the array surface, the peptides were ordered with the side chain of glutamate (U) amidated, hence, making the amino acid a glutamine (Q). 5mM stock solutions were prepared in water using the peptide weight provided by GenScript.

### EXAMPLE 6

### Streptavidin Binding to Peptide Microarray

Slides were bound with 150 mg streptavidin-Cy5 in 30 mL binding buffer for 30 minutes at room temperature. Binding buffer contained 1% alkali soluble casein and 0.05% tween-20 in 1×TBS, pH 7.4. After 30 minutes, slides were washed twice in 1×TBS buffer for 1 minute, water for 30 seconds, and spun to dryness.

### EXAMPLE 7

### Fluorescence Scans/Data Analysis

Cy5 fluorescence intensity of the arrays was measured with MS200 scanner (Roche NimbleGen) at resolution 2 um, wavelength 635 nm, gain 25% and laser intensity 100%. Cy5 signal intensities were extracted using Image Extraction Software (Roche NimbleGen). Data pre-processing, normalization and statistical tests were done in R. Data visualization and analysis were performed with Spotfire 6.5.0 (Tibco, Boston, Mass.) software platform.

### EXAMPLE 8

### Surface Plasmon Resonance

Surface plasmon resonance (SPR) experiments were performed on a BIAcore X100 (GE Healthcare). The running buffer was HBS-EP+. To prepare a streptavidin coated chip, 100 ug/mL streptavidin in Acetate 5.0 immobilization buffer was coupled to flow cell 2 of a CM5 chip using the Amine Coupling Kit (GE Healthcare. The chip was then conditioned by flowing a solution containing 0.2 M NaCl and 10 mM NaOH in water over the prepared chip for 60 seconds. The binding affinities of the cyclic and linear peptides were measured against the prepared streptavidin chip using a multiple cycle experiment with base regeneration between each step. Here, seven prepared concentrations of peptide in HBS-EP+ buffer were flowed over the streptavidin chip for 30 seconds and then allowed to dissociate for 60 seconds. Following each peptide concentration, the streptavidin chip was regenerated by flowing 0.2 M NaCl and 10 mM NaOH in water over the chip for 30 seconds followed by a stabilization period of 120 seconds. Kinetic parameters were determined using BIAcore X100 Evaluation Software Version 2.0.1.

### EXAMPLE 9

### Random 4mer Library Design

Cyclic and linear peptides were generated according to the methods described in Examples 1, 3, and 4. All peptides in the library were of the format XXXXU, each X was an independently selected amino acid selected from a specific set of L- and D- amino acids, and U was a glutamate protected on the C-terminus with either an allyl ester (cyclic features) or t-butyl ester (linear features), as described in Example 4. The amino acids included in this design were L-Ser, L-Thr, L-Asn, L-Gln, L-Gly, L-Pro, L-Ala, L-Ile, L-Phe, L-Trp, L-Tyr, L-Val, D-Ala, D-Asn, D-Leu, D-Phe, D-Pro, D-Ser, D-Trp, and D-Tyr. As used herein, lowercase “p” in an amino acid sequence refers to D-proline.

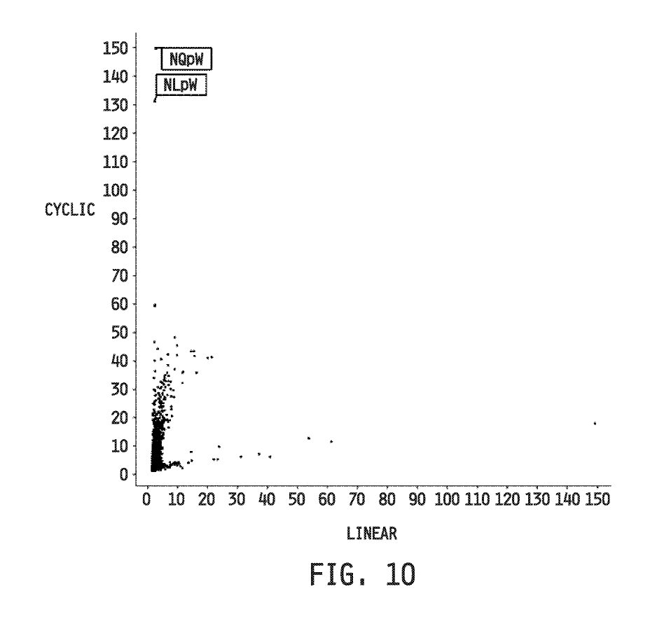

A streptavidin binding assay for peptides of the format XXXXU was performed according to the methods of Examples 6 and 7. Results are shown in FIG. 10, which is a chart showing cyclic versus linear fluorescent intensity for a peptide library of the format XXXXU bound to streptavidin-Cy5. Each point on the chart represents a unique peptide sequence. All points that fall off of the correlation line represent differential binding between the cyclic and linear conformations of the same sequence. The cylic NQpWU (SEQ ID NO: 83) peptide was identified as having the highest cyclic fluorescent intensity.

### EXAMPLE 10

### NQpWQ (SEQ ID NO: 84) SPR Results

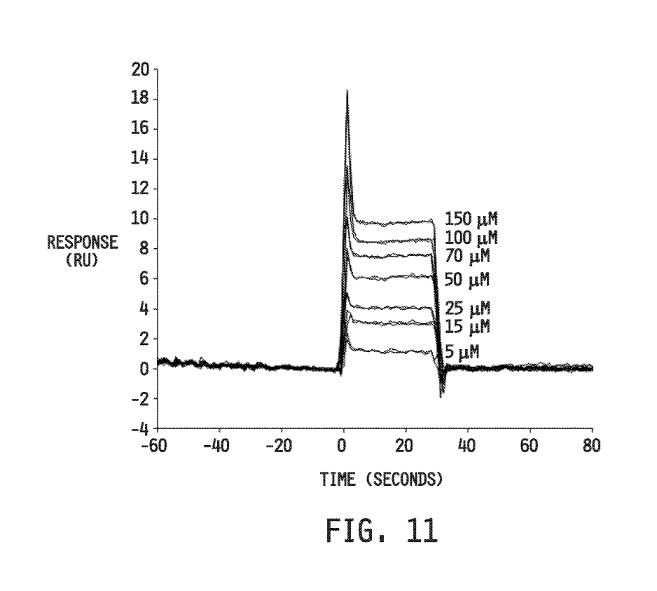

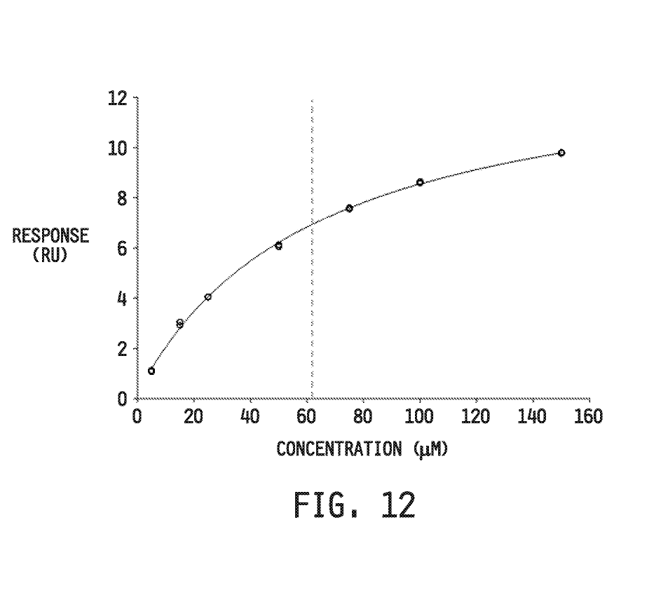

The head-to-tail cyclic NQpWQ (SEQ ID NO: 84) peptide (obtained according to Example 5) was the subject of a surface plasmon resonance (SPR) binding study according to Example 8. FIG. 11 shows surface plasmon resonance (SPR) binding curves of the head-to-tail cylic NQpWQ (SEQ ID NO: 84) peptide to a streptavidin coated CM5 BIAcore chip. FIG. 12 shows surface plasmon resonance (SPR) binding of the head-to-tail cylic NQpWQ (SEQ ID NO: 84) peptide to a streptavidin coated CM5 BIAcore chip versus peptide concentration. The dashed line indicates the binding constant.

The linear NH₂-NQpWQ-COOH (SEQ ID NO: 85) peptide (obtained according to Example 5) was also the subject to an SPR study. While the cylic NQpWQ (SEQ ID NO: 84) peptide had a binding constant (K_{D}) of 61.3 μM, the linear NH₂-NQpWQ-COOH (SEQ ID NO: 85) peptide showed no measureable binding activity (K_{D}>2000 μM). The difference in activity between the cyclic NQpWQ (SEQ ID NO: 84) peptide and the linear NH₂-NQpWQ-COOH (SEQ ID NO: 85) peptide, each prepared according to Example 5, agrees with the difference in activity between the subarrays of linear and cyclized NQpWU (SEQ ID NO: 83) peptides separately generated on the microarray according to Example 4. This result shows that the cyclization step according to Example 4 was successful.

### EXAMPLE 11

### HPQ-Specific Design Library Design

Cyclic and linear peptides were generated according to the methods described in Examples 1, 3, and 4. All peptides in the library were of the format JXXHPQXXJU (SEQ ID NO: 86), where J was a mixture of all 20 standard amino acids, each X was an independently selected amino acid, and U was a glutamate protected on the C-terminus with either an allyl ester (cyclic features) or t-butyl ester (linear features), as described in Example 4.

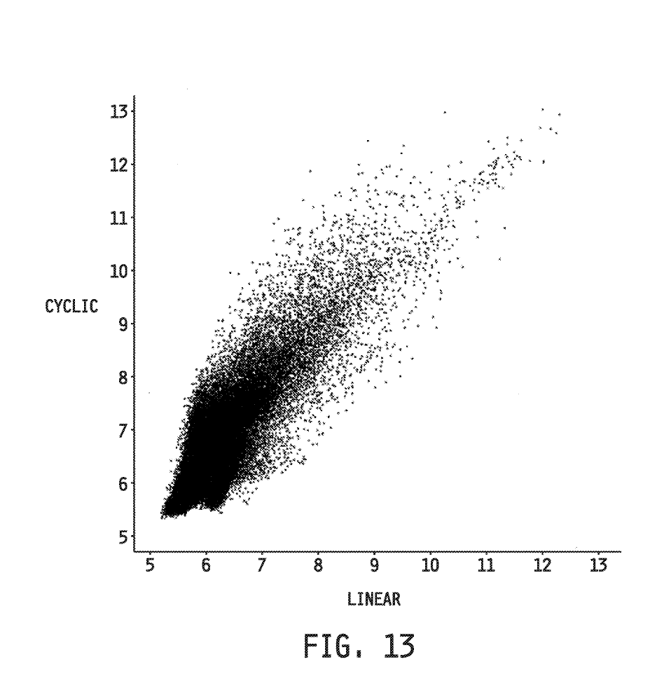

A streptavidin binding assay for peptides of the format JXXHPQXXJU (SEQ ID NO: 86) was performed according to the methods of Examples 6 and 7. Results are shown in FIG. 13, which is a chart showing cyclic versus linear fluorescent intensity for a peptide library of the format JXXHPQXXJU (SEQ ID NO: 86) bound to streptavidin-Cy5. Each point on the chart represents a unique peptide sequence. All points that fall off of the correlation line represent differential binding between the cyclic and linear conformations of the same sequence.

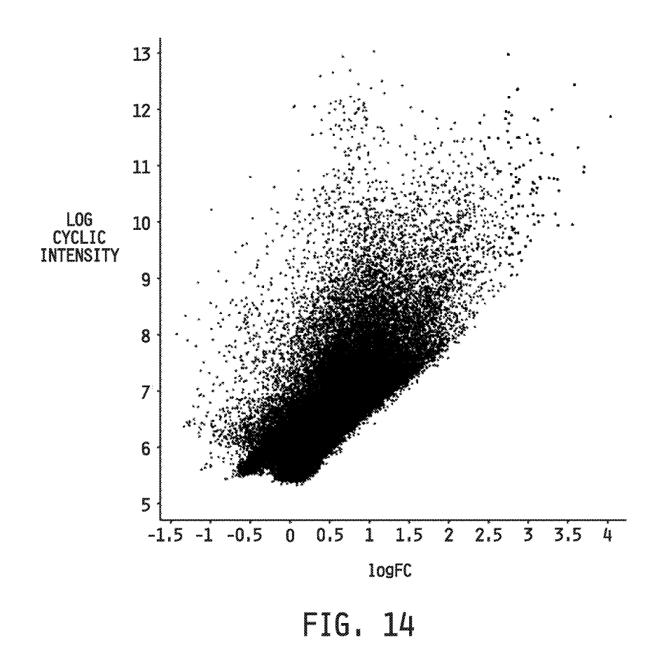

The data can also be represented for each sequence as a log fold (logFC) change between cyclic and linear fluorescent intensity. As used herein, “logFC” is the log fold change between cyclic and linear fluorescent intensity where a positive logFC indicates a preference for binding to a cyclic peptide and a negative logFC indicates a preference for binding to a linear peptide. The fluorescent intensity data for the peptide library of the format JXXHPQXXJU (SEQ ID NO: 86) are plotted as cyclic fluorescent intensity versus logFC in the chart shown as FIG. 14. Peptides that show no change between cyclic and linear features either have failed to cyclize or did not show a conformational preference. The top 100 hits for this initial HPQ-specific design are shown in Table 1.

TABLE 1
Top 100 streptavidin binding peptides for
HPQ-specific design of Example 11.

| | | | |
|---|---|---|---|
| JYDHPQNGJ (SEQ ID | JWDHPQSGJ (SEQ | JNQHPQAGJ (SEQ | JYEHPQVGJ |
| NO: 87) | ID NO: 88) | ID NO: 89) | (SEQ ID NO: 90) |
| JNDHPQNGJ (SEQ ID | JFGHPQGGJ (SEQ | JGDHPQNGJ (SEQ | JYEHPQKGJ |
| NO: 91) | ID NO: 92) | ID NO: 93) | (SEQ ID NO: 94) |
| JYDHPQGGJ (SEQ ID | JWDHPQVGJ (SEQ | JWEHPQAGJ (SEQ | JNQHPQVGJ |
| NO: 95) | ID NO: 96) | ID NO: 97) | (SEQ ID NO: 98) |
| JWDHPQNGJ (SEQ ID | JNGHPQGGJ (SEQ | JSGHPQGGJ (SEQ | JGQHPQVGJ (SEQ |
| NO: 99) | ID NO: 100) | ID NO: 101) | ID NO: 102) |
| JWQHPQVGJ (SEQ ID | JCDHPQNGJ (SEQ | JHDHPQGGJ (SEQ | JHQHPQVGJ (SEQ |
| NO: 103) | ID NO: 104) | ID NO: 105) | ID NO: 106) |
| JFDHPQNGJ (SEQ ID | JWQHPQNGJ (SEQ | JWAHPQGGJ (SEQ | JSDHPQGGJ (SEQ |
| NO: 107) | ID NO: 108) | ID NO: 109) | ID NO: 110) |
| JWDHPQGGJ (SEQ ID | JTDHPQNGJ (SEQ | JNQHPQGGJ (SEQ | JHQHPQFGJ (SEQ |
| NO: 111) | ID NO: 112) | ID NO: 113) | ID NO: 114) |
| JWDHPQAGJ (SEQ ID | JYEHPQGGJ (SEQ | JYDHPQVGJ (SEQ | JNDHPQVGJ (SEQ |
| NO: 115) | ID NO: 116) | ID NO: 117) | ID NO: 118) |
| JWEHPQGGJ (SEQ ID | JYDHPQNNJ (SEQ | JWQHPQKGJ (SEQ | JHDHPQAGJ (SEQ |
| NO: 119) | ID NO: 120) | ID NO: 121) | ID NO: 122) |
| JWDHPQKGJ (SEQ ID | JWGHPQNGJ (SEQ | JYDHPQKGJ (SEQ | JCGHPQGGJ (SEQ |
| NO: 123) | ID NO: 124) | ID NO: 125) | ID NO: 126) |
| JWDHPQRGJ (SEQ ID | JWQHPQFGJ (SEQ | JRDHPQAGJ (SEQ | JFDHPQVGJ (SEQ |
| NO: 127) | ID NO: 128) | ID NO: 129) | ID NO: 130) |
| JGGHPQGGJ (SEQ ID | JADHPQNGJ (SEQ | JWGHPQAGJ (SEQ | JFDHPQKGJ (SEQ |
| NO: 131) | ID NO: 132) | ID NO: 133) | ID NO: 134) |
| JWQHPQGGJ (SEQ ID | JQDHPQNGJ (SEQ | JWQHPQRGJ (SEQ | JPHHPQSGJ (SEQ |
| NO: 135) | ID NO: 136) | ID NO: 137) | ID NO: 138) |
| JHDHPQNGJ (SEQ ID | JNDHPQGGJ (SEQ | JHQHPQGGJ (SEQ | JNEHPQGGJ (SEQ |
| NO: 139) | ID NO: 140) | ID NO: 141) | ID NO: 142) |
| JLDHPQNGJ (SEQ ID | JYQHPQAGJ (SEQ | JFGHPQGPJ (SEQ | JFEHPQVGJ (SEQ |
| NO: 143) | ID NO: 144) | ID NO: 145) | ID NO: 146) |
| JWEHPQKGJ (SEQ ID | JFQHPQGGJ (SEQ | JFEHPQGGJ (SEQ | JTDHPQGGJ (SEQ |
| NO: 147) | ID NO: 148) | ID NO: 149) | ID NO: 150) |
| JYDHPQAGJ (SEQ ID | JWGHPQGPJ (SEQ | JFQHPQVGJ (SEQ | JSQHPQGGJ (SEQ |
| NO: 151) | ID NO: 152) | ID NO: 153) | ID NO: 154) |
| JWQHPQAGJ (SEQ ID | JFDHPQAGJ (SEQ | JQGHPQGGJ (SEQ | JWDHPQHSJ |
| NO: 155) | ID NO: 156) | ID NO: 157) | (SEQ ID NO: 158) |
| JYGHPQGGJ (SEQ ID | JWEHPQRGJ (SEQ | JWEHPQNGJ (SEQ | JHEHPQFGJ (SEQ |
| NO: 159) | ID NO: 160) | ID NO: 161) | ID NO: 162) |
| JRDHPQNGJ (SEQ ID | JWEHPQVGJ (SEQ | JQWHPQGGJ (SEQ | JYDHPQAPJ (SEQ |
| NO: 163) | ID NO: 164) | ID NO: 165) | ID NO: 166) |
| JWGHPQGGJ (SEQ ID | JHQHPQAGJ (SEQ | JNDHPQAGJ (SEQ | JGGHPQGPJ (SEQ |
| NO: 167) | ID NO: 168) | ID NO: 169) | ID NO: 170) |
| JNDHPQNNJ (SEQ ID | JFQHPQAGJ (SEQ | JYQHPQVGJ (SEQ | JHEHPQGGJ (SEQ |
| NO: 171) | ID NO: 172) | ID NO: 173) | ID NO: 174) |
| JYQHPQGGJ (SEQ ID | JWDHPQHGJ (SEQ | JFDHPQRGJ (SEQ | JHDHPQRGJ (SEQ |
| NO: 175) | ID NO: 176) | ID NO: 177) | ID NO: 178) |
| JSDHPQNGJ (SEQ ID | JYDHPQRGJ (SEQ | JDDHPQNGJ (SEQ | JWNHPQVGJ |
| NO: 179) | ID NO: 180) | ID NO: 181) | (SEQ ID NO: 182) |
| JFDHPQGGJ (SEQ ID | JYDHPQSGJ (SEQ | JNQHPQNGJ (SEQ | JPYHPQSGJ (SEQ |
| NO: 183) | ID NO: 184) | ID NO: 185) | ID NO: 186) |

### EXAMPLE 12

### Extension of HPQ-Specific Design

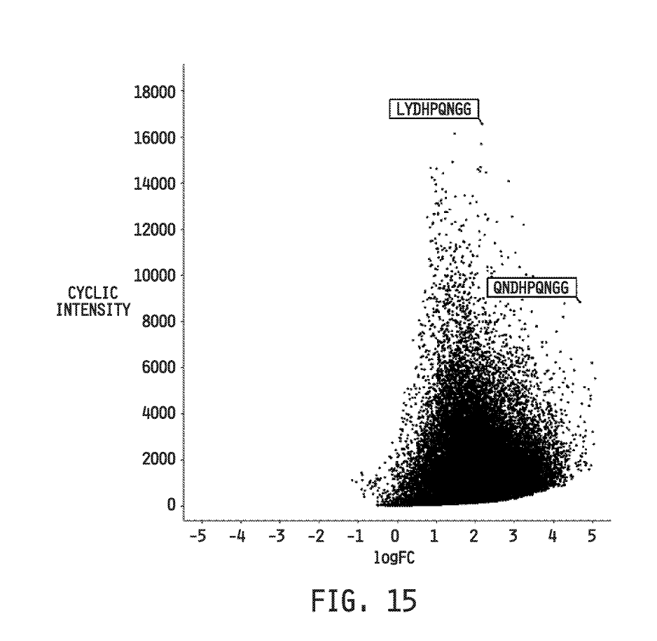

To determine which combinations of J′s flanking the XXHPQXX (SEQ ID NO: 187) sequence would yield the highest binding to streptavidin, sequences having all possible combinations of the standard 20 L-amino acids in the J positions were synthesized for the sequences shown in Table 1. A streptavidin binding assay for peptides of Table 1 was performed according to the methods of Examples 6 and 7. Results are shown in FIG. 15, which is a chart showing cyclic fluorescent intensity versus logFC. The cylic LYDHPQNGGU (SEQ ID NO: 188) peptide was identified as having the highest cyclic intensity, and the cyclic QNDHPQNGGU (SEQ ID NO: 189) petide was identified as a peptide having high cyclic intensitiy and a high logFC.

### EXAMPLE 13

### LYDHPQNGGQ (SEQ ID NO: 190) SPR Results

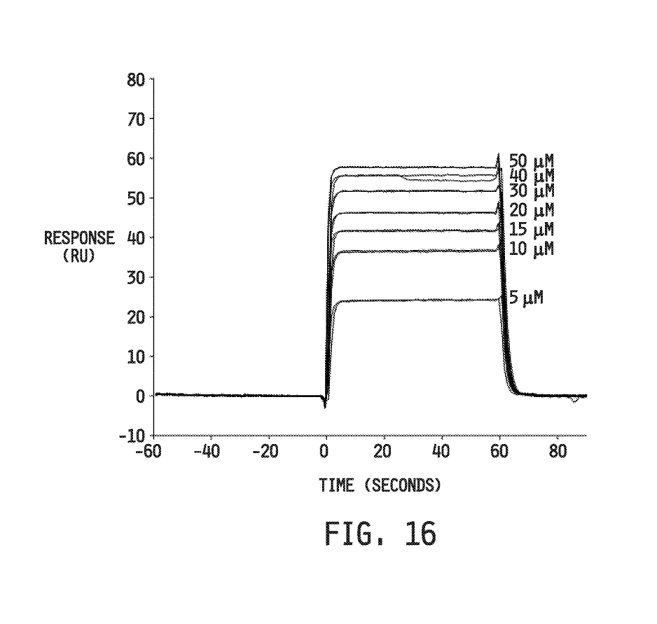

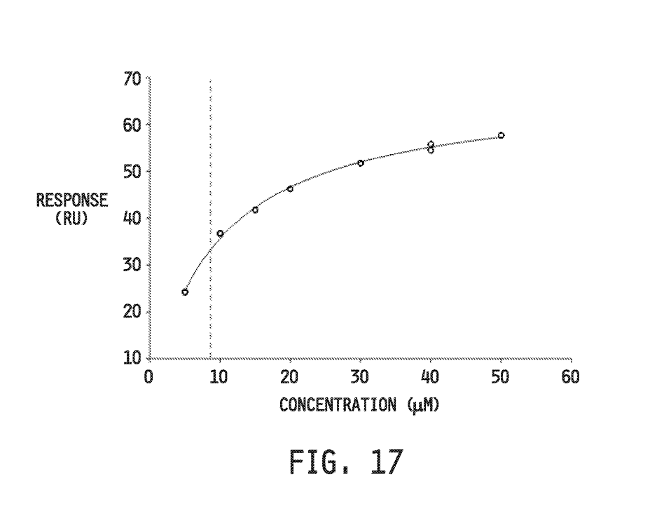

The head-to-tail cyclic LYDHPQNGGQ (SEQ ID NO: 190) peptide (obtained according to Example 5) was the subject of a surface plasmon resonance (SPR) binding study according to Example 8. FIG. 16 shows surface plasmon resonance (SPR) binding curves of the head-to-tail cylic LYDHPQNGGQ (SEQ ID NO: 190) peptide to a streptavidin coated CM5 BIAcore chip. FIG. 17 shows surface plasmon resonance (SPR) binding of the head-to-tail cylic LYDHPQNGGQ (SEQ ID NO: 190) peptide to a streptavidin coated CM5 BIAcore chip versus peptide concentration. The dashed line indicates the binding constant.

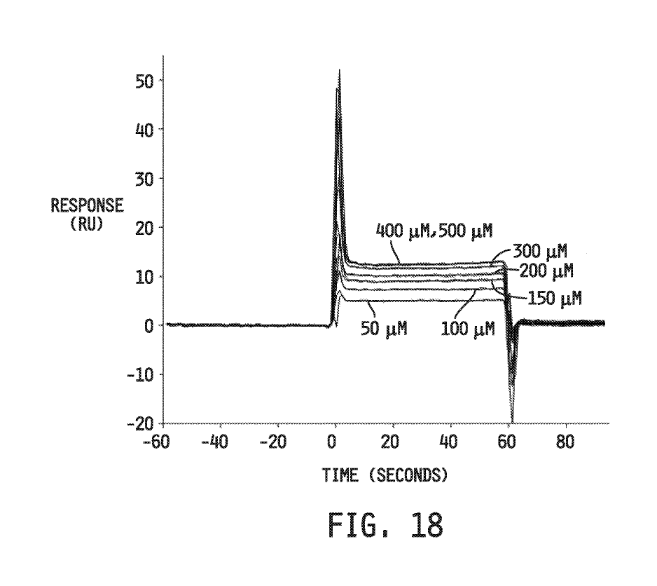

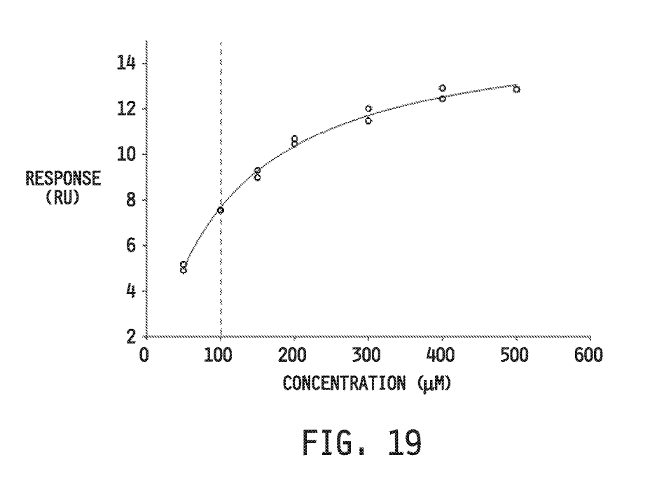

The linear NH₂-LYDHPQNGGQ-COOH (SEQ ID NO: 191) peptide (obtained according to Example 5) was also the subject to an SPR study. FIG. 18 shows surface plasmon resonance (SPR) binding curves of the linear NH₂-LYDHPQNGGQ-COOH (SEQ ID NO: 191) peptide to a streptavidin coated CM5 BIAcore chip. FIG. 19 shows surface plasmon resonance (SPR) binding of the linear NH₂-LYDHPQNGGQ-COOH (SEQ ID NO: 191) peptide to a streptavidin coated CM5 BIAcore chip versus peptide concentration. The dashed line indicates the binding constant.

While the cylic LYDHPQNGGQ (SEQ ID NO: 190) peptide had a binding constant (K_{D}) of 9.4 μM, the linear NH₂-LYDHPQNGGQ-COOH (SEQ ID NO: 191) peptide had a binding constant (K_{D}) of 100 μM. The difference in activity between the cyclic LYDHPQNGGQ (SEQ ID NO: 190) peptide and the linear NH₂-LYDHPQNGGQ-COOH (SEQ ID NO: 191) peptide, each prepared according to Example 5, agrees with the difference in activity between the subarrays of linear and cyclized LYDHPQNGGU (SEQ ID NO: 188) peptides separately generated on the microarray according to Example 4. This result shows that the cyclization step according to Example 4 was successful.

### EXAMPLE 14

### QNDHPQNGGQ (SEQ ID NO: 192) SPR Results

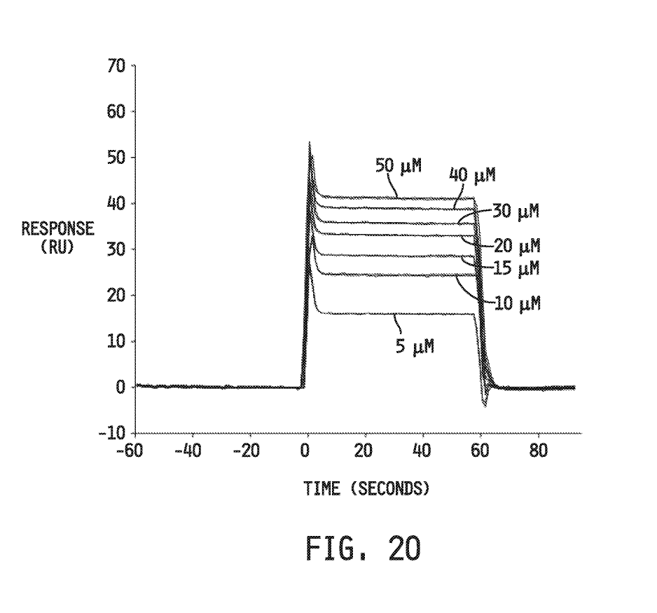

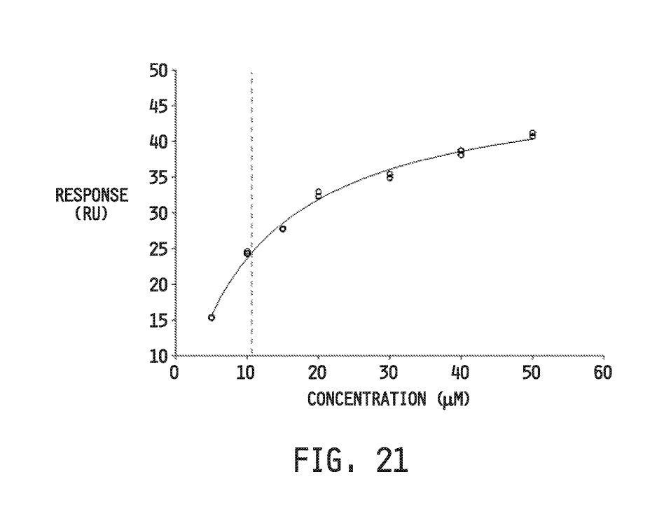

The head-to-tail cyclic QNDHPQNGGQ (SEQ ID NO: 192) peptide (obtained according to Example 5) was the subject of a surface plasmon resonance (SPR) binding study according to Example 8. FIG. 20 shows surface plasmon resonance (SPR) binding curves of the head-to-tail cylic QNDHPQNGGQ (SEQ ID NO: 192) peptide to a streptavidin coated CM5 BIAcore chip. FIG. 21 shows surface plasmon resonance (SPR) binding of the head-to-tail cylic QNDHPQNGGQ (SEQ ID NO: 192) peptide to a streptavidin coated CM5 BIAcore chip versus peptide concentration. The dashed line indicates the binding constant.

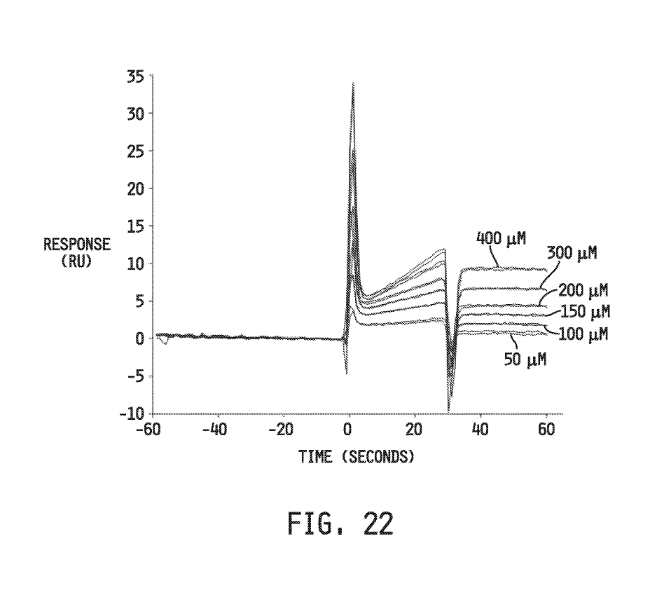

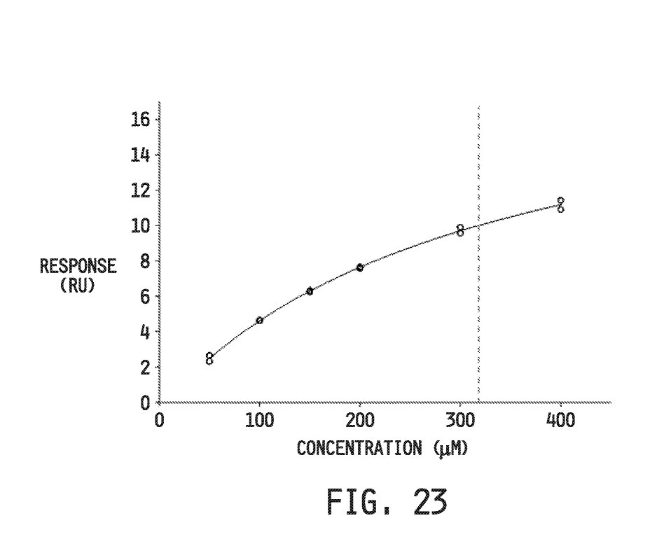

The linear NH₂-QNDHPQNGGQ-COOH (SEQ ID NO: 193) peptide (obtained according to Example 5) was also the subject to an SPR study. FIG. 22 shows surface plasmon resonance (SPR) binding curves of the linear NH₂-QNDHPQNGGQ-COOH (SEQ ID NO: 193) peptide to a streptavidin coated CM5 BIAcore chip. FIG. 23 shows surface plasmon resonance (SPR) binding of the linear NH₂-QNDHPQNGGQ-COOH (SEQ ID NO: 193) peptide to a streptavidin coated CM5 BIAcore chip versus peptide concentration. The dashed line indicates the binding constant.

While the cylic QNDHPQNGGQ (SEQ ID NO: 192) peptide had a binding constant (K_{D}) of 10.8 μM, the linear NH₂-QNDHPQNGGQ-COOH (SEQ ID NO: 193) peptide had a binding constant (K_{D}) of 320 μM. The difference in activity between the cyclic QNDHPQNGGQ (SEQ ID NO: 192) peptide and the linear NH₂-QNDHPQNGGQ-COOH (SEQ ID NO: 193) peptide, each prepared according to Example 5, agrees with the difference in activity between the subarrays of linear and cyclized QNDHPQNGGU (SEQ ID NO: 189) peptides separately generated on the microarray according to Example 4. This result shows that the cyclization step according to Example 4 was successful.

What is claimed is:

1. A peptide microarray comprising at least one cyclic peptide of formula I 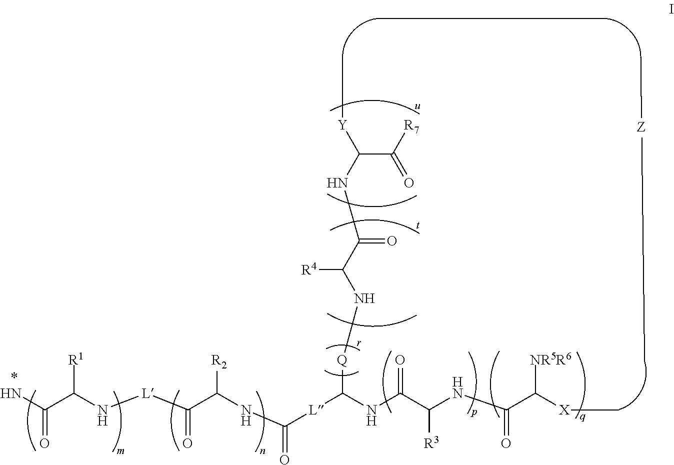
wherein each R¹, R², R³ and R⁴ is independently a natural amino acid side chain or a non-natural amino acid side chain;
each R⁵ and R⁶ is independently hydrogen or an N-terminal capping group;
each R⁷ is independently —OH or a C-terminal capping group;
Q is selected from the group consisting of a carbonyl, a natural amino acid side chain, and a non-natural amino acid side chain;
each X and Y is independently selected from the group consisting of a bond, a natural amino acid side chain covalently attached to Z, and a non-natural amino acid side chain covalently attached to Z;
Z is a group comprising a moiety selected from the group consisting of an amide bond, a disulfide bond, an isopeptide bond, a 1,2,3-triazole, and an optionally substituted 1,2-quinone;
L′ and L″ are each independently an optional bivalent linking group or a bond;
m is an integer from 0 to 6;
n is an integer from 0 to 6;
p is an integer from 0 to 100;
q is 0 or 1;
5727-248051
r is 0 or 1;
t is an integer from 0 to 100;
u is 0 or 1;
and * is a point of connection connecting the at least one cyclic peptide to a solid support having a reactive surface,
wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

2. The peptide microarray of claim 1, wherein Z comprises a moiety selected from the group consisting of an amide bond, 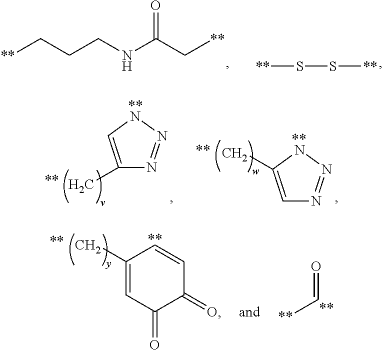
wherein v is an integer from 0 to 6, w is an integer from 0 to 6, and y is an integer from 0 to 6, and ** is a point of connection to the rest of the cyclic peptide.

3. The peptide microarray of claim 1, wherein Z comprises a peptide bond, Q is a carbonyl, q is 0, r is 1, and u is 0.

4. The peptide microarray of claim 1, wherein L′ is 6-aminohexanoic acid.

5. The peptide microarray of claim 1, wherein L″ is CH₂CH₂.

6. The peptide microarray of claim 1, wherein t is 0, and p is an integer 1 to 20.

7. The peptide microarray of claim 1, wherein the reactive surface comprises an activated amine.

8. The peptide microarray of claim 1, wherein the amino acid sequences of interest of the population of peptides comprise the same number of amino acids.

9. The peptide microarray of claim 1, wherein the amino acid sequences of interest of the population of peptides do not contain any of a methionine amino acid, a cysteine amino acid, an amino acid repeat of the same amino acid, or an amino acid motif consisting of a histidine (H)- proline (P)- glutamine (Q) sequence.

10. A method of generating a peptide microarray comprising at least one cyclic peptide of formula I 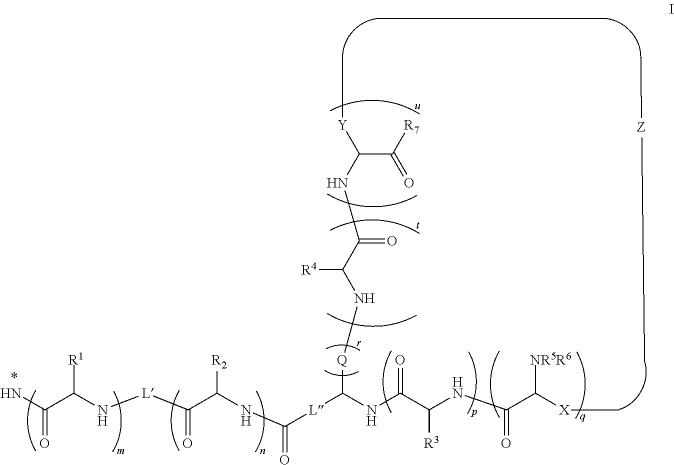
wherein each R¹, R², R³ and R⁴ is independently a natural amino acid side chain or a non-natural amino acid side chain;
each R⁵ and R⁶ is independently hydrogen or an N-terminal capping group;
each R⁷ is independently —OH or a C-terminal capping group;
Q is selected from the group consisting of a carbonyl, a natural amino acid side chain, and a non-natural amino acid side chain;
each X and Y is independently selected from the group consisting of a bond, a natural amino acid side chain covalently attached to Z, and a non-natural amino acid side chain covalently attached to Z;
Z is a group comprising a moiety selected from the group consisting of an amide bond, a disulfide bond, an isopeptide bond, a 1,2,3-triazole, and an optionally substituted 1,2-quinone;
L′ and L″ are each independently an optional bivalent linking group or a bond;
m is an integer from 0 to 6;
n is an integer from 0 to 6;
p is an integer from 0 to 100;
q is 0 or 1;
r is 0 or 1;
t is an integer from 0 to 100;
u is 0 or 1; and * is a point of connection connecting the at least one cyclic peptide to a solid support having a reactive surface;
the method comprising the step of reacting a functionalized peptide of formula II under conditions that cause Z to form 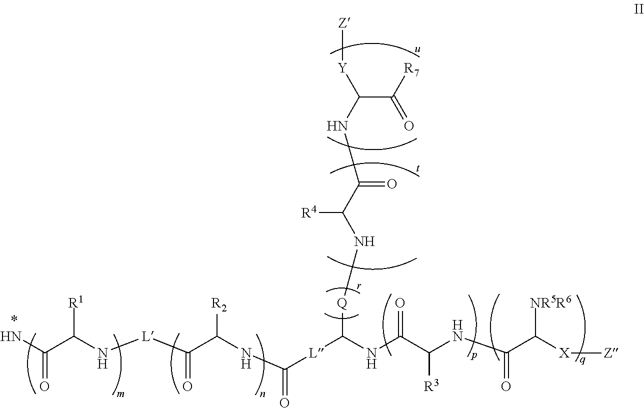
wherein R¹, R² R³, R⁴, R⁵, R⁶, Q, L′, L″, m, n, p, q, r, t, u, and * are as defined for formula I;
each R⁷ is independently selected from the group consisting of —OH, a C-terminal capping group, and 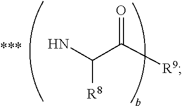
each R⁸ is independently a natural amino acid side chain or a non-natural amino acid side chain;
each R⁹ is independently —OH or a C-terminal capping group;
each X′ is independently selected from the group consisting of a bond, a natural amino acid side chain covalently attached to Z″, and a non-natural amino acid side chain covalently attached to Z″; each Y′ is independently selected from the group consisting of a bond, a natural amino acid side chain covalently attached to Z′, and a non-natural amino acid side chain covalently attached to Z′;
Z′ and Z″ are each independently selected from the group consisting of a bond, —OH, hydrogen, a thiol, an amine, a carboxylic acid, an amide, an alkyne, an azide, an optionally substituted aminophenol, a natural amino acid side chain, a non-natural amino acid side chain, an N-terminal protecting group, and a C-terminal protecting group, provided that Z′ and Z″ are complementary groups that combine to form Z;
b is an integer from 0 to 50;
and *** is a point of connection to the rest of the functionalized peptide;
wherein the at least one cyclic peptide is immobilized to the reactive surface, and wherein the at least one cyclic peptide is part of a population of peptides immobilized to the reactive surface wherein the population of peptides comprises independently selected amino acid sequences of interest.

11. The method of claim 10, wherein Z comprises a peptide bond, Z′ comprises a C-terminal protecting group or Z″ comprises an N-terminal protecting group, Q is a carbonyl, q is 0, r is 1, and u is 0.

12. The method of claim 11, further comprising removing Z′ or Z″ from the rest of the functionalized peptide to cause the peptide bond to form.

13. The method of claim 10, wherein p is an integer 1 to 20, q is 0, r is 1, t is 0, u is 0, Q is a carbonyl, and Z is an amide bond,.

14. A method of preparing a peptide microarray comprising:
generating at least one first linear peptide subarray comprising a first plurality of linear peptides covalently attached to a microarray surface;
generating at least one second linear peptide subarray comprising a second plurality of linear peptides covalently attached to the microarray surface, wherein the second plurality of linear peptides has an amino acid sequence that is identical to the first plurality of linear peptides; and treating the peptide microarray under conditions to cyclize the first plurality of linear peptides to provide at least one cyclized peptide subarray comprising a plurality of cyclized peptides, wherein the second plurality of linear peptides substantially does not cyclize.

15. The method of claim 14, wherein the first plurality of linear peptides is a first plurality of protected linear peptides, wherein the C-terminus of the first plurality of protected linear peptides is protected by a first protecting group; and
the second plurality of linear peptides is a second plurality of protected linear peptides, wherein the second plurality of protected linear peptides has an amino acid sequence that is identical to the first plurality of protected linear peptides, and wherein the C-terminus of the second plurality of protected linear peptides is protected by a second protecting group that is different from the first protecting group.

16. The method of claim 15, further comprising contacting the peptide microarray with a first deprotection reagent to selectively remove the first protecting group to provide at least one first deprotected linear peptide subarray comprising a first plurality of deprotected linear peptides; and
contacting the peptide microarray with a second deprotection reagent to remove the second protecting group to provide at least one second deprotected linear peptide subarray comprising a second plurality of deprotected linear peptides.

17. The method of claim 14, wherein the first plurality of linear peptides and the second plurality of linear peptides are each covalently attached to the microarray surface through a carboxylic acid side chain.

18. The method of claim 15, wherein the first protecting group is OAR and the first deprotection reagent is a palladium catalyst.

19. The method of claim 15, wherein the second protecting group is OtBu and the second deprotection reagent is an acid.

20. The method of claim 14, wherein treating the peptide microarray under conditions to cyclize the first plurality of linear peptides comprises activating the carboxyl group of the C-terminus of the first plurality of linear peptides to react with the amino group of the N-terminus of the first plurality of linear peptides to form an amide bond.


SEQUENCE LISTING (231 sequences)

SEQ ID NO: 1 - protein, 9 aa, Artificial Sequence
  Description of Artificial Sequence Synthetic peptide
GDYALQGPG

SEQ ID NO: 2 - protein, 11 aa, Artificial Sequence
  Description of Artificial Sequence Synthetic peptide
CGGDYALQGPG

SEQ ID NO: 3 - protein, 11 aa, Artificial Sequence
  Description of Artificial Sequence Synthetic peptide
WGGDYALQGPG

SEQ ID NO: 4 - protein, 11 aa, Artificial Sequence
  Description of Artificial Sequence Synthetic peptide
YGGDYALQGPG

SEQ ID NO: 5 - protein, 11 aa, Artificial Sequence
  Description of Artificial Sequence Synthetic peptide
DGGDYALQGPG

SEQ ID NO: 6 - protein, 11 aa, Artificial Sequence
  Description of Artificial Sequence Synthetic peptide
GDGDYALQGPG

SEQ ID NO: 7 - protein, 11 aa, Artificial Sequence
  Description of Artificial Sequence Synthetic peptide
NGGDYALQGPG

SEQ ID NO: 8 - protein, 11 aa, Artificial Sequence
  Description of Artificial Sequence Synthetic peptide
GCGDYALQGPG

SEQ ID NO: 9 - protein, 11 aa, Artificial Sequence
  Description of Artificial Sequence Synthetic peptide
EGGDYALQGPG

SEQ ID NO: 10 - protein, 11 aa, Artificial Sequence
  Description of Artificial Sequence Synthetic peptide
PGGDYALQGPG

SEQ ID NO: 11 - protein, 11 aa, Artificial Sequence
  Description of Artificial Sequence Synthetic peptide
TGGDYALQGPG

SEQ ID NO: 12 - protein, 11 aa, Artificial Sequence
  Description of Artificial Sequence Synthetic peptide
QGGDYALQGPG

SEQ ID NO: 13 - protein, 11 aa, Artificial Sequence
  Description of Artificial Sequence Synthetic peptide
IGGDYALQGPG

SEQ ID NO: 14 - protein, 11 aa, Artificial Sequence
  Description of Artificial Sequence Synthetic peptide
FGGDYALQGPG

SEQ ID NO: 15 - protein, 11 aa, Artificial Sequence
  Description of Artificial Sequence Synthetic peptide
HGGDYALQGPG

SEQ ID NO: 16 - protein, 11 aa, Artificial Sequence
  Description of Artificial Sequence Synthetic peptide
LGGDYALQGPG

SEQ ID NO: 17 - protein, 11 aa, Artificial Sequence
  Description of Artificial Sequence Synthetic peptide
VGGDYALQGPG

SEQ ID NO: 18 - protein, 11 aa, Artificial Sequence
  Description of Artificial Sequence Synthetic peptide
RGGDYALQGPG

SEQ ID NO: 19 - protein, 11 aa, Artificial Sequence
  Description of Artificial Sequence Synthetic peptide
GWGDYALQGPG

SEQ ID NO: 20 - protein, 11 aa, Artificial Sequence
  Description of Artificial Sequence Synthetic peptide
MGGDYALQGPG

SEQ ID NO: 21 - protein, 11 aa, Artificial Sequence
  Description of Artificial Sequence Synthetic peptide
SGGDYALQGPG

SEQ ID NO: 22 - protein, 11 aa, Artificial Sequence
  Description of Artificial Sequence Synthetic peptide
AGGDYALQGPG

SEQ ID NO: 23 - protein, 11 aa, Artificial Sequence
  Description of Artificial Sequence Synthetic peptide
GYGDYALQGPG

SEQ ID NO: 24 - protein, 11 aa, Artificial Sequence
  Description of Artificial Sequence Synthetic peptide
GEGDYALQGPG

SEQ ID NO: 25 - protein, 11 aa, Artificial Sequence
  Description of Artificial Sequence Synthetic peptide
GPGDYALQGPG

SEQ ID NO: 26 - protein, 11 aa, Artificial Sequence
  Description of Artificial Sequence Synthetic peptide
GHGDYALQGPG

SEQ ID NO: 27 - protein, 11 aa, Artificial Sequence
  Description of Artificial Sequence Synthetic peptide
GNGDYALQGPG

SEQ ID NO: 28 - protein, 5 aa, Artificial Sequence
  Description of Artificial Sequence Synthetic peptide
DYALQ

SEQ ID NO: 29 - protein, 11 aa, Artificial Sequence
  Description of Artificial Sequence Synthetic peptide
GGGDYALQGGG

SEQ ID NO: 30 - protein, 11 aa, Artificial Sequence
  Description of Artificial Sequence Synthetic peptide
WDGDYALQGGG

SEQ ID NO: 31 - protein, 13 aa, Artificial Sequence
  Description of Artificial Sequence Synthetic peptide
GGGGDYALQGGGG

SEQ ID NO: 32 - protein, 12 aa, Artificial Sequence
  Description of Artificial Sequence Synthetic peptide
GGGDYALQGGGG

SEQ ID NO: 33 - protein, 5 aa, Artificial Sequence
  Description of Artificial Sequence Synthetic peptide
XXLQG

SEQ ID NO: 34 - protein, 5 aa, Artificial Sequence
  Description of Artificial Sequence Synthetic peptide
DYALQ

SEQ ID NO: 35 - protein, 5 aa, Artificial Sequence
  Description of Artificial Sequence Synthetic peptide
DYVLQ

SEQ ID NO: 36 - protein, 5 aa, Artificial Sequence
  Description of Artificial Sequence Synthetic peptide
NYALQ

SEQ ID NO: 37 - protein, 5 aa, Artificial Sequence
  Description of Artificial Sequence Synthetic peptide
EYALQ

SEQ ID NO: 38 - protein, 5 aa, Artificial Sequence
  Description of Artificial Sequence Synthetic peptide
PYALQ

SEQ ID NO: 39 - protein, 5 aa, Artificial Sequence
  Description of Artificial Sequence Synthetic peptide
EYVLQ

SEQ ID NO: 40 - protein, 5 aa, Artificial Sequence
  Description of Artificial Sequence Synthetic peptide
DFALQ

SEQ ID NO: 41 - protein, 5 aa, Artificial Sequence
  Description of Artificial Sequence Synthetic peptide
FYALQ

SEQ ID NO: 42 - protein, 5 aa, Artificial Sequence
  Description of Artificial Sequence Synthetic peptide
NYVLQ

SEQ ID NO: 43 - protein, 5 aa, Artificial Sequence
  Description of Artificial Sequence Synthetic peptide
RYALQ

SEQ ID NO: 44 - protein, 5 aa, Artificial Sequence
  Description of Artificial Sequence Synthetic peptide
YFALQ

SEQ ID NO: 45 - protein, 5 aa, Artificial Sequence
  Description of Artificial Sequence Synthetic peptide
PYVLQ

SEQ ID NO: 46 - protein, 5 aa, Artificial Sequence
  Description of Artificial Sequence Synthetic peptide
WYALQ

SEQ ID NO: 47 - protein, 5 aa, Artificial Sequence
  Description of Artificial Sequence Synthetic peptide
SYALQ

SEQ ID NO: 48 - protein, 5 aa, Artificial Sequence
  Description of Artificial Sequence Synthetic peptide
HYALQ

SEQ ID NO: 49 - protein, 5 aa, Artificial Sequence
  Description of Artificial Sequence Synthetic peptide
EFALQ

SEQ ID NO: 50 - protein, 5 aa, Artificial Sequence
  Description of Artificial Sequence Synthetic peptide
NFVLQ

SEQ ID NO: 51 - protein, 5 aa, Artificial Sequence
  Description of Artificial Sequence Synthetic peptide
DYFLQ

SEQ ID NO: 52 - protein, 5 aa, Artificial Sequence
  Description of Artificial Sequence Synthetic peptide
EYVAQ

SEQ ID NO: 53 - protein, 5 aa, Artificial Sequence
  Description of Artificial Sequence Synthetic peptide
DYVAQ

SEQ ID NO: 54 - protein, 5 aa, Artificial Sequence
  Description of Artificial Sequence Synthetic peptide
DFYLQ

SEQ ID NO: 55 - protein, 5 aa, Artificial Sequence
  Description of Artificial Sequence Synthetic peptide
EYFLQ

SEQ ID NO: 56 - protein, 4 aa, Artificial Sequence
  Description of Artificial Sequence Synthetic peptide
SKXK

SEQ ID NO: 57 - protein, 4 aa, Artificial Sequence
  Description of Artificial Sequence Synthetic peptide
XXKL

SEQ ID NO: 58 - protein, 5 aa, Artificial Sequence
  Description of Artificial Sequence Synthetic peptide
ARSKL

SEQ ID NO: 59 - protein, 5 aa, Artificial Sequence
  Description of Artificial Sequence Synthetic peptide
KSKLA

SEQ ID NO: 60 - protein, 5 aa, Artificial Sequence
  Description of Artificial Sequence Synthetic peptide
TKSKL

SEQ ID NO: 61 - protein, 5 aa, Artificial Sequence
  Description of Artificial Sequence Synthetic peptide
KLSKL

SEQ ID NO: 62 - protein, 5 aa, Artificial Sequence
  Description of Artificial Sequence Synthetic peptide
RSKLG

SEQ ID NO: 63 - protein, 5 aa, Artificial Sequence
  Description of Artificial Sequence Synthetic peptide
RGSKL

SEQ ID NO: 64 - protein, 5 aa, Artificial Sequence
  Description of Artificial Sequence Synthetic peptide
RSKSK

SEQ ID NO: 65 - protein, 5 aa, Artificial Sequence
  Description of Artificial Sequence Synthetic peptide
SKSKL

SEQ ID NO: 66 - protein, 5 aa, Artificial Sequence
  Description of Artificial Sequence Synthetic peptide
PKTKL

SEQ ID NO: 67 - protein, 5 aa, Artificial Sequence
  Description of Artificial Sequence Synthetic peptide
RSKLA

SEQ ID NO: 68 - protein, 5 aa, Artificial Sequence
  Description of Artificial Sequence Synthetic peptide
GRSKL

SEQ ID NO: 69 - protein, 5 aa, Artificial Sequence
  Description of Artificial Sequence Synthetic peptide
SKLSK

SEQ ID NO: 70 - protein, 5 aa, Artificial Sequence
  Description of Artificial Sequence Synthetic peptide
FTKSK

SEQ ID NO: 71 - protein, 5 aa, Artificial Sequence
  Description of Artificial Sequence Synthetic peptide
RLKSK

SEQ ID NO: 72 - protein, 5 aa, Artificial Sequence
  Description of Artificial Sequence Synthetic peptide
KLGAK

SEQ ID NO: 73 - protein, 5 aa, Artificial Sequence
  Description of Artificial Sequence Synthetic peptide
QRSKL

SEQ ID NO: 74 - protein, 5 aa, Artificial Sequence
  Description of Artificial Sequence Synthetic peptide
LSKLK

SEQ ID NO: 75 - protein, 5 aa, Artificial Sequence
  Description of Artificial Sequence Synthetic peptide
NRTKL

SEQ ID NO: 76 - protein, 5 aa, Artificial Sequence
  Description of Artificial Sequence Synthetic peptide
QRTKL

SEQ ID NO: 77 - protein, 11 aa, Artificial Sequence
  Description of Artificial Sequence Synthetic peptide
GGGRSKLAGGG

SEQ ID NO: 78 - protein, 12 aa, Artificial Sequence
  Description of Artificial Sequence Synthetic peptide
GGGARSKLGGGG

SEQ ID NO: 79 - protein, 4 aa, Artificial Sequence
  Description of Artificial Sequence Synthetic peptide
XXLQ

SEQ ID NO: 80 - protein, 4 aa, Artificial Sequence
  Description of Artificial Sequence Synthetic peptide
XVAQ

SEQ ID NO: 81 - protein, 3 aa, Artificial Sequence
  Description of Artificial Sequence Synthetic peptide
KXK

SEQ ID NO: 82 - protein, 3 aa, Artificial Sequence
  Description of Artificial Sequence Synthetic peptide
TKL

SEQ ID NO: 83 - protein, 5 aa, Artificial Sequence
  Description of Artificial Sequence Synthetic peptide
NQPWE

SEQ ID NO: 84 - protein, 5 aa, Artificial Sequence
  Description of Artificial Sequence Synthetic peptide
NQPWQ

SEQ ID NO: 85 - protein, 5 aa, Artificial Sequence
  Description of Artificial Sequence Synthetic peptide
NQPWQ

SEQ ID NO: 86 - protein, 10 aa, Artificial Sequence
  Description of Artificial Sequence Synthetic peptide
XXXHPQXXXE

SEQ ID NO: 87 - protein, 9 aa, Artificial Sequence
  Description of Artificial Sequence Synthetic peptide
XYDHPQNGX

SEQ ID NO: 88 - protein, 9 aa, Artificial Sequence
  Description of Artificial Sequence Synthetic peptide
XWDHPQSGX

SEQ ID NO: 89 - protein, 9 aa, Artificial Sequence
  Description of Artificial Sequence Synthetic peptide
XNQHPQAGX

SEQ ID NO: 90 - protein, 9 aa, Artificial Sequence
  Description of Artificial Sequence Synthetic peptide
XYEHPQVGX

SEQ ID NO: 91 - protein, 9 aa, Artificial Sequence
  Description of Artificial Sequence Synthetic peptide
XNDHPQNGX

SEQ ID NO: 92 - protein, 9 aa, Artificial Sequence
  Description of Artificial Sequence Synthetic peptide
XFGHPQGGX

SEQ ID NO: 93 - protein, 9 aa, Artificial Sequence
  Description of Artificial Sequence Synthetic peptide
XGDHPQNGX

SEQ ID NO: 94 - protein, 9 aa, Artificial Sequence
  Description of Artificial Sequence Synthetic peptide
XYEHPQKGX

SEQ ID NO: 95 - protein, 9 aa, Artificial Sequence
  Description of Artificial Sequence Synthetic peptide
XYDHPQGGX

SEQ ID NO: 96 - protein, 9 aa, Artificial Sequence
  Description of Artificial Sequence Synthetic peptide
XWDHPQVGX

SEQ ID NO: 97 - protein, 9 aa, Artificial Sequence
  Description of Artificial Sequence Synthetic peptide
XWEHPQAGX

SEQ ID NO: 98 - protein, 9 aa, Artificial Sequence
  Description of Artificial Sequence Synthetic peptide
XNQHPQVGX

SEQ ID NO: 99 - protein, 9 aa, Artificial Sequence
  Description of Artificial Sequence Synthetic peptide
XWDHPQNGX

SEQ ID NO: 100 - protein, 9 aa, Artificial Sequence
  Description of Artificial Sequence Synthetic peptide
XNGHPQGGX

SEQ ID NO: 101 - protein, 9 aa, Artificial Sequence
  Description of Artificial Sequence Synthetic peptide
XSGHPQGGX

SEQ ID NO: 102 - protein, 9 aa, Artificial Sequence
  Description of Artificial Sequence Synthetic peptide
XGQHPQVGX

SEQ ID NO: 103 - protein, 9 aa, Artificial Sequence
  Description of Artificial Sequence Synthetic peptide
XWQHPQVGX

SEQ ID NO: 104 - protein, 9 aa, Artificial Sequence
  Description of Artificial Sequence Synthetic peptide
XCDHPQNGX

SEQ ID NO: 105 - protein, 9 aa, Artificial Sequence
  Description of Artificial Sequence Synthetic peptide
XHDHPQGGX

SEQ ID NO: 106 - protein, 9 aa, Artificial Sequence
  Description of Artificial Sequence Synthetic peptide
XHQHPQVGX

SEQ ID NO: 107 - protein, 9 aa, Artificial Sequence
  Description of Artificial Sequence Synthetic peptide
XFDHPQNGX

SEQ ID NO: 108 - protein, 9 aa, Artificial Sequence
  Description of Artificial Sequence Synthetic peptide
XWQHPQNGX

SEQ ID NO: 109 - protein, 9 aa, Artificial Sequence
  Description of Artificial Sequence Synthetic peptide
XWAHPQGGX

SEQ ID NO: 110 - protein, 9 aa, Artificial Sequence
  Description of Artificial Sequence Synthetic peptide
XSDHPQGGX

SEQ ID NO: 111 - protein, 9 aa, Artificial Sequence
  Description of Artificial Sequence Synthetic peptide
XWDHPQGGX

SEQ ID NO: 112 - protein, 9 aa, Artificial Sequence
  Description of Artificial Sequence Synthetic peptide
XTDHPQNGX

SEQ ID NO: 113 - protein, 9 aa, Artificial Sequence
  Description of Artificial Sequence Synthetic peptide
XNQHPQGGX

SEQ ID NO: 114 - protein, 9 aa, Artificial Sequence
  Description of Artificial Sequence Synthetic peptide
XHQHPQFGX

SEQ ID NO: 115 - protein, 9 aa, Artificial Sequence
  Description of Artificial Sequence Synthetic peptide
XWDHPQAGX

SEQ ID NO: 116 - protein, 9 aa, Artificial Sequence
  Description of Artificial Sequence Synthetic peptide
XYEHPQGGX

SEQ ID NO: 117 - protein, 9 aa, Artificial Sequence
  Description of Artificial Sequence Synthetic peptide
XYDHPQVGX

SEQ ID NO: 118 - protein, 9 aa, Artificial Sequence
  Description of Artificial Sequence Synthetic peptide
XNDHPQVGX

SEQ ID NO: 119 - protein, 9 aa, Artificial Sequence
  Description of Artificial Sequence Synthetic peptide
XWEHPQGGX

SEQ ID NO: 120 - protein, 9 aa, Artificial Sequence
  Description of Artificial Sequence Synthetic peptide
XYDHPQNNX

SEQ ID NO: 121 - protein, 9 aa, Artificial Sequence
  Description of Artificial Sequence Synthetic peptide
XWQHPQKGX

SEQ ID NO: 122 - protein, 9 aa, Artificial Sequence
  Description of Artificial Sequence Synthetic peptide
XHDHPQAGX

SEQ ID NO: 123 - protein, 9 aa, Artificial Sequence
  Description of Artificial Sequence Synthetic peptide
XWDHPQKGX

SEQ ID NO: 124 - protein, 9 aa, Artificial Sequence
  Description of Artificial Sequence Synthetic peptide
XWGHPQNGX

SEQ ID NO: 125 - protein, 9 aa, Artificial Sequence
  Description of Artificial Sequence Synthetic peptide
XYDHPQKGX

SEQ ID NO: 126 - protein, 9 aa, Artificial Sequence
  Description of Artificial Sequence Synthetic peptide
XCGHPQGGX

SEQ ID NO: 127 - protein, 9 aa, Artificial Sequence
  Description of Artificial Sequence Synthetic peptide
XWDHPQRGX

SEQ ID NO: 128 - protein, 9 aa, Artificial Sequence
  Description of Artificial Sequence Synthetic peptide
XWQHPQFGX

SEQ ID NO: 129 - protein, 9 aa, Artificial Sequence
  Description of Artificial Sequence Synthetic peptide
XRDHPQAGX

SEQ ID NO: 130 - protein, 9 aa, Artificial Sequence
  Description of Artificial Sequence Synthetic peptide
XFDHPQVGX

SEQ ID NO: 131 - protein, 9 aa, Artificial Sequence
  Description of Artificial Sequence Synthetic peptide
XGGHPQGGX

SEQ ID NO: 132 - protein, 9 aa, Artificial Sequence
  Description of Artificial Sequence Synthetic peptide
XADHPQNGX

SEQ ID NO: 133 - protein, 9 aa, Artificial Sequence
  Description of Artificial Sequence Synthetic peptide
XWGHPQAGX

SEQ ID NO: 134 - protein, 9 aa, Artificial Sequence
  Description of Artificial Sequence Synthetic peptide
XFDHPQKGX

SEQ ID NO: 135 - protein, 9 aa, Artificial Sequence
  Description of Artificial Sequence Synthetic peptide
XWQHPQGGX

SEQ ID NO: 136 - protein, 9 aa, Artificial Sequence
  Description of Artificial Sequence Synthetic peptide
XQDHPQNGX

SEQ ID NO: 137 - protein, 9 aa, Artificial Sequence
  Description of Artificial Sequence Synthetic peptide
XWQHPQRGX

SEQ ID NO: 138 - protein, 9 aa, Artificial Sequence
  Description of Artificial Sequence Synthetic peptide
XPHHPQSGX

SEQ ID NO: 139 - protein, 9 aa, Artificial Sequence
  Description of Artificial Sequence Synthetic peptide
XHDHPQNGX

SEQ ID NO: 140 - protein, 9 aa, Artificial Sequence
  Description of Artificial Sequence Synthetic peptide
XNDHPQGGX

SEQ ID NO: 141 - protein, 9 aa, Artificial Sequence
  Description of Artificial Sequence Synthetic peptide
XHQHPQGGX

SEQ ID NO: 142 - protein, 9 aa, Artificial Sequence
  Description of Artificial Sequence Synthetic peptide
XNEHPQGGX

SEQ ID NO: 143 - protein, 9 aa, Artificial Sequence
  Description of Artificial Sequence Synthetic peptide
XLDHPQNGX

SEQ ID NO: 144 - protein, 9 aa, Artificial Sequence
  Description of Artificial Sequence Synthetic peptide
XYQHPQAGX

SEQ ID NO: 145 - protein, 9 aa, Artificial Sequence
  Description of Artificial Sequence Synthetic peptide
XFGHPQGPX

SEQ ID NO: 146 - protein, 9 aa, Artificial Sequence
  Description of Artificial Sequence Synthetic peptide
XFEHPQVGX

SEQ ID NO: 147 - protein, 9 aa, Artificial Sequence
  Description of Artificial Sequence Synthetic peptide
XWEHPQKGX

SEQ ID NO: 148 - protein, 9 aa, Artificial Sequence
  Description of Artificial Sequence Synthetic peptide
XFQHPQGGX

SEQ ID NO: 149 - protein, 9 aa, Artificial Sequence
  Description of Artificial Sequence Synthetic peptide
XFEHPQGGX

SEQ ID NO: 150 - protein, 9 aa, Artificial Sequence
  Description of Artificial Sequence Synthetic peptide
XTDHPQGGX

SEQ ID NO: 151 - protein, 9 aa, Artificial Sequence
  Description of Artificial Sequence Synthetic peptide
XYDHPQAGX

SEQ ID NO: 152 - protein, 9 aa, Artificial Sequence
  Description of Artificial Sequence Synthetic peptide
XWGHPQGPX

SEQ ID NO: 153 - protein, 9 aa, Artificial Sequence
  Description of Artificial Sequence Synthetic peptide
XFQHPQVGX

SEQ ID NO: 154 - protein, 9 aa, Artificial Sequence
  Description of Artificial Sequence Synthetic peptide
XSQHPQGGX

SEQ ID NO: 155 - protein, 9 aa, Artificial Sequence
  Description of Artificial Sequence Synthetic peptide
XWQHPQAGX

SEQ ID NO: 156 - protein, 9 aa, Artificial Sequence
  Description of Artificial Sequence Synthetic peptide
XFDHPQAGX

SEQ ID NO: 157 - protein, 9 aa, Artificial Sequence
  Description of Artificial Sequence Synthetic peptide
XQGHPQGGX

SEQ ID NO: 158 - protein, 9 aa, Artificial Sequence
  Description of Artificial Sequence Synthetic peptide
XWDHPQHSX

SEQ ID NO: 159 - protein, 9 aa, Artificial Sequence
  Description of Artificial Sequence Synthetic peptide
XYGHPQGGX

SEQ ID NO: 160 - protein, 9 aa, Artificial Sequence
  Description of Artificial Sequence Synthetic peptide
XWEHPQRGX

SEQ ID NO: 161 - protein, 9 aa, Artificial Sequence
  Description of Artificial Sequence Synthetic peptide
XWEHPQNGX

SEQ ID NO: 162 - protein, 9 aa, Artificial Sequence
  Description of Artificial Sequence Synthetic peptide
XHEHPQFGX

SEQ ID NO: 163 - protein, 9 aa, Artificial Sequence
  Description of Artificial Sequence Synthetic peptide
XRDHPQNGX

SEQ ID NO: 164 - protein, 9 aa, Artificial Sequence
  Description of Artificial Sequence Synthetic peptide
XWEHPQVGX

SEQ ID NO: 165 - protein, 9 aa, Artificial Sequence
  Description of Artificial Sequence Synthetic peptide
XQWHPQGGX

SEQ ID NO: 166 - protein, 9 aa, Artificial Sequence
  Description of Artificial Sequence Synthetic peptide
XYDHPQAPX

SEQ ID NO: 167 - protein, 9 aa, Artificial Sequence
  Description of Artificial Sequence Synthetic peptide
XWGHPQGGX

SEQ ID NO: 168 - protein, 9 aa, Artificial Sequence
  Description of Artificial Sequence Synthetic peptide
XHQHPQAGX

SEQ ID NO: 169 - protein, 9 aa, Artificial Sequence
  Description of Artificial Sequence Synthetic peptide
XNDHPQAGX

SEQ ID NO: 170 - protein, 9 aa, Artificial Sequence
  Description of Artificial Sequence Synthetic peptide
XGGHPQGPX

SEQ ID NO: 171 - protein, 9 aa, Artificial Sequence
  Description of Artificial Sequence Synthetic peptide
XNDHPQNNX

SEQ ID NO: 172 - protein, 9 aa, Artificial Sequence
  Description of Artificial Sequence Synthetic peptide
XFQHPQAGX

SEQ ID NO: 173 - protein, 9 aa, Artificial Sequence
  Description of Artificial Sequence Synthetic peptide
XYQHPQVGX

SEQ ID NO: 174 - protein, 9 aa, Artificial Sequence
  Description of Artificial Sequence Synthetic peptide
XHEHPQGGX

SEQ ID NO: 175 - protein, 9 aa, Artificial Sequence
  Description of Artificial Sequence Synthetic peptide
XYQHPQGGX

SEQ ID NO: 176 - protein, 9 aa, Artificial Sequence
  Description of Artificial Sequence Synthetic peptide
XWDHPQHGX

SEQ ID NO: 177 - protein, 9 aa, Artificial Sequence
  Description of Artificial Sequence Synthetic peptide
XFDHPQRGX

SEQ ID NO: 178 - protein, 9 aa, Artificial Sequence
  Description of Artificial Sequence Synthetic peptide
XHDHPQRGX

SEQ ID NO: 179 - protein, 9 aa, Artificial Sequence
  Description of Artificial Sequence Synthetic peptide
XSDHPQNGX

SEQ ID NO: 180 - protein, 9 aa, Artificial Sequence
  Description of Artificial Sequence Synthetic peptide
XYDHPQRGX

SEQ ID NO: 181 - protein, 9 aa, Artificial Sequence
  Description of Artificial Sequence Synthetic peptide
XDDHPQNGX

SEQ ID NO: 182 - protein, 9 aa, Artificial Sequence
  Description of Artificial Sequence Synthetic peptide
XWNHPQVGX

SEQ ID NO: 183 - protein, 9 aa, Artificial Sequence
  Description of Artificial Sequence Synthetic peptide
XFDHPQGGX

SEQ ID NO: 184 - protein, 9 aa, Artificial Sequence
  Description of Artificial Sequence Synthetic peptide
XYDHPQSGX

SEQ ID NO: 185 - protein, 9 aa, Artificial Sequence
  Description of Artificial Sequence Synthetic peptide
XNQHPQNGX

SEQ ID NO: 186 - protein, 9 aa, Artificial Sequence
  Description of Artificial Sequence Synthetic peptide
XPYHPQSGX

SEQ ID NO: 187 - protein, 7 aa, Artificial Sequence
  Description of Artificial Sequence Synthetic peptide
XXHPQXX

SEQ ID NO: 188 - protein, 10 aa, Artificial Sequence
  Description of Artificial Sequence Synthetic peptide
LYDHPQNGGE

SEQ ID NO: 189 - protein, 10 aa, Artificial Sequence
  Description of Artificial Sequence Synthetic peptide
QNDHPQNGGE

SEQ ID NO: 190 - protein, 10 aa, Artificial Sequence
  Description of Artificial Sequence Synthetic peptide
LYDHPQNGGQ

SEQ ID NO: 191 - protein, 10 aa, Artificial Sequence
  Description of Artificial Sequence Synthetic peptide
LYDHPQNGGQ

SEQ ID NO: 192 - protein, 10 aa, Artificial Sequence
  Description of Artificial Sequence Synthetic peptide
QNDHPQNGGQ

SEQ ID NO: 193 - protein, 10 aa, Artificial Sequence
  Description of Artificial Sequence Synthetic peptide
QNDHPQNGGQ

SEQ ID NO: 194 - protein, 10 aa, Artificial Sequence
  Description of Artificial Sequence Synthetic peptide
XXXXALQXYD

SEQ ID NO: 195 - protein, 5 aa, Artificial Sequence
  Description of Artificial Sequence Synthetic peptide
RSKLG

SEQ ID NO: 196 - protein, 5 aa, Artificial Sequence
  Description of Artificial Sequence Synthetic peptide
RGTKL

SEQ ID NO: 197 - protein, 5 aa, Artificial Sequence
  Description of Artificial Sequence Synthetic peptide
FPKLK

SEQ ID NO: 198 - protein, 5 aa, Artificial Sequence
  Description of Artificial Sequence Synthetic peptide
KLKYK

SEQ ID NO: 199 - protein, 5 aa, Artificial Sequence
  Description of Artificial Sequence Synthetic peptide
RAKYK

SEQ ID NO: 200 - protein, 5 aa, Artificial Sequence
  Description of Artificial Sequence Synthetic peptide
KTKYK

SEQ ID NO: 201 - protein, 5 aa, Artificial Sequence
  Description of Artificial Sequence Synthetic peptide
GYKLK

SEQ ID NO: 202 - protein, 5 aa, Artificial Sequence
  Description of Artificial Sequence Synthetic peptide
MMMMM

SEQ ID NO: 203 - protein, 5 aa, Artificial Sequence
  Description of Artificial Sequence Synthetic peptide
AMMMM

SEQ ID NO: 204 - protein, 5 aa, Artificial Sequence
  Description of Artificial Sequence Synthetic peptide
PMMMM

SEQ ID NO: 205 - protein, 5 aa, Artificial Sequence
  Description of Artificial Sequence Synthetic peptide
VMMMM

SEQ ID NO: 206 - protein, 5 aa, Artificial Sequence
  Description of Artificial Sequence Synthetic peptide
QMMMM

SEQ ID NO: 207 - protein, 5 aa, Artificial Sequence
  Description of Artificial Sequence Synthetic peptide
MAMMM

SEQ ID NO: 208 - protein, 5 aa, Artificial Sequence
  Description of Artificial Sequence Synthetic peptide
MQMMM

SEQ ID NO: 209 - protein, 5 aa, Artificial Sequence
  Description of Artificial Sequence Synthetic peptide
MPMMM

SEQ ID NO: 210 - protein, 5 aa, Artificial Sequence
  Description of Artificial Sequence Synthetic peptide
MNMMM

SEQ ID NO: 211 - protein, 5 aa, Artificial Sequence
  Description of Artificial Sequence Synthetic peptide
PAMMM

SEQ ID NO: 212 - protein, 5 aa, Artificial Sequence
  Description of Artificial Sequence Synthetic peptide
PFMMM

SEQ ID NO: 213 - protein, 5 aa, Artificial Sequence
  Description of Artificial Sequence Synthetic peptide
PVMMM

SEQ ID NO: 214 - protein, 5 aa, Artificial Sequence
  Description of Artificial Sequence Synthetic peptide
PEMMM

SEQ ID NO: 215 - protein, 5 aa, Artificial Sequence
  Description of Artificial Sequence Synthetic peptide
VAMMM

SEQ ID NO: 216 - protein, 5 aa, Artificial Sequence
  Description of Artificial Sequence Synthetic peptide
VFMMM

SEQ ID NO: 217 - protein, 5 aa, Artificial Sequence
  Description of Artificial Sequence Synthetic peptide
PVMMM

SEQ ID NO: 218 - protein, 5 aa, Artificial Sequence
  Description of Artificial Sequence Synthetic peptide
VEMMM

SEQ ID NO: 219 - protein, 5 aa, Artificial Sequence
  Description of Artificial Sequence Synthetic peptide
AAMMM

SEQ ID NO: 220 - protein, 5 aa, Artificial Sequence
  Description of Artificial Sequence Synthetic peptide
AFMMM

SEQ ID NO: 221 - protein, 5 aa, Artificial Sequence
  Description of Artificial Sequence Synthetic peptide
AVMMM

SEQ ID NO: 222 - protein, 5 aa, Artificial Sequence
  Description of Artificial Sequence Synthetic peptide
AEMMM

SEQ ID NO: 223 - protein, 4 aa, Artificial Sequence
  Description of Artificial Sequence Synthetic peptide
MMMM

SEQ ID NO: 224 - protein, 6 aa, Artificial Sequence
  Description of Artificial Sequence Synthetic peptide
XMMMMM

SEQ ID NO: 225 - protein, 6 aa, Artificial Sequence
  Description of Artificial Sequence Synthetic peptide
MXMMMM

SEQ ID NO: 226 - protein, 6 aa, Artificial Sequence
  Description of Artificial Sequence Synthetic peptide
MMXMMM

SEQ ID NO: 227 - protein, 6 aa, Artificial Sequence
  Description of Artificial Sequence Synthetic peptide
MMMXMM

SEQ ID NO: 228 - protein, 6 aa, Artificial Sequence
  Description of Artificial Sequence Synthetic peptide
MMMMXM

SEQ ID NO: 229 - protein, 6 aa, Artificial Sequence
  Description of Artificial Sequence Synthetic peptide
MMMMMX

SEQ ID NO: 230 - protein, 9 aa, Artificial Sequence
  Description of Artificial Sequence Synthetic peptide
LYDHPQNGG

SEQ ID NO: 231 - protein, 9 aa, Artificial Sequence
  Description of Artificial Sequence Synthetic peptide
QNDHPQNGG